(19) United States
(12) Patent Application Publication
(10) Pub. No.: US 2003/0225998 A1
(43) Pub. Date: Dec. 4, 2003

(54) Configurable data processor with multi-length instruction set architecture

(76) Inventors: Mohammed Noshad Khan, Middlesex (GB); Peter Warnes, Herts (GB); Arthur Robert Temple, London (GB); Jonathan Ferguson, London (GB); Richard A. Fuhler, Santa Cruz, CA (US); Simon Davidson, London (GB)

Correspondence Address: GAZDZINSKI & ASSOCIATES, Suite 375, 11440 West Bernardo Court, San Diego, CA, 92127, US

(21) Appl. No.: 10/356,129

(22) Filed: Jan. 31, 2003

Related U.S. Application Data
(60) Provisional application No. 60/353,647, filed on Jan. 31, 2002.

(51) Int. Cl. G06F 9/30

(52) U.S. Cl. 712/210

(57) ABSTRACT

Digital processor apparatus having an instruction set architecture (ISA) with instruction words of varying length. In the exemplary embodiment, the processor comprises an extended user-configurable RISC processor with four-stage pipeline (fetch, decode, and writeback) and associated logic that is adapted to decode and process both 32-execute, bit and 16-bit instruction words present in a single program, thereby increasing the flexibility of the instruction set, and allowing for greater code compression and reduced memory overhead. Free-form use of the different length instructions is provided with no required mode shift. An improved instruction aligner and code compression architecture is also disclosed.

### RELATED APPLICATIONS

The present application claims priority benefit of U.S. Provisional Application Serial No. 60/353,647 filed Jan. 31, 2002 and entitled “CONFIGURABLE DATA PROCESSOR WITH MULTI-LENGTH INSTRUCTION SET ARCHITECTURE”, which is incorporated herein by reference in its entirety. The present application is also related to co-pending and co-owned U.S. patent application Ser. No. ______ filed Dec. 26, 2002 and entitled “METHODS AND APPARATUS FOR COMPILING INSTRUCTIONS FOR A DATA PROCESSOR”, which claims priority benefit of U.S. Provisional Serial No. 60/343,730 filed Dec. 26, 2001 of the same title, both of which are incorporated by reference herein in their entirety.

### COPYRIGHT

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention relates generally to the field of data processors, and specifically to an improved data processor instruction set architecture (ISA) and related apparatus and methods.

2. Description of Related Technology

A variety of different techniques are known in the prior art for implementing specific functionalities (such as FFT, convolutional coding, and other computationally intensive applications) using data processors. These techniques generally fall into one of three categories: (i) “fixed” hardware; (ii) software; and (iii) user-configurable.

So-called ‘fixed’ architecture processors of the prior art characteristically incorporate special instructions and or hardware to accelerate particular functions. Because the architecture of processors in such cases is largely fixed beforehand, and the details of the end application unknown to the processor designer, the specialized instructions added to accelerate operations are not optimized in terms of performance. Furthermore, hardware implementations such as those present in prior art processors are inflexible, and the logic is typically not used by the device for other “general purpose” computing when not being actively used for coding, thereby making the processor larger in terms of die size, gate count, and power consumption, than it needs to be. Furthermore, no ability to subsequently add extensions to the instruction set architectures (ISAs) of such ‘fixed’ approaches exists.

Alternatively, software-based implementations have the advantage of flexibility; specifically, it is possible to change the functional operations by simply altering the software program. Decoding in software also has the advantages afforded by the sophisticated compiler and debug tools available to the programmer. Such flexibility and availability of tools, however, comes at the cost of efficiency (e.g., cycle count), since it generally takes many more cycles to implement the software approach than would be needed for a comparable hardware solution.

So-called “user-configurable” extensible data processors, such as the ARCtangent™ processor produced by the Assignee hereof, allow the user to customize the processor configuration, so as to optimize one or more attributes of the resulting design. When employing a user-configurable and extensible data processor, the end application is known at the time of design/synthesis, and the user configuring the processor can produce the desired level of functionality and attributes. The user can also configure the processor appropriately so that only the hardware resources required to perform the function are included, resulting in an architecture that is significantly more silicon (and power) efficient than fixed architecture processors.

The ARCtangent processor is a user-customizable 32-bit RISC core for ASIC, system-on-chip (SoC), and FPGA integration. It is synthesizable, configurable, and extendable, thus allowing developers to modify and extend the architecture to better suit specific applications. It comprises a 32-bit RISC architecture with a four-stage execution pipeline. The instruction set, register file, condition codes, caches, buses, and other architectural features are user-configurable and extendable. It has a 32×32-bit core register file, which can be doubled if required by the application. Additionally, it is possible to use large number of auxiliary registers (up to 2E32). The functional elements of the core of this processor include the arithmetic logic unit (ALU), register file (e.g., 32×32), program counter (PC), instruction fetch (i-fetch) interface logic, as well as various stage latches.

Even in configurable processors such as the A4, existing prior art instruction sets (such as for example those employing single-length instructions) are characteristically restrictive in that the code size required to support such instruction sets is comparatively large, thereby requiring significant memory overhead. This overhead necessitates the use of additional memory capacity over that which would otherwise be required, and necessitates larger die size and power consumption. Conversely, for a given fixed die size or memory capacity, the ability to use the remaining memory for other functions is restricted. This problem is particularly acute in configurable processors, since these limitations typically manifest themselves as limitations on the number and/or type of extension instructions (extensions) which may be added by the designer to the instruction set. This can often frustrate the very purpose of user-configurability itself, i.e., the ability of the user to freely add a variety of different extensions dependent on their particular application(s) and consistent with their design constraints.

Furthermore, as 32-bit architectures become more widely used in deeply embedded systems, code density can have a direct impact on system cost. Typically, a very high percentage of the silicon area of a system-on-chip (SoC) device is taken up by memory.

As an example of the foregoing, Table 1 lists an exemplary base prior art RISC processor instruction set. This instruction set has only two remaining expansion slots although there is also space for additional single operand instructions. Fundamentally, there is very limited room for development of future applications (e.g., DSP hardware) or for users who may wish to add many of their own extensions.

TABLE 1

| Instruction | Instruction | |
|---|---|---|
| Opcode | Type | Description |
| 0x00 | LD | Delayed load from memory |
| 0x01 | LD | Delayed load from memory with shimm |
| | | offset |
| 0x02 | ST | Store data to memory |
| 0x03 | Single Operand | Single Operand Instructions, e.g. BRK, |
| | | Sleep, Flag, Normalize, etc |
| 0x04 | Branch | Branch conditionally |
| 0x05 | BL | Branch & link conditionally |
| 0x06 | LP | Zero overhead loop set up |
| 0x07 | Jump/Jump & | Jump conditionally |
| | Link | |
| 0x08 | ADD | Add 2 numbers |
| 0x09 | ADC | Addition with Carry |
| 0x0A | SUB | Subtraction |
| 0x0B | SBC | Subtract with Carry |
| 0x0C | AND | Logical bitwise And |
| 0x0D | OR | Logical bitwise OR |
| 0x0E | BIC | Bitwise And with invert |
| 0x0F | XOR | Exclusive Or |
| 0x10 | ASL (LSL) | Arithmetic shift left |
| 0x11 | ASR | Arithmetic shift right |
| 0x12 | LSR | Logical Shift Right |
| 0x13 | ROR | Rotate right |
| 0x14 | MUL64 | Signed 32 × 32 Multiply |
| 0x15 | MULU64 | Unsigned 32 × 32 Multiply |
| 0x16 | N/A | |
| 0x17 | N/A | |
| 0x18 | MUL | Signed 16 × 16 or (24 × 24) |
| 0x19 | MULU | Unsigned 16 × 16 (or 24 × 24) |
| 0x1A | MAC | Signed multiply accumulate |
| 0x1B | MACU | Unsigned multiply accumulate |
| 0x1C | ADDS | Addition for the XMAC with saturation |
| | | limiting |
| 0x1D | SUBS | Subtraction for the XMAC with saturation |
| | | limiting. |
| 0x1E | MIN | Minimum of 2 numbers is written to core |
| | | register. |
| 0x1F | MAX | Maximum of 2 numbers is written to core |
| | | register. |

Variable-Length ISAs

A variety of different approaches to variable or multi-length instructions are present in the prior art. For example, U.S. Pat. No. 4,099,229 to Kancler issued Jul. 4, 1978 entitled “Variable architecture digital computer” discloses a variable architecture digital computer to provide real-time control for a missile by executing variable-length instructions optimized for such application by means of a microprogrammed processor and an instruction byte string concept. The instruction set is of variable-length and is optimized to solve the computational problem presented in two ways. First, the amount of information contained in an instruction is proportional to the complexity of the instruction with the shortest formats being given to the most frequently executed instructions to save execution time. Secondly, with a microprogram control mechanism and flexible instruction formatting, only instructions required by the particular computational application are provided by accessing appropriate microroutines, saving memory space as a result.

U.S. Pat. No. 5,488,710 to Sato, et al. issued Jan. 30, 1996 and entitled “Cache memory and data processor including instruction length decoding circuitry for simultaneously decoding a plurality of variable length instructions” discloses a cache memory, and a data processor including the cache memory, for processing at least one variable length instruction from a memory and outputting processed information to a control unit, such as a central processing unit (CPU). The cache memory includes a unit for decoding an instruction length of a variable length instruction from the memory, and a unit for storing the variable length instruction from the memory, together with the decoded instruction length information. The variable length instruction and the instruction length information thereof are fed to the control unit. Accordingly, the cache memory enables the control unit to simultaneously decode a plurality of variable length instructions and thus ostensibly realize higher speed processing.

U.S. Pat. No. 5,636,352 to Bealkowski, et al. issued Jun. 3, 1997 entitled “Method and apparatus for utilizing condensed instructions” discloses a method and apparatus for executing a condensed instruction stream by a processor including receiving an instruction including an instruction identifier and multiple of instruction synonyms within the instruction, generating at least one full width instruction for each instruction synonym, and executing by the processor the generated full width instructions. A standard instruction cell is used to contain a desired instruction for execution by the system processor. For the PowerPC 601 RISC-style microprocessor, the width of the instruction cell is thirty-two bits. Instructions are four bytes long (32 bits) and word-aligned. Bits 0-5 of the instruction word specify the primary opcode. Some instructions may also have a secondary opcode to further define the first opcode. The remaining bits of the instruction contain one or more fields for the different instruction formats. A Condensed Instruction Cell is comprised of a Condensed Cell Specifier (CCS) and one or more Instruction Synonyms (IS) IS1, IS2, . . . ISn. An instruction synonym is, typically, a shorter (in total bit count) value used to represent the value of a full width instruction cell.

U.S. Pat. No. 5,819,058 to Miller, et al. issued Oct. 6, 1998 and entitled “Instruction compression and decompression system and method for a processor” discloses a system and method for compressing and decompressing variable length instructions contained in variable length instruction packets in a processor having a plurality of processing units. A compression system with a system for generating an instruction packet containing a plurality of instructions, a system for assigning a compressed instruction having a predetermined length to an instruction within the instruction packet, a shorter compressed instruction corresponding to a more frequently used instruction, and a system for generating an instruction packet containing compressed instructions for corresponding ones of the processing units is provided. The decompression system has a system for storing a plurality of instruction packets in a plurality of storage locations, a system for generating an address that points to a selected variable length instruction packet in the storage system, and a decompression system that decompresses the compressed instructions in said selected instruction packet to generate a variable length instruction for each of the processing units. The decompression system may also have a system for routing said variable length instructions from the decompression system to each of the processing units.

U.S. Pat. No. 5,881,260 to Raje, et al. issued Mar. 9, 1999 “Method and apparatus for sequencing and decoding variable length instructions with an instruction boundary marker within each instruction” discloses an apparatus and method for decoding variable length instructions in a processor where a line of variable length instructions from an instruction cache are loaded into an instruction buffer and the start bits indicating the instruction boundaries of the instructions in the line of variable length instructions is loaded into a start bit buffer. A first shift register is loaded with the start bits and shifted in response to a lower program count value which is also used to shift the instruction buffer. A length of a current instruction is obtained by detecting the position of the next instruction boundary in the start bits in the first register. The length of the current instruction is added to the current value of the lower program count value in order to obtain a next sequential value for the lower program count which is loaded into a lower program count register. An upper program count value is determined by loading a second shift register with the start bits, shifting the start bits in response to the lower program count value and detecting when only one instruction remains in the instruction buffer. When one instruction remains, the upper program count value is incremented and loaded into an upper program count register for output to the instruction cache in order to cause a fetch of another line of instructions and a ‘0’ value is loaded into the lower program count register. Another embodiment includes multiplexers for loading a branch address into the upper and lower program count registers in response to a branch control signal.

U.S. Pat. No. 6,209,079 to Otani, et al. issued Mar. 27, 2001 and entitled “Processor for executing instruction codes of two different lengths and device for inputting the instruction codes” discloses a processor having instruction codes of two instruction lengths (16 bits and 32 bits), and methods of locating the instruction codes. These methods are limited to two types: (1) two 16-bit instruction codes are stored within 32-bit word boundaries, and (2) a single 32-bit instruction code is stored intact within the 32-bit word boundaries. A branch destination address is specified only on the 32-bit word boundary. The MSB of each instruction code serves as a 1-bit instruction length identifier for controlling the execution sequence of the instruction codes. This provides two transfer paths from an instruction fetch portion to an instruction decode portion within the processor, ostensibly achieving reduction in code side and in the amount of hardware and, accordingly, the increase in operating speed.

U.S. Pat. No. 6,282,633 to Killian, et al. issued Aug. 28, 2001 and entitled “High data density RISC processor” discloses a RISC processor implementing an instruction set which, in addition to attempting to optimize a relationship between the number of instructions required for execution of a program, clock period and average number of clocks per instruction, also attempts to optimize the equation S=IS*BI, where S is the size of program instructions in bits, IS is the static number of instructions required to represent the program (not the number required by an execution) and BI is the average number of bits per instruction. This approach is intended to lower both BI and IS with minimal increases in clock period and average number of clocks per instruction. The processor seeks to provide good code density in a fixed-length high-performance encoding based on RISC principles, including a general register with load/store architecture. Further, the processor implements a variable-length encoding.

U.S. Pat. No. 6,463,520 to Otani, et al. issued Oct. 8, 2002 and entitled “Processor for executing instruction codes of two different lengths and device for inputting the instruction codes” discloses a technique which facilitates the process instruction codes in processor. A memory device is provided which comprises a plurality of 2N-bit word boundaries, where N is greater than or equal to one. The processor of the present invention executes instruction codes of a 2N-bit length and a N-bit length. The instruction codes are stored in the memory device is such a way that the 2-N bit word boundaries contains either a single 2N-bit instruction code or two N-bit instruction codes. The most significant bit of each instruction code serves as a instruction format identifier which controls the execution (or decoding) sequence of the instruction codes. As a result, only two transfer paths from an instruction fetch portion to an instruction decode portion of the processor are necessary thereby reducing the hardware requirement of the processor and increasing system throughput.

U.S. Pat. No. 5,948,100 to Hsu, et al. issued Sep. 7, 1999 entitled “Branch prediction and fetch mechanism for variable length instruction, superscalar pipelined processor” discloses a processor architecture including a fetcher, packet unit and branch target buffer. The branch target buffer is provided with a tag RAM that is organized in a set associative fashion. In response to receiving a search address, multiple sets in the tag RAM are simultaneously searched for a branch instruction that is predicted to be taken. The packet unit has a queue into which fetched cache blocks are stored containing instructions. Sequentially fetched cache blocks are stored in adjacent locations of the queue. The queue entries also have indicators that indicate whether or not a starting or final data word of an instruction sequence is contained in the queue entry and if so, an offset indicating the particular starting or final data word. In response, the packet unit concatenates data words of an instruction sequence into contiguous blocks. The fetcher generates a fetch address for fetching a cache block from the instruction cache containing instructions to be executed. The fetcher also generates a search address for output to the branch target buffer. In response to the branch target buffer detecting a taken branch that crosses multiple cache blocks, the fetch address is increased so that it points to the next cache block to be fetched but the search address is maintained the same.

U.S. Pat. No. 5,870,576 to Faraboschi, et al. issued Feb. 9, 1999 and entitled “Method and apparatus for storing and expanding variable-length program instructions upon detection of a miss condition within an instruction cache containing pointers to compressed instructions for wide instruction word processor architectures” discloses apparatus for storing and expanding wide instruction words in a computer system. The computer system includes a memory and an instruction cache. Compressed instruction words of a program are stored in a code heap segment of the memory, and code pointers are stored in a code pointer segment of the memory. Each of the code pointers contains a pointer to one of the compressed instruction words. Part of the program is stored in the instruction cache as expanded instruction words. During execution of the program, an instruction word is accessed in the instruction cache. When the instruction word required for execution is not present in the instruction cache, thereby indicating a cache miss, a code pointer corresponding to the required instruction word is accessed in the code pointer segment of memory. The code pointer is used to access a compressed instruction word corresponding to the required instruction word in the code heap segment of memory. The compressed instruction word is expanded to provide an expanded instruction word, which is loaded into the instruction cache and is accessed for execution.

U.S. Pat. No. 5,864,704 to Battle, et al. issued Jan. 26, 1999 entitled “Multimedia processor using variable length instructions with opcode specification of source operand as result of prior instruction” discloses a media engine which incorporates into a single chip structure various media functions. The media engine includes a signal processor which shares a memory with the CPU of the host computer and also includes a plurality of control modules each dedicated to one of the seven multi-media functions. The signal processor retrieves from this shared memory instructions placed therein by the host CPU and in response thereto causes the execution of such instructions via one of the on-chip control modules. The signal processor utilizes an instruction register having a movable partition which allows larger than typical instructions to be paired with smaller than typical instructions. The signal processor reduces demand for memory read ports by placing data into the instruction register where it may be directly routed to the arithmetic logic units for execution and, where the destination of a first instruction matches the source of a second instruction, by defaulting the source specifier of the second instruction to the result register of the ALU employed in the execution of the first instruction.

U.S. Pat. No. 5,809,272 to Thusoo, et al. issued Sep. 15, 1998 and entitled “Early instruction-length pre-decode of variable-length instructions in a superscalar processor” discloses a superscalar processor that can dispatch two instructions per clock cycle. The first instruction is decoded from instruction bytes in a large instruction buffer. A secondary instruction buffer is loaded with a copy of the first few bytes of the second instruction to be dispatched in a cycle. In the previous cycle this secondary instruction buffer is used to determine the length of the second instruction dispatched in that previous cycle. That second instruction's length is then used to extract the first bytes of the third instruction, and its length is also determined. The first bytes of the fourth instruction are then located. When both the first and the second instructions are dispatched, the secondary buffer is loaded with the bytes from the fourth instruction. If only the first instruction is dispatched, then the secondary buffer is loaded with the first bytes of the third instruction. Thus the secondary buffer is always loaded with the starting bytes of undispatched instructions. The starting bytes are found in the previous cycle. Once initialized, two instructions can be issued each cycle. Decoding of both the first and second instructions proceeds without delay since the starting bytes of the second instruction are found in the previous cycle. On the initial cycle after a reset or branch mis-predict, just the first instruction can be issued. The secondary buffer is initially loaded with a copy of the first instruction's starting bytes, allowing the two length decoders to be used to generate the lengths of the first and second instructions or the second and third instructions. Only two, and not three, length decoders are needed.

Despite the various foregoing approaches, what is needed is an improved processor instruction set architecture (ISA) and related functionalities which (i) reduce or compress the overhead required by the instruction set to an absolute minimum, thereby reducing the required memory (and associated silicon), and (ii) provide the designer with maximum flexibility in adding custom extensions under a given set of constraints. Such improved ISA would also ideally provide free-form mixing of different instruction formats without a mode switch, thereby greatly simplifying programming and compiling operations, and helping to reduce the aforementioned overhead.

### SUMMARY OF THE INVENTION

The present invention satisfies the aforementioned needs by an improved processor instruction set architecture (ISA) and associated apparatus and methods.

In a first aspect of the invention, an improved processor instruction set architecture (ISA) is disclosed. The improved ISA generally comprises a plurality of first instructions having a first length, and a plurality of second instructions having a second length, the second length being shorter than the first. In one exemplary embodiment, the ISA comprises both 16-bit and 32-bit instructions which can be decoded and processed by the 32-bit core when contained within a single code listing. The 16-bit instructions are selectively utilized for operations which do not require a 32-bit instruction, and/or where the cycle count can be reduced. This affords the parent processor with compressed or reduced code size, and affords an increased number of expansion slots and available extension instructions.

In a second aspect of the invention, an improved processor based on the aforementioned ISA is disclosed. The processor generally comprises: a plurality of first instructions having a first length; a plurality of second instructions having a second length; and logic adapted to decode and process both said first length and second length instructions from a single program having both first and second length instructions contained therein. In one exemplary embodiment, the processor comprises a user-configurable extended RISC processor with fetch, decode, execute, and writeback stages and having both 16-bit and 32-bit instruction decode and processing capability. The processor requires a limited amount of on-chip memory to support the code based on the use of the “compressed” 16-bit and 32-bit ISA described above.

In a third aspect of the invention, an improved instruction aligner for use with the aforementioned ISA is disclosed. In one exemplary embodiment, the instruction aligner is disposed within the first (fetch) stage of the pipeline, and is adapted to receive instructions from the instruction cache and generate instruction words of both 16-bit and 32-bit length based thereon. The correct or valid instruction is selected and passed down the pipeline. 16-bit instructions are selectively buffered within the aligner, thereby allowing proper formatting for the 32-bit architecture of the processor.

In a fourth aspect of the invention, an improved method of processing multi-length instructions within a digital processor instruction pipeline is disclosed. The method generally comprises providing a plurality of first instructions of a first length; providing a plurality of second instructions of a second length, at least a portion of the plurality of second instructions comprising components of a longword; determining when a given longword comprises one of the first instructions or a plurality of the second instructions; and when the given longword comprises a plurality of the second instructions, buffering at least one of the second instructions. In an exemplary embodiment, the longwords comprise 32-bit words with a 16-bit boundary, and the MSBs of the instructions are utilized to determine whether they are 16-bit instructions or 32-bit instructions.

In a fifth aspect of the invention, an improved method of synthesizing a processor design having the improved ISA described above is disclosed. In one exemplary embodiment, the method comprises: providing at least one desired functionality; providing a processor design tool comprising a plurality of logic modules, such design tool adapted to generate a processor design having a mixed 16-bit and 32-bit ISA; providing a plurality of constraints on said design to the design tool; and generating a mixed ISA processor design using at least the design tool and based at least in part on the plurality of constraints.

### BRIEF DESCRIPTION OF THE DRAWINGS

FIG. 1 is a graphical representation of various exemplary Instruction Formats used with the ISA of the present invention, including LD, ST, Branch, and Compare/Branch instructions.

FIG. 2 is a graphical representation of an exemplary general register format.

FIG. 3 is a graphical representation of an exemplary Branch, MOV/CMP, ADD/SUB format.

FIG. 4 is a graphical representation of an exemplary BL Instruction format

FIG. 5—MOV, CMP, ADD with high register instruction formats

FIG. 6 is a pipeline diagram for instructions BSET, BCLR, BTST and BMSK.

FIG. 7 is a schematic block diagram illustrating exemplary selector multiplexers for 16 and 32 bit instructions.

FIG. 8 is a schematic block diagram illustrating an exemplary datapath through stage 2 of the pipeline.

FIG. 9 is a schematic block diagram illustrating an exemplary generation of s2val_one_bit within stage 3 of the pipeline

FIG. 10 is a schematic block diagram illustrating an exemplary generation of 2val_mask in stage 3 of the pipeline

FIG. 11 is a schematic pipeline diagram for BRNE instruction.

FIG. 12 is a schematic block diagram illustrating an exemplary Stage 1 mux for ‘fs1a’ and ‘s2offset’.

FIG. 13 is a schematic block diagram illustrating an exemplary Stage 2 datapath for ‘s1val’ and ‘s2val’.

FIG. 14 is a schematic block diagram illustrating an exemplary Stage 2 branch target calculation for BR and BBIT instructions.

FIG. 15 is a schematic block diagram illustrating an exemplary Stage 3 dataflow for ALU and flag calculation.

FIG. 16 is a schematic block diagram illustrating an exemplary ABS instruction.

FIG. 17 is a schematic block diagram illustrating exemplary Shift ADD/SUB instructions.

FIG. 18 is a schematic block diagram illustrating an exemplary Shift Right & Mask extension.

FIG. 19 is a schematic block diagram illustrating an exemplary Code Compression Architecture.

FIG. 20 is a schematic block diagram illustrating an exemplary configuration of the Decode Logic (Stage 2)

FIG. 21 is a schematic block diagram illustrating an exemplary processor hierarchy.

FIG. 22 is a schematic block diagram illustrating an exemplary Operand Fetch.

FIG. 23 is a schematic block diagram illustrating an exemplary Datapath for Stage 1.

FIG. 24 is a schematic block diagram illustrating exemplary expansion logic for 16-bit Instructions.

FIG. 25 is a schematic block diagram illustrating exemplary expansion logic for 16-bit Instructions 2.

FIG. 26 is a schematic block diagram illustrating exemplary disabling logic for stage 1 when Actionpoint/BRK.

FIG. 27 is a schematic block diagram illustrating exemplary disabling logic for stage 1 when single instruction stepping.

FIG. 28 is a schematic block diagram illustrating exemplary disabling logic for stage 1 when no instruction available.

FIG. 29 is a schematic block diagram illustrating exemplary instruction fetch logic.

FIG. 30 is a schematic block diagram illustrating exemplary long immediate data.

FIG. 31 is a schematic block diagram illustrating exemplary program counter enable logic.

FIG. 32 is a schematic block diagram illustrating exemplary program counter enable logic 2.

FIG. 33 is a schematic block diagram illustrating exemplary instruction pending logic.

FIG. 34 is a schematic block diagram illustrating an exemplary BRK instruction decode.

FIG. 35 is a schematic block diagram illustrating exemplary actionpoint/BRK Stall logic in stage 1.

FIG. 36 is a schematic block diagram illustrating exemplary actionpoint/BRK Stall logic in stage 2.

FIG. 37 is a schematic block diagram illustrating an exemplary Stage 2 Data path—Source 1 Operand.

FIG. 38 is a schematic block diagram illustrating an exemplary Stage 2 Data path—Source 2 Operand.

FIG. 39 is a schematic block diagram illustrating exemplary Scaled Addressing.

FIG. 40 is a schematic block diagram illustrating exemplary branch target addresses.

FIG. 41 is a schematic block diagram illustrating exemplary Next PC signal generation (1).

FIG. 42 is a schematic block diagram illustrating exemplary Next PC signal generation (2).

FIG. 43 is a graphical representation of an exemplary Status Register encoding.

FIG. 44 is a graphical representation of an exemplary PC32 Register encoding.

FIG. 45 is a graphical representation of an exemplary Status32 Register encoding.

FIG. 46 is a graphical representation of updating the PC/Status registers.

FIG. 47 is a schematic block diagram illustrating exemplary disabling logic for stage 2 when awaiting a delayed load.

FIG. 48 is a schematic block diagram illustrating exemplary Stage 2 branch holdup logic.

FIG. 49 is a schematic block diagram illustrating an exemplary stall for conditional Jumps.

FIG. 50 is a schematic block diagram illustrating killing delay slots.

FIG. 51 is a schematic block diagram illustrating an exemplary Stage 3 data path.

FIG. 52 is a schematic block diagram illustrating an exemplary Arithmetic Unit used with the processor of the invention.

FIG. 53 is a schematic block diagram illustrating address generation.

FIG. 54 is a schematic block diagram illustrating an exemplary Logic Unit.

FIG. 55 is a schematic block diagram illustrating exemplary arithmetic/rotate functionality.

FIG. 56 is a schematic block diagram illustrating an exemplary Stage 3 result selection.

FIG. 57 is a schematic block diagram illustrating exemplary Flag generation.

FIG. 58 is a schematic block diagram illustrating exemplary writeback address generation (p3a).

FIG. 59 is a schematic block diagram illustrating an exemplary Min/Max data path.

FIG. 60 is a schematic block diagram illustrating exemplary carry flag for MIN/MAX instruction.

FIG. 61 is a graphical representation of a first exemplary operation—Aligning Instructions upon Reset.

FIG. 62 is a graphical representation of a second exemplary operation—Aligning Instructions upon Reset.

FIG. 63 is a graphical representation of a first exemplary operation—Aligning Instructions after Branches.

FIG. 64 is a graphical representation of a second exemplary operation—Aligning Instructions after Branches.

FIG. 65 is a graphical representation of the operation of FIG. 64.

### DETAILED DESCRIPTION

Reference is now made to the drawings wherein like numerals refer to like parts throughout.

As used herein, the term “processor” is meant to include any integrated circuit or other electronic device (or collection of devices) capable of performing an operation on at least one instruction word including, without limitation, reduced instruction set core (RISC) processors such as for example the ARCtangent™ A4 or A5 user-configurable core manufactured by the Assignee hereof, central processing units (CPUs), and digital signal processors (DSPs). The hardware of such devices may be integrated onto a single substrate (e.g., silicon “die”), or distributed among two or more substrates. Furthermore, various functional aspects of the processor may be implemented solely as software or firmware associated with the processor.

Additionally, it will be recognized by those of ordinary skill in the art that the term “stage” as used herein refers to various successive stages within a pipelined processor; i.e., stage 1 refers to the first pipelined stage, stage 2 to the second pipelined stage, and so forth. Such stages may comprise, for example, instruction fetch, decode, execution, and writeback stages.

Lastly, any references to hardware description language (HDL) or VHSIC HDL (VHDL) contained herein are also meant to include other hardware description languages such as Verilog®. Furthermore, an exemplary Synopsys® synthesis engine such as the Design Compiler 2000.05 (DC00) may be used to synthesize the various embodiments set forth herein, or alternatively other synthesis engines such as Buildgates® available from, inter alia, Cadence Design Systems, Inc., may be used. IEEE std. 1076.3-1997, IEEE Standard VHDL Synthesis Packages, describes an industry-accepted language for specifying a Hardware Definition Language-based design and the synthesis capabilities that may be expected to be available to one of ordinary skill in the art.

Overview

The present invention is an innovative instruction set architecture (ISA) that allows designers to freely mix 16 and 32-bit instructions on their 32-bit user-configurable processor. A key benefit of the ISA is the ability to cut memory requirements on a SoC (system-on-chip) by significant percentages, resulting in lower power consumption and lower cost devices in deeply embedded applications such as wireless communications and high volume consumer electronics products. The Assignee hereof has empirically determined that the improved ISA of the present invention provides up to forty-percent (40%) compression of the ISA code as compared to prior art (non-compressed) single-length instruction ISAs.

The main features of the present (ARCompact) ISA include 32-bit instructions aimed at providing better code density, a set of 16-bit instructions for the most commonly used operations, and freeform mixing of 16-bit and 32-bit instructions without a mode switch—significant because it significantly reduces the complexity of compiler usage compared to competing mode-switching architectures. The present instruction set expands the number of custom extension instructions that users can add to the base-case ARCtangent™ or other processor instruction set. The existing configurable processor architecture already allows users to add as many as 69 new instructions to speed up critical routines and algorithms. With the improved ISA of the present invention, users can add as many as 256 new instructions, thereby greatly enhancing flexibility and user-configurability. Users can also add new core registers, auxiliary registers, and condition codes. The ISA of the present invention thus maintains yet enhances and expands upon the user-customizable features of the prior art configurable processor technology.

The improved ISA of the present invention delivers high density code helping to significantly reduce the memory required for the embedded application, a vital factor for high-volume consumer applications, such as flash memory cards. In addition, by fitting code into a smaller memory area, the processor potentially has to make fewer memory accesses. This reduces power consumption and extends battery life for portable devices such as MP3 players, digital cameras and wireless handsets. Additionally, the shorter instructions provided by the present ISA can improve system throughput by executing in a single clock cycle some operations previously requiring two or more instructions to complete. This often boosts application performance without having to run the processor at higher clock frequencies.

The support for freeform use of 16-bit and 32-bit instructions allows compilers and programmers to use the most suitable instructions for a given task, without any need for specific code partitioning or system mode management. Direct replacement of 32-bit instructions with counterpart 16-bit instructions provides an immediate code density benefit, which can be realized at an individual instruction level throughout the application. As the compiler is not required to restructure the code, greater scope for optimizations is provided, over a larger range of instructions. Application debugging is also more intuitive, because the newly generated code follows the structure of the original source code.

The present invention provides, inter alia, a detailed description of the 32- and 16-bit ISA in the context of an exemplary ARCtangent-based processor, although it will be recognized that the features of the invention may be adapted to many different types and configurations of data processor. Data and control path configurations are described which allow the decoding and processing of both the 16- and 32-bit instructions. The addition of the 16-bit ISA allow more instructions to be inserted and reduce code size, thereby affording a degree of code “compression” as compared to a prior art “one-size” (e.g., 32-bit) ISA.

The processor described herein advantageously is also able to execute 16-bit and 32-bit instructions intermixed within the same piece of source code. The improved ISA also allows a significant number of expansion slots for use by the designer.

It is further noted that the present disclosure references a method of synthesizing a processor design having certain parameters (“build”) incorporating, inter alia, the foregoing 16/32-bit ISA functionality. The generalized method of synthesizing integrated circuits having a user-customized (i.e., “soft”) instruction set is disclosed in Applicant's co-pending U.S. patent application Ser. No. 09/418,663 entitled “Method And Apparatus For Managing The Configuration And Functionality Of A Semiconductor Design” filed Oct. 14, 1999, which is incorporated herein by reference in its entirety, as embodied in the “ARChitect” design software manufactured by the Assignee hereof, although it will be recognized that other software environments and approaches may be utilized consistent with the present invention. For example, the object-oriented approach described in co-pending U.S. Provisional Patent Application Serial No. 60/375,997 filed Apr. 25, 2002 and entitled “Apparatus and Method for Managing Integrated Circuit Designs” (ARChitect II) may also be employed. Hence, references to specific attributes of the aforementioned ARChitect program are merely illustrative in nature.

Additionally, while aspects of the present invention are presented in terms of an algorithm or computer program running on a microcomputer or other similar processing device, it can be appreciated that other hardware environments (including minicomputers, workstations, networked computers, “supercomputers”, mainframes, and distributed processing environments) may be used to practice the invention. Additionally, one or more portions of the computer program may be embodied in hardware or firmware as opposed to software if desired, such alternate embodiments being well within the skill of the computer artisan.

32-Bit ISA

Referring now to FIGS. 1-5, an exemplary embodiment of the 32-bit portion of the improved ISA of the present invention is described. The exemplary embodiment implements a 32-bit instruction set which is enhanced and modified with respect to existing or prior art instruction sets (such as for example that utilized in the ARCtangent A4 processor). These enhancements and modifications are required so that the size of code employed for any given application is reduced, thereby keeping memory overhead to an absolute minimum. The code compression scheme of the present embodiment comprises partitioning the instruction set into two component instruction sets: (i) a 32-bit instruction set; and (ii) a 16-bit instruction set. As will be demonstrated in greater detail herein, this “dual ISA” approach also affords the processor the ability to readily switch between the 16- and 32-bit instructions.

One exemplary format of the core registers the “dual ISA” processor of the present invention is shown in Table 2.

TABLE 2

| Register | Core Register | |
|---|---|---|
| Number | Name | Description |
| 0 to 25 | r0 to r25 | General purpose registers |
| 26 | Gp or r26 | General purpose register or global pointer |
| 27 | Fp or r27 | General purpose register or frame pointer |
| 28 | Sp or r28 | General purpose register or stack pointer |
| 29 | Ilink1 or r29 | Maskable interrupt register |
| 30 | Ilink2 or r30 | Maskable interrupt register |
| 31 | Blink or r31 | Branch link register |
| 32 to 59 | r32 to r59 | More general purpose registers |
| 60 | r60 | Loop Count Register |
| 61 | r61 | Reserved |
| 62 | r62 | Register encoding for long immediate |
| | | (limm) data |
| 63 | r63 | Register encoding for Program counter |
| | | (currentpc) |

Instructions included with the exemplary 32-bit instruction set include: (i) bit set, test, mask, clear; (ii) push/pop; (iii) compare & branch; (iv) load offset relative to the PC; and (v) 2 auxiliary registers, 32-bit PC and status register. Additionally, the other 32-bit instructions of the present embodiment are organized to fit between opcode slots 0×0 to 0×07 as shown in Table 3 (in the exemplary context of the aforementioned ARCtangent A4 32-bit instruction set):

TABLE 3

| Instruction | Instruction | |
|---|---|---|
| Opcode | Type | Description |
| 0x00 | Branch | Branch conditionally |
| 0x01 | BL | Branch & link |
| | | conditionally |
| 0x02 | LD | Delayed load from |
| | | memory. Format is |
| | | register + shimm. |
| 0x03 | ST | Stores to memory. |
| | | Format is register + |
| | | shimm. |
| 0x04 | Operation | This includes the |
| | format 1 | basecase instructions. |
| 0x05 | Operation | Reserved for extension |
| | format 2 | instructions. |
| 0x06 | Operation | |
| | format 3 | |
| 0x07 | Operation | Reserved for user |
| | format 4 | extension instructions. |
| 0x08 | Empty Slot | Expansion slots available |
| 0x09 | Empty Slot | for 16-bit instructions. |
| 0x0A | Empty Slot | |
| 0x0B | Empty Slot | |
| 0x0C | Empty Slot | |
| 0x0D | Variable | Reserved for 16-bit ISA |
| 0x0E | | |
| ....... | | |
| 0x1E | | |
| 0x1F | | |

The branch instructions of the present embodiment have been configured to occupy opcode slots 0×0 and 0×1, i.e. Branch conditionally (Bcc) and Branch & Link (BL) respectively. The instruction formats are as follows: (i) Bcc 21-bit address (0×0); and (ii) BLcc 22-bit address (0×1). The branch and link instruction is 32-bit aligned while Branch instructions are 16-bit aligned. There are only two delay slot modes providing for jumps in the illustrated embodiment, i.e. .nd (don't execute delay slot) and .d (always execute delay slot), although it will be recognized that other and more complex jump delay slot modes may be specified, such as for example those described in U.S. patent application Ser. No. 09/523,877 filed Mar. 13, 2000 and entitled “Method and Apparatus for Jump Delay Slot Control in a Pipelined Processor” which is co-owned by the Assignee hereof, and incorporated herein by reference in its entirety.

The load/store (LD/ST) instructions of the present embodiment are configured such that they can be addressed from the value in a core register plus short immediate offset (e.g., 9-bits). Addressing modes for LD/ST operations include (i) LD relative to the program counter (PC); and (ii) scaled index addressing mode.

The LD/ST PC relative instruction allows LD/ST instructions for the 32-bit ISA to be relative the PC. This is implemented in the illustrated embodiment by having register r63 as a read only value of the PC. This register is available as a source register to all other instructions.

The scaled index addressing mode allows operand two to be shifted by the size of the data access, e.g., zero for byte, one for word, two for longword. This functionality is described in greater detail subsequently herein.

It is also noted that the different encoding can be used, e.g. three for 64-bit.

A number of arithmetic and logical instructions are encompassed within the aforementioned opcode slots 0×2 to 0×7, as follows: (i) Arithmetic—ADD, SUB, ADC, SBC, MUL64, MULU64, MACU, MAC, ADDS, SUBS, MIN, MAX; (ii) Bit Shift—ASR, ASL, LSR, ROR; and (iii) Logical—AND, OR, NOT, XOR, BIC. Each opcode supports a different format based on flag setting, conditional execution, and different constants (6, 12-bits). This also includes the single operand instructions.

The Shift and Add/Subtract instructions of the illustrated embodiment allow a value to be shifted 0, 1, or 2 places, and then it is added to the contents of a register. This adds an additional overhead in stage 3 of the processor since there will 2 levels of logic added to the input of the 32-bit adder (bigalu). This functionality is described in greater detail subsequently herein.

The Bit Set, Clear & Test instructions remove the need for long immediate (limm) data for masking purposes. This allows a 5-bit value in the instruction encoding to generate a “power of 2” 32-bit operand. The logic necessary to perform these operations is disposed in stage 3 of the processor in the exemplary embodiment.

The And & Mask instruction behaves similar to the Bit set instruction previously described in that it allows a 5-bit value in the instruction encoding to generate a 32-bit mask. This feature utilizes a portion of the stage 3 logic described above.

The PUSH instruction stores a value into memory based on the value held in the stack pointer, and then increments the stack pointer. It is fundamentally a Store operation with address writeback mode enabled so that there is a pre-decrement to the address. This requires little modification to the existing processor logic. An additional POP instruction type is “POP PC” which may be split in the following manner:

| | |
|---|---|
| POP | Blink |
| J | [Blink] |

The POP instruction is the inverse in that it performs a load from memory based on the value in the stack pointer and then decrements the stack pointer. It is a load instruction with a post-increment to the address before storing to memory.

The MOV instruction is configured so that unsigned 12-bit constants can be moved into the core registers. The compare (CMP) instruction is basically a special encoding of a SUB instruction with flag setting and no destination for the result.

The LOOP instruction is configured so that it employs a register for the number of iterations in the loop and a short immediate value (shimm), which provides the offset for instructions encompassed by the loop. Additional interlocks are needed to enable single instruction loops. The Loopcount register is in one exemplary embodiment moved to the auxiliary register space. All registers associated with this instruction in the exemplary embodiment are 32-bits wide (i.e. LP_START, LP_END, LP_COUNT).

Exemplary Instruction Formats for the ISA of the invention are provided in Appendix I and FIGS. 1-5 herein. Exemplary encodings for the 32-bit ISA are defined in Table 4.

TABLE 4

| Constant Name | Width | Description |
|---|---|---|
| Isa32_width | 32 | This is width of the 32-bit ISA. |
| instr_ubnd | 31 | This is most significant bit of the opcode |
| | | field. |
| instr_lbnd | 27 | This is least significant bit of the opcode |
| | | field. |
| Aop_ubnd | 5 | This is the most significant bit of the |
| | | destination field. |
| Aop_lbnd | 0 | This is the least significant bit of the |
| | | destination field. |
| bop_2_ubnd | 26 | This is the most significant bit of the source |
| | | operand one field (lower 3-bits). |
| bop_2_lbnd | 24 | This is the least significant bit of the source |
| | | operand one field (lower 3-bits). |
| bop_1_ubnd | 14 | This is the most significant bit of the source |
| | | operand one field (upper 3-bits). |
| bop_1_lbnd | 12 | This is the least significant bit of the source |
| | | operand one field (upper 3-bits). |
| cop_ubnd | 11 | This is the most significant bit of the source |
| | | operand two field. |
| cop_lbnd | 6 | This is the least significant bit of the source |
| | | operand two field. |
| shimm16_1_u9_msb | 15 | This defines most significant bit of 9-bit |
| | | signed constant. |
| shimm16_2_u9_ubnd | 23 | This defines bit position 8 of 9-bit signed |
| | | constant. |
| shimm16_2_u9_lbnd | 16 | This defines least significant bit of 9-bit |
| | | signed constant. |
| shimm16_u5_ubnd | 4 | This is most significant bit of a 5-bit |
| | | unsigned immediate data. |
| shimm16_u5_lbnd | 0 | This is least significant bit of a 5-bit unsigned |
| | | immediate data. |
| targ_1_ubnd | 15 | This is the most significant bit of the branch |
| | | offset field (upper 10-bits). |
| targ_1_lbnd | 6 | This is the least significant bit of the branch |
| | | offset field (upper 10-bits). |
| targ_2_ubnd | 26 | This is the most significant bit of the branch |
| | | offset field (lower 10-bits). |
| targ_2_lbnd | 17 | This is the least significant bit of the branch |
| | | offset field (lower 10-bits). |
| setflgpos | 16 | Location of flag setting bit (.f). |
| single_op_ubnd | 21 | This is the most significant bit of the sub- |
| | | opcode field. |
| single_op_lbnd | 16 | This is the least significant bit of the sub- |
| | | opcode field. |
| shimm32_1_s8_msb | 15 | This is most significant bit of an 8-bit signed |
| | | immediate data. |
| shimm32_2_s8_ubnd | 23 | This is bit position 7 of an 8-bit signed |
| | | immediate data. |
| shimm32_2_s8_lbnd | 17 | This is least significant bit of an 8-bit signed |
| | | immediate data. |
| shimm32_u6_ubnd | 11 | This is most significant bit of a 6-bit |
| | | unsigned immediate data. |
| shimm32_u6_lbnd | 6 | This is least significant bit of a 6-bit unsigned |
| | | immediate data. |
| qq_ubnd | 4 | This is the most significant bit of the |
| | | condition code field. |
| qq_lbnd | 0 | This is the least significant bit of the |
| | | condition code field. |
| ls_nc | 5 | Direct data cache bypass (.di) |
| ls_awbck_ubnd | 4 | This is the most significant bit of the address |
| | | writeback field. |
| ls_awbck_ubnd | 3 | This is the least significant bit of the address |
| | | writeback field. |
| ls_s_ubnd | 2 | This is most significant bit for the data size |
| | | for LD/STs. |
| ls_s_lbnd | 1 | This is least significant bit for the data size |
| | | for LD/STs. |
| ls_ext | 0 | Sign extend bit (.x). |
| pc_size | 32 | Number of bits in the program counter. |
| pc_msb | 31 | This is most significant bit of the PC. |
| loopcnt_size | 32 | Number of bits in the loop counter. |
| loopcnt_msb | 31 | This is most significant bit of the loopcount register. |

As previously stated, four additional or auxiliary registers are provided in the processor since the program counter (PC) is extended to 32-bits wide. These registers are: (i) PC32; (ii) Status32; and (iii) Status32_{—}11/Status32_{—}12. These registers complement existing status registers by allowing access to the full address space. An added flag register also allows expansion for additional flags. Table 5 shows exemplary mappings for these registers.

TABLE 5

| Auxillary | | | |
|---|---|---|---|
| Register | Register | | |
| Address | Type | Register Name | Description |
| 0x0 | Read/Write | Status | Status register which holds |
| | | | 24-bit PC, flags, halt |
| | | | status, and interrupt info. |
| 0x1 | Read/Write | Semaphore | Inter-process/host semaphore |
| | | | register. |
| 0x2 | Read/Write | Lp_start | Loop start address (32-bit). |
| 0x3 | Read/Write | Lp_end | Loop end address (32-bit). |
| 0x4 | Read only | Identity | Core Identification Register |
| | | | (basecase core auxiliary |
| | | | register). |
| 0x5 | Read/Write | Debug | Debug Register (basecase core |
| | | | auxiliary register). |
| 0x6 | Read/Host | PC32 | This holds the new 32-bit PC. |
| | Write | | |
| 0x7 | Read/Write | STATUS32 | This contains the |
| | | | information on the ALU flags, |
| | | | halt bit, and interrupts. |
| TBD | Read/Write | STATUS32_ | Status register for level 1 |
| | | L1 | exceptions. |
| TBD | Read/Write | STATUS32_ | Status register for level 2 |
| | | L2 | exceptions. |

16-Bit Instruction Set Architecture

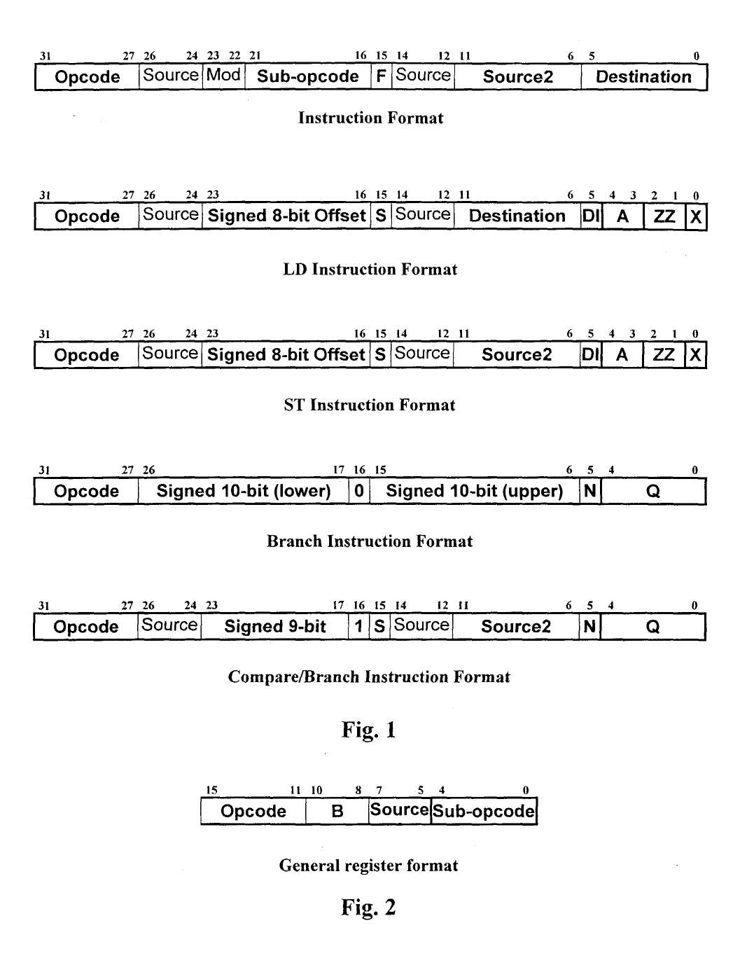

Referring now to FIGS. 2-5, an exemplary embodiment of the 16-bit portion of the processor ISA is described. As previously discussed, a 16-bit instruction set is employed within the exemplary configuration of the invention to ultimately reduce memory overhead. This allows users/designers to, inter alia, reduce their costs with regards to external memory. The 16-bit portion of the instruction set (ISA) is now described in detail.

Core Register Mapping—An exemplary format of the core registers are defined in Table 6 for the 16-bit ISA in the processor. The encoding for the core registers is 3-bits wide so that there are only 8. From the perspective of application software, the most commonly used registers from the 32-bit register mappings have been linked to the 16-bit register mapping.

TABLE 6

| | Core | 32-bit | |
|---|---|---|---|
| Register | Register | ISA | |
| Number | Name | Register | Description |
| 0 to 3 | r0 to r3 | r0 to r3 | Argument Registers as defined in the |
| | | | Application Binary Interface (ABI). |
| 4 | r4 | r12 | Saved Registers |
| 5 | r5 | r13 | |
| 6 | r6 | r14 | |
| 7 | r7 | r15 | |

One exemplary embodiment of the 16-bit ISA, in the context of the aforementioned ARCtangent A4 processor, is shown in Table 7. Note that existing instructions (e.g., those of the A4) have been re-organized to fit between opcode slots 0×0C to 0×1F.

TABLE 7

| Instruction | | |
|---|---|---|
| Opcode | Instruction Type | Description |
| 0x0C | LD/ADD | Load and addition with short immediate |
| | | offset |
| 0x0D | ADD/SUB/ | Delayed loads from memory and stores. |
| | ASL/LSR | Fornat is register + shimm |
| 0x0E | MOV/CMP | Move and compare with access to full |
| | | 64 registers in core register file |
| 0x0F | Operation | Arithmetic & Logic operations |
| | Format 1 | |
| 0x10 | LD | Delayed load from memory with 7-bit |
| | | unsigned shimm offset. |
| 0x11 | LDB | Delayed load byte from memory with 5- |
| | | bit unsigned shimm offset. |
| 0x12 | LDW | Delayed load word from memory with |
| | | 6-bit unsigned shimm offset. |
| 0x13 | LDW.x | Delayed load word from memory. |
| 0x14 | ST | Store to memory. Fornat includes |
| | | register + 7-bit unsigned shimm. |
| 0x15 | STB | Store to byte memory. Fornat includes |
| | | register + 5-bit unsigned shimm. |
| 0x16 | STW | Store to word memory. Fornat includes |
| | | register + 6-bit unsigned shimm. |
| 0x17 | Operation | This includes asr, asl, subtract, single |
| | format 1 | operand and logical instructions. |
| 0x18 | LD/ST SP | Delayed load from memory from |
| | POP | address 9-bit unsigned offset + PC (or |
| | PUSH | 6-bit unsigned offset + SP). Also has |
| | | Pop/Push. |
| 0x19 | LD GP | Load from address relative to global |
| | | pointer to r0 |
| 0x1A | LD PC | Load from address relative to the PC |
| 0x1B | MOV | Move instruction with unsigned short |
| | | immediate value. |
| 0x1C | ADD/CMP | Add and compare instruction. |
| 0x1D | BRcc | Compare and branch instruction |
| 0x1E | Bcc | Branch conditionally |
| 0x1F | BL | Branch & link |

A detailed description of each instruction is provided in the following sections. The format of the 16-bit instruction employing registers is as shown in FIG. 2. Each of the fields in the general register instruction format of FIG. 2 perform the following functions: (i) bits 4 to 0—Sub-opcode field provides the additional options available for the instruction type or it can be a 5-bit unsigned immediate value for shifts; (ii) Bits 7 to 5—Source2 field contains the second source operand for the instruction; (iii) Bits 10 to 8—B-field contains the source/destination for the instruction; and (iv) Bits 15 to 11—Major Opeode.

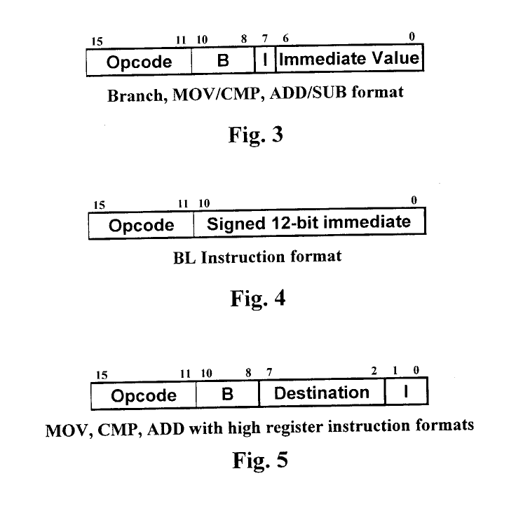

FIG. 3 illustrates an exemplary Branch, MOV/CMP, ADD/SUB format. The fields encode the following: (i) Bits 6 to 0—Immediate data value; (ii) Bit 7—Sub-opcode; (iii) Bits 10 to 8—B-field contains the source/destination for the instruction; (iv) Bits 15 to 11—Major Opcode.

FIG. 4 illustrates an exemplary BL Instruction format. The fields encode the following: (i) Bits 10 to 0—Signed 12-bit immediate address longword aligned; and (ii) Bits 15 to 11—Major Opcode

FIG. 5 shows the MOV, CMP, ADD with high register instruction formats. Each of the fields in the instruction perform the following functions: (i) Bits 1 to 0—Sub-opcode field; (ii) Bits 7 to 2—Destination register for the instruction; (iii) Bits 10 to 8—B-field contains the source operand for the instruction; and (iv) Bits 15 to 11—Major Opcode

The different formats for the LD/ST Instructions (0×0C-0×0D, 0×10—0×17, 0×1B) are defined in Table 8. The unsigned constant is shifted left as required by the data access alignment.

TABLE 8

| Instruction | | |
|---|---|---|
| Opcode | Operation | Description |
| 0x0C | LD b, [pc, u9] | Delayed load from memory with PC + 9-bit |
| | | unsigned shimm offset. |
| 0x0D | LD/ST b, [gp, | Delayed load from memory with GP + 9-bit |
| | u9] | unsigned shimm offset. |
| 0x10 | LD a, [b, u7] | Delayed load from memory with 7-bit |
| | | unsigned shimm offset. |
| 0x11 | LDB a, [b, u5] | Delayed load byte from memory with 5-bit |
| | | unsigned shimm offset. |
| 0x12 | LDW a, [b, u6] | Delayed load word from memory with 6-bit |
| | | unsigned shimm offset. |
| 0x13 | LDW.x a, [b, | Delayed load word from memory with 6-bit |
| | u6] | unsigned shimm offset. |
| 0x14 | ST a, [b, u7] | Store to memory. Format includes register + |
| | | 7-bit unsigned shimm. |
| 0x15 | STB a, [b, u6] | Store to byte memory. Format includes |
| | | register + 5-bit unsigned shimm. |
| 0x16 | STW a, [b, u6] | Store to word memory. Format includes |
| | | register + 6-bit unsigned shimm. |
| 0x17 | LD a, [pc, u9] | Delayed load from memory with PC + 9-bit |
| | | unsigned shimm offset. This is a new 32-bit |
| | | instruction. |
| 0x17 | LD a, [sp, u6] | Load from memory with SP + 6-bit unsigned |
| | | shimm offset. This is 32-bit aligned. |
| 0x17 | LDB a, [sp, u6] | Load from memory with SP + 6-bit unsigned |
| | | shimm offset. This is 32-bit aligned. |
| 0x17 | ST a, [sp, u6] | Store from memory with SP + 6-bit |
| | | unsigned shimm offset. This is 32-bit |
| | | aligned. |
| 0x17 | STB a, [sp, u6] | Store from memory with SP + 6-bit |
| | | unsigned shimm offset. This is 32-bit |
| | | aligned. |
| 0x1B | LD c, [a, b] | Delayed load word from memory with |
| | | address [register + register]. |
| 0x1B | LDB c, [a, b] | Delayed load word from memory with |
| | | address [register + register]. |
| 0x1B | LDW c, [a, b] | Delayed load word from memory with |
| | | address [register + register]. |

The PUSH instruction stores a value into memory based on the value held in the stack pointer, and then increments the stack pointer. It is fundamentally a Store with address writeback mode enabled so that there is a pre-decrement to the address. This requires little modification to the existing processor logic. An additional POP instruction type is “POP PC” which may be split in the following manner:

| | |
|---|---|
| POP | Blink |
| J | [Blink] |

The POP instruction is the inverse in that it performs a load from memory based on the value in the stack pointer and then decrements the stack pointer. It is a load instruction with a post-increment to the address before storing to memory.

The LD PC Relative instruction allows LD instructions for the 16-bit ISA to be relative the PC. This can be implemented by having register r63 as a read only value of the PC. This is available as a source register to all other instructions.

The exemplary 16-bit ISA also provides for a Scaled Index Addressing Mode; here, operand2 can be shifted by the size of the data access, e.g. zero for byte, one for word, two for longword.

The Shift & Add/Subtract instruction allows a value to be shifted left 0, 1, 2 or 3 places and then it will be added to the contents of a register. This removes the need for long immediate data (limm). This adds an additional overhead in stage 3 of the processor since there are 2 levels of logic added to the input of the 32-bit adder (bigalu).

Standard (i.e., basecase core IS) ADD/SUB with SHIMM Operand instructions comprise basecase core arithmetic instructions.

The Shift Right and Mask extension instruction shifts based upon a 5-bit value, and then the result is masked based upon another 4-bit constant, which define a 1 to 16-bit mask. These 4-bit and 5-bit constants are packed into the 9-bit shimm value. The functionality is basically a barrel shift followed by the masking process. This can be set in parallel due to the encoding, although the calculation is performed sequentially. Existing barrel shifter logic may be used for the first part of the operation, however, the second part requires additional dedicated logic which is readily synthesized by those of ordinary skill. This functionality is part of the barrel shifter extension, and in implementation advantageously adds only a small number (approx 50) of gates to the gate count of the existing barrel shifter.

The Bit Set, Clear & Test instructions of the 16-bit IS remove the need for a long immediate (limm) data for masking purposes. This allows a 5-bit value in the instruction encoding to generate a “power of 2” 32-bit operand. The logic necessary to perform these operations is disposed in stage 3 of the processor, and consumes approx. 100 additional gates. The CMP instruction is a SUB instruction with no destination register with flag setting enabled, i.e. SUB.f 0, a, u7 where u7 is an unsigned 7-bit constant.

The Branch and Compare instructions takes a branch based upon the result of a comparison. This instruction is not conditionally executed and it does not have a flag setting capability. This requires that the branch address to be calculated in stage 2 of the pipeline, and the comparison to be performed in stage 3. Hence, an implementation that takes the branch once the comparison has been performed. This will produce 2 delay slots. However, an alternative solution is to take the branch in stage 2, and if the comparison proves to be false, then the processor can execute from point immediately the after the cmp/branch instruction.

For the 32-bit version of this instruction, there may also be provided an optional hint flag which in the exemplary embodiment defaults to either always taking the branch or always killing the branch. Hence, a 32-bit register holding the PC of the path not taken has to be stored in stage 2 to perform this function.

There are two branch instructions associated with the 16-bit IS; i.e., (i) Branch conditionally, and (ii) Branch and link. The Branch conditionally (Bcc) instruction has signed 16-bit aligned offset and has a longer range for certain conditions, i.e. AL, EQ, NE. The Branch and Link instruction has a signed 32-bit aligned offset so that it has a greater range. Table 9 lists exemplary types of branch instructions available within the ISA.

TABLE 9

| Instruction | | |
|---|---|---|
| Opcode | Operation | Description |
| 0x1E | BAL s10 | Branch always with 10-bit signed immediate |
| | | offset |
| 0x1E | BEQ s10 | Branch when equal to flags set with 10-bit |
| | | signed immediate offset |
| 0x1E | BNE s10 | Branch when not equal to flags set with 10- |
| | | bit signed immediate offset |
| 0x1E | BGT s7 | Branch when greater than flags set with 7-bit |
| | | signed immediate offset |
| 0x1E | BGE s7 | Branch when greater than or equal to flags |
| | | set with 7-bit signed immediate offset |
| 0x1E | BLT s7 | Branch when less than flags set with 7-bit |
| | | signed immediate offset |
| 0x1E | BLE s7 | Branch when less than or equal to flags set |
| | | with 7-bit signed immediate offset |
| 0x1E | BHI s7 | Branch when not equal with 7-bit signed |
| | | immediate offset |
| 0x1E | BHS s7 | Branch when not equal with 7-bit signed |
| | | immediate offset |
| 0x1E | BLO s7 | Branch when not equal with 7-bit signed |
| | | immediate offset |
| 0x1E | BLS s7 | Branch when not equal with 7-bit signed |
| | | immediate offset |
| 0x1F | BL s13 | Branch & link with 13-bit signed immediate |
| | | offset. The BLINK register takes the value |
| | | of the PC before the branch is taken. |

It is noted that when performing a compressed (16-bit) Jump or a Branch instruction, the associated delay slot should always include another 16-bit instruction. This instruction is either executed or not executed similar to a normal 32-bit instruction. Branches and jumps cannot be included in the delay slots of instructions in the present embodiment, although other configurations may be substituted.

Additional instructions included within the Instruction Set Architecture (ISA) of the present invention comprise of the following: (i) LD/ST Addressing Modes; (ii) Mov Instruction; (iii) Bit Set, Clear & Test; (iv) And & Mask; (v) Cmp & Branch; (vi) Loop Instruction; (vii) Not Instruction; (viii) Negate Instruction; (ix) Absolute Instruction; (x) Shift & Add/Subtract; and (xi) Shift Right & Mask (Extension). The implementation of these instructions is described in detail in the following sections.

The addressing modes for load/store operations (LD/STs) are partitioned as follows:

1. Pre-update mode—Take address before performing addition in the ALU

2. Post-update mode—Take address after performing addition in the ALU

3. Scaled addressing modes—Short immediate constant is shifted based upon the opcode encoding of instruction (see discussion below).

The pre/post update addressing modes are performed in stage 3 of the processor and are described in greater detail subsequently herein. The POP/PUSH instructions are decoded as LD/ST operations respectively in stage 2 with address writeback enabled to the stack pointer (e.g., r28).

The MOV instruction is decoded in stage 2 of the processor and maps to the AND instruction which is present in the base instruction set. There are interlocks provided that handle the long immediate data encoding (r62) or the PC (r63) as the destination address. This interlock may be made part of the compiler assembler since all instructions that use the aforementioned registers as destinations will not perform a write operation.

The Bit Set (BSET), Clear (BCLR), Test (BTST) and Mask (BMSK) instructions remove the need for a long immediate (limm) data for masking purposes. This allows a 5-bit value in the instruction encoding to generate a “power of 2” 32-bit operand. The logic necessary to perform these operations is disposed in stage 3 of the exemplary processor. This “power of 2” operation is effectively a simple decode block. This decode is performed directly before the ALU logic, and is common to all of the bit processing instructions described herein.

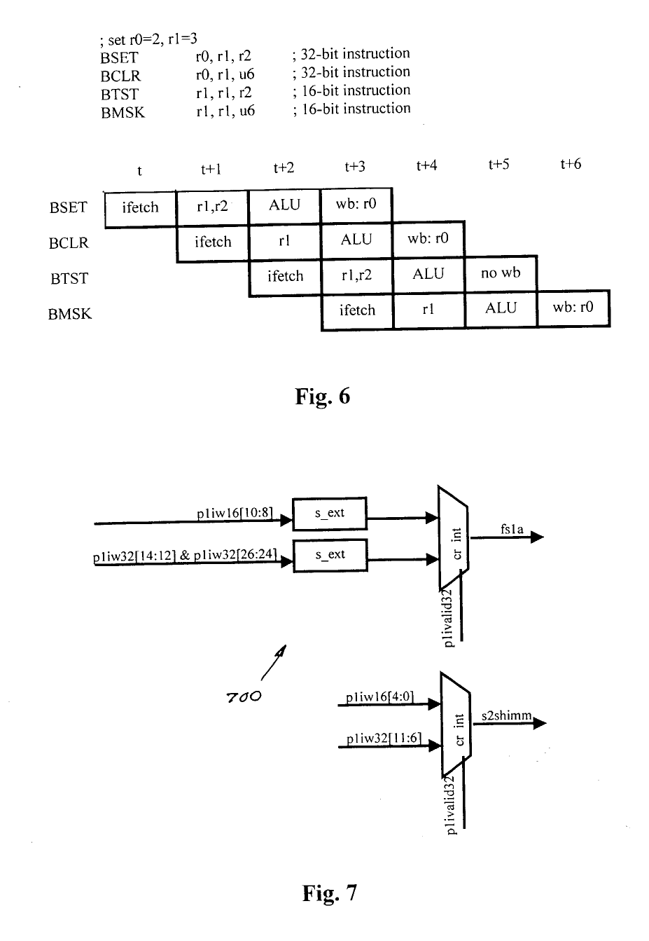

FIG. 6 is a pipeline diagram illustrating the operation of the foregoing instructions. For the Bit Set (BSET) operation, the following sequence is performed:

1. At time (t) the 2 source fields which are ‘s1a’ and either ‘fs2a’ or ‘s2shimm’ are extracted using the exemplary logic 700 of FIG. 7. The result address ‘dest’ is also extracted.

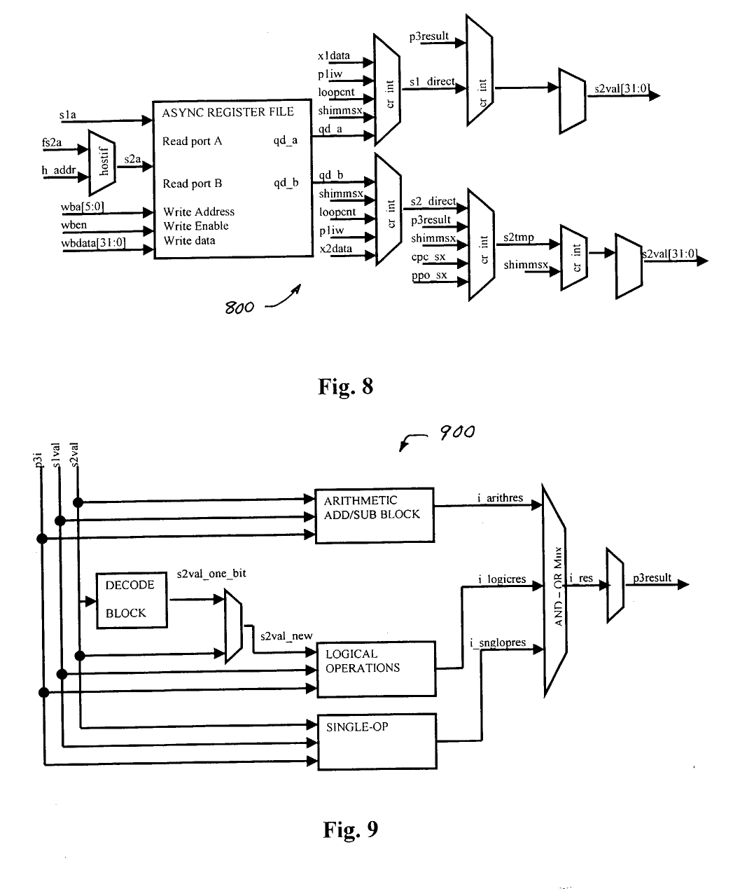

2. At time (t+1) the instruction is in stage 2 of the pipeline and the logic 800 extracts the data ‘s1val’ from the register file and ‘s2val’ from either the register file (using address ‘s2a’) or ‘p2shimm’ as shown in FIG. 8.

3. At time (t+2) a decoder 902 in stage 3 900 (FIG. 9) decodes ‘s2val’ into ‘s2val_one_bit’. A mux 904 then selects ‘s2val_one_bit’ to produce ‘s2val_new’. This data is fed into the LOGIC block 906 within ‘bigalu’ together with ‘s1val’ to perform an OR operation. The result is latched into ‘wbdata’.

4. At time (t+3) in stage 4 the ‘wben’ signal is asserted together with setting ‘wba’ to the original ‘dest’ address to perform the write-back operation.

For a Bit Clear instruction, the ALU effectively performs a BIC operation on the decoded data. For the Bit Test instruction, the ALU effectively performs an AND.F operation on the decoded data for bit test instruction. This will set the zero flag if the tested bit is zero. Also, in stage 1 address 62 (‘limm’ address) is placed onto the ‘dest’ field which prevents a writeback from occurring.

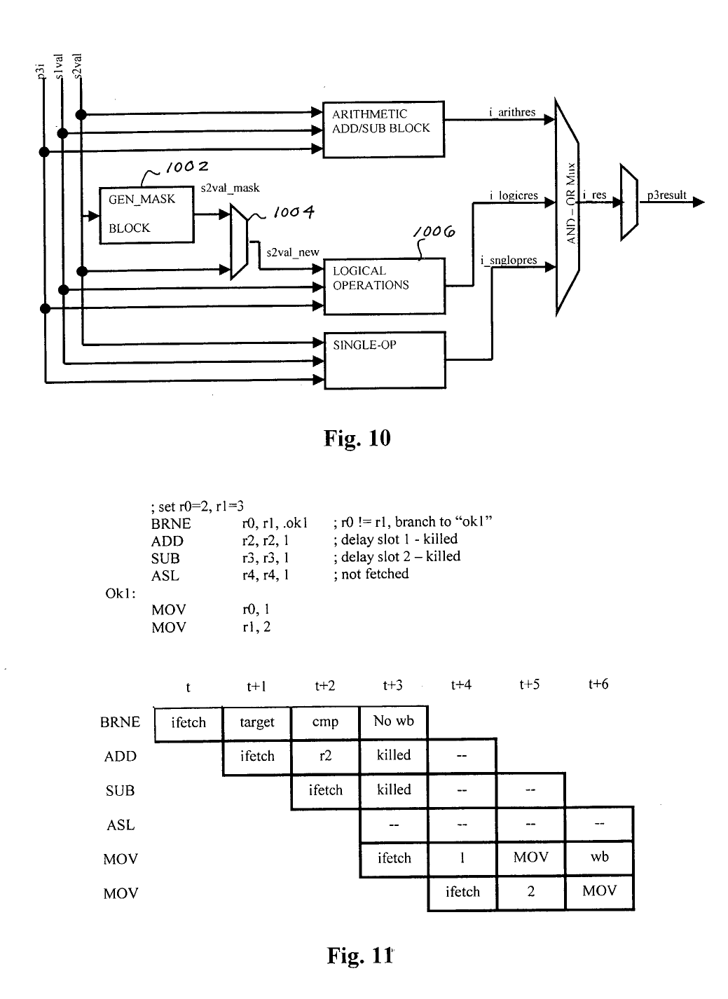

The Bit Mask instruction differs from the rest in stage 3. As shown in FIG. 10, a mask is first generated in the mask generator block 1002 with (u6+1) ones called ‘s2val_mask’. This mask is then muxed via the mux 1004 onto ‘s2val_new’ before entering the LOGIC block 1006 which ANDs this mask with register ‘s1val’.

The And & Mask instruction of the present embodiment behaves similar to the Bit set instruction in that it allows a 5-bit value in the instruction encoding to generate a 32-bit mask, which is then ANDed with the value from source operand 1 in the register (s1val).

The Compare & Branch instruction requires the branch address to be calculated in stage 2 of the pipeline, and the comparison to be performed in stage 3. Hence, an implementation that takes the branch once the comparison has been performed is needed; this will produce 2 delay slots.

The flow of the Branch Taken But Delay Slot Not Used (BRNE) instruction through the pipeline can be seen in FIG. 11. For the BRNE instruction, the following sequence is performed:

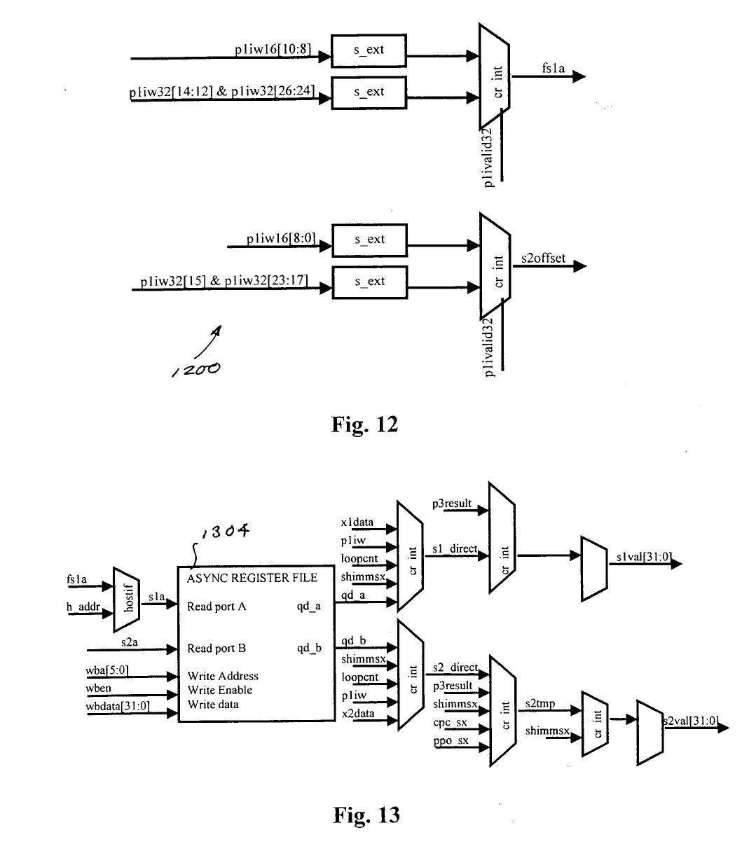

1. At time (t) the BRNE instruction enters stage 1 of the pipeline where ‘p1iw16’ or ‘p1iw32’ is split and latched into ‘p2offset’, ‘p2cc’, ‘fs1a’, and ‘s2a’ or ‘p2shimm’ using the logic 1200 of FIG. 12.

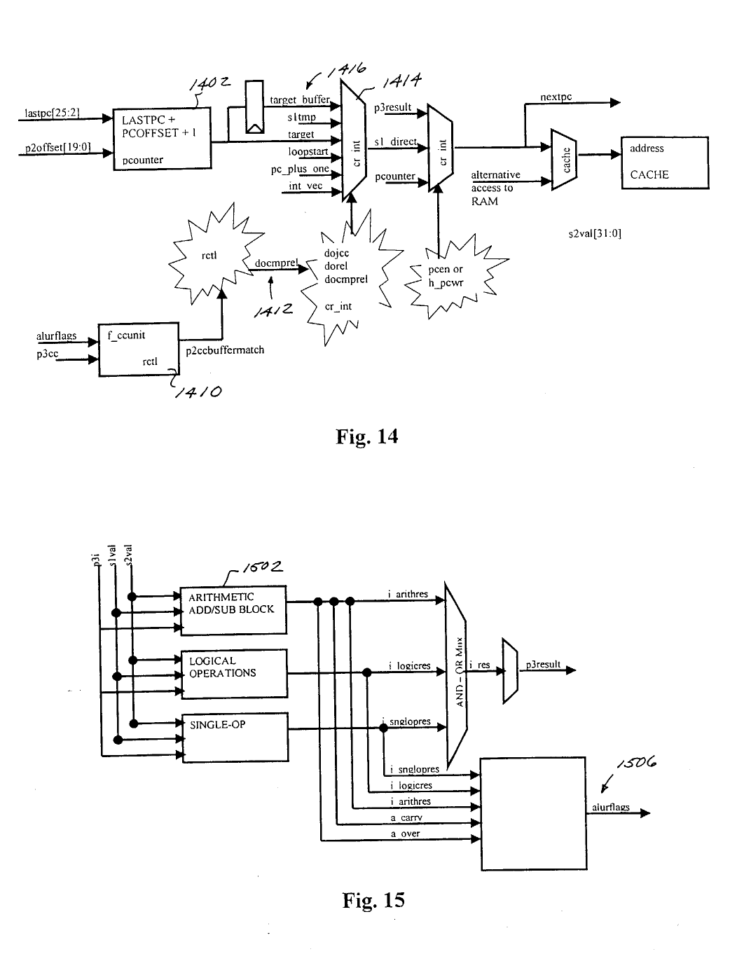

2. At time (t+1) ‘fs1a’ is muxed via the mux 1302 with ‘h_addr’ to produce ‘s1a’ which addresses the register file 1304 to produce the value ‘pd_a’; see FIG. 13. This value is then latched into ‘s1val’. At the same time the latched value ‘s2val’ is produced either from the register file 1304 which is addressed by ‘s2a’ or from ‘p2shimm’. Also in stage 2, ‘p2offset’ is added to ‘last_pc’+1 in the logic block 1402 to produce ‘target’ which is then latched into ‘target_buffer’ (see FIG. 14). The condition code signal ‘p2cc’ needs to be stored but ‘p3cc’ already exists so there is no need to create, for example, ‘p2ccbuffer’.

3. At time (t+2) ‘s2val’ is decoded to produce ‘s2val_one_bit’ which is a value with only one bit set. These 2 signals are muxed together to produce ‘s2val_new’. The ‘s2val_one_bit’ value is only selected if performing a BBIT instruction; otherwise the mux selects ‘s2val’. Within the block ‘bigalu’ the process ‘type_decode’ selects either the ‘arith’ block 1502 or ‘logic’ block 1504 to perform the operation depending on whether a BRcc instruction or a BBIT instruction is present (see FIG. 15). The flag signals in ‘alurflags’ 1506 are normally latched into ‘aluflags’ in the ‘aux_regs’ block. However, in this case a short-cut ‘aluflags’ back to stage 2 is needed to allow a branch decision to be made without introducing a stall. In the ‘rctl’ block 1410 (FIG. 14) the signal ‘ip2ccbuffermatch’ is required to match ‘p3cc’ against ‘alurflags’ therefore deciding if the branch should be taken. Also, an extra output ‘docmprel’ 1412 which checks signal ‘p3iw’ to see if it is a BR or BBIT instruction is provided. This ‘docmprel’ signal goes to the ‘cr_int’ block 1414 where it causes ‘pcen_related’ to select ‘target_buffer’ 1416 as the next address.

4. At time (t+3) ‘current_pc’ (current program counter) has the value of the branch target and ‘p1iw’ contains the instruction at that target. The instructions in stages 2 and 3 are now killed by de-asserting ‘p2iv’ and ‘p3iv’. Asserting ‘p3killnext’ kills ‘p3iv’. This assertion is achieved by the added condition ‘p3iw=obr AND p2dd=nd’. Asserting ‘p2killnext’ similarly kills the second delay slot. This assertion is achieved by the added condition ‘p3iw=obr OR p3iw=obbit’.

The Negate (NEG) instruction employs an encoding of the SUB instruction, i.e. SUB r0, 0, r0. Therefore the NEG instruction is decoded as SUB instruction with source two-operand to specify the value to be negated and this is also the destination register. The value in the source one-operand field will always be zero according to the present embodiment.

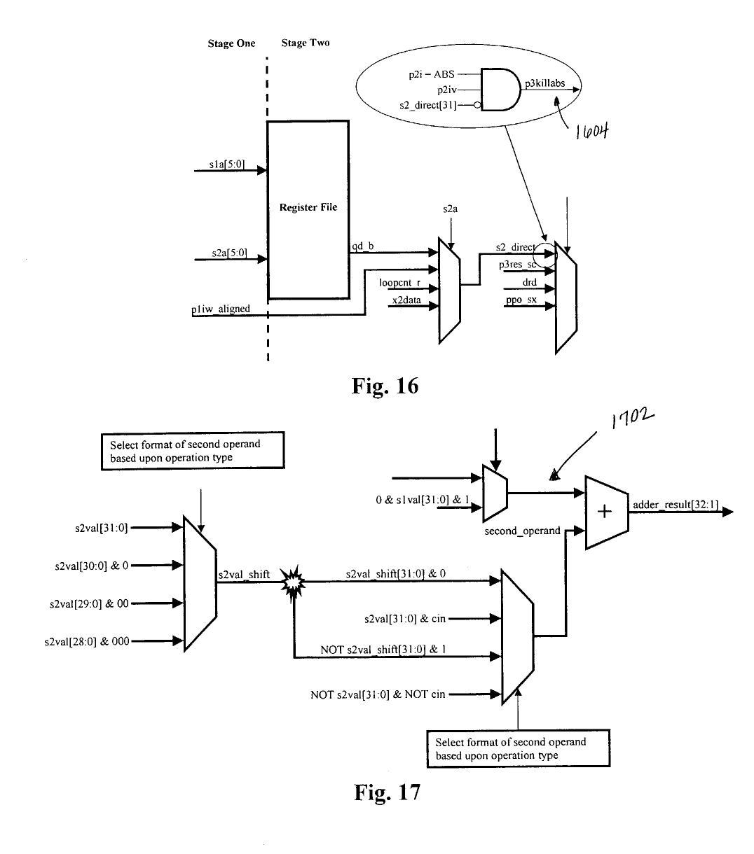

If the source operand is negative (most significant bit=1), then the NEG operation is performed; otherwise it is permitted to pass through unchanged. This functionality is implemented in stage 2 and three of the pipeline in the present embodiment; see FIG. 16. The Absolute (ABS) instruction performs the following operation upon a signed 32-bit value: (i) positive number remains unchanged; and (ii) negative number requires a NEG operation to be performed on the source two operand. This means that if the most significant bit (msb) of s2_direct 1602 is ‘1’, then a NEG is performed in stage 3 on s2val. However, if the msb is ‘0’ then the ABS instruction is killed in stage 3, p3iv=0. This means the value is already an absolute value and need not be changed. As shown in FIG. 16, the signal employed for killing an ABS instruction in stage 3 is p3killabs 1604.

The Shift & Add/Subtract (extension) instructions employ a constant, which determines how many places the immediate value should be shift before performing the addition or subtraction. Therefore source operand two can be shifted between 1 and 3 places left before performing the arithmetic operation. This removes the need for long immediate data for the most common cases. The shifting operation is performed in stage 3 of the processor pipeline by logic 1702 associated with the “base” arithmetic unit (described below) to perform the shift before the addition/subtraction. See FIG. 17.

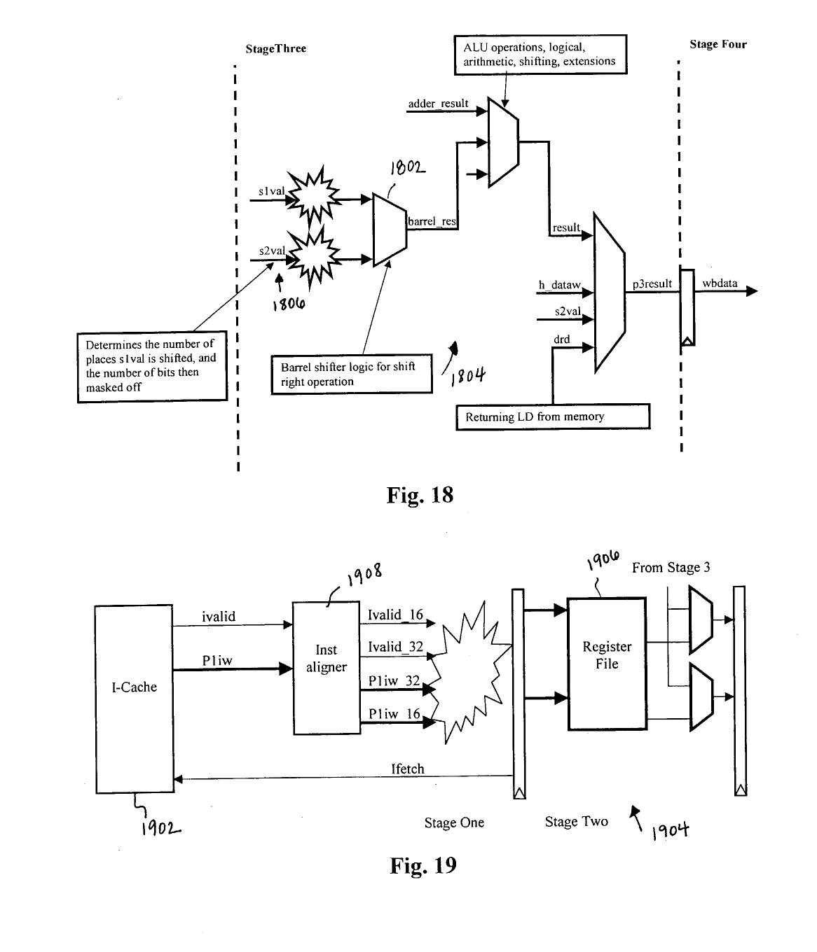

The Shift Right & Mask (extension) instruction is to shift based upon a 5-bit value, and then the result is masked based upon another 4-bit constant, which defines a 1 to 16-bit wide mask. These 4-bit and 5-bit constants are packed into the 9-bit shimm value. The fanctionality is basically a barrel shift followed by the masking process. This can be performed in parallel due to the encoding, although the calculation is performed sequentially. An existing barrel shifter 1802 (FIG. 18) may be used for the first part of the operation; however, the second part requires dedicated logic 1804. This functionality is made part of the barrel shifter extension in the illustrated embodiment.

Hence, as shown in FIG. 18, the subopcode for the Shift Right & Mask instruction is decoded in stage 2 and this will flag that s2val 1806 is part of the control for the Shift Right & Mask instruction in stage 3.

Hardware Implementation

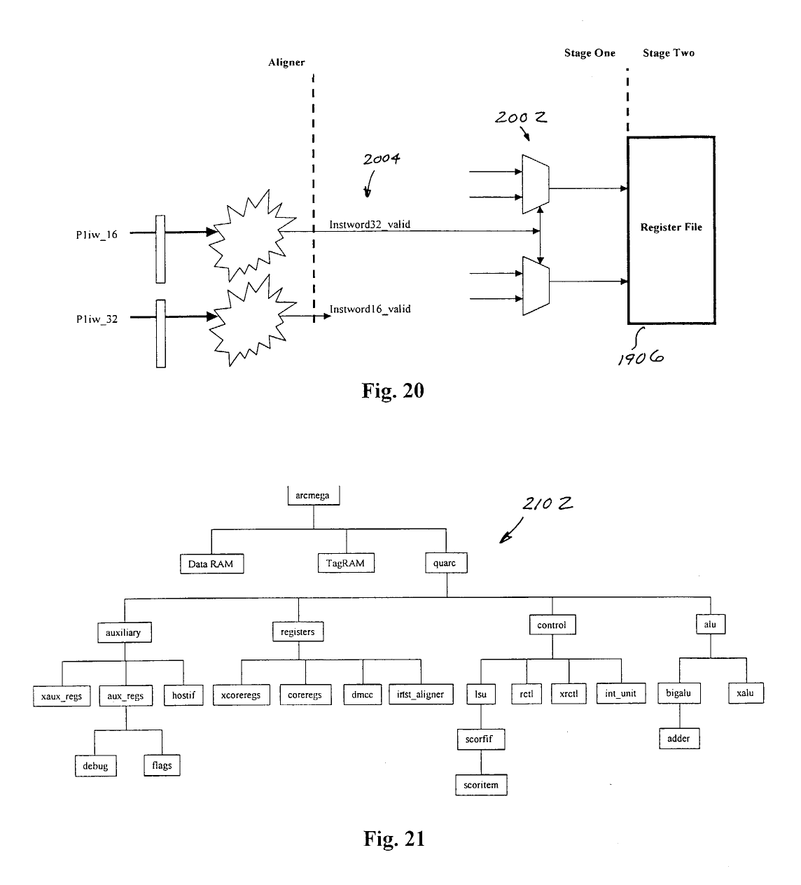

Referring now to FIGS. 19-20, exemplary hardware implementing the combined 16/32-bit ISA in the four-stage pipeline (i.e., fetch, decode, execute, and writeback stages) of the exemplary processor is now described. As shown in FIG. 19, one primary area of difference over prior art configurations lies between the instruction cache 1902 and stage 2 1904 of the processor that performs the operand fetch from the core register file 1906. In the exemplary embodiment, a module 1908 is provided, herein referred to as the “instruction aligner”. The aligner 1908 of the illustrated embodiment provides a 32-bit instruction and a 16-bit instruction to stage 1 of the processor. Only one of these instructions will be valid, and this is determined by the decode logic (not shown) in stage 1. The operand fetch logic at the input of the register file 1906 is provided with an additional multiplexer 2002 (FIG. 20) so it selects the appropriate operands based upon either the 16-bit or 32-bit instruction.

The instruction aligner 1908 is also configured to generate a signal 2004 to specify which instruction is valid, i.e. 32-bit or 16-bit. It contains an internal buffer (16-bits wide in the exemplary embodiment) when there are 16-bit accesses or unaligned accesses so that the latency of the system is kept to a minimum. Basically, this means an instruction that only uses half of the fetched 32-bit instruction requires a buffer. Hence, an instruction that crosses a longword boundary will not cause a pipeline stall even though two longwords need to be fetched.

The second stage of the processor is also configured such that the logic that generates the target addresses for Branches includes a 32-bit adder, and the control logic to support new instructions, CMP & Branch instructions. The ALU stage also supports pre/post incrementing logic in addition to shift and masking logic for these instructions. The writeback stage of the processor is essentially unchanged since the exemplary ISA disclosed herein does not employ additional writeback modes.

Integration of Code Compression

The code compression scheme of the present invention requires proper configuration of the configuration files associated with the core; e.g., those below the quarc level 2102 in the exemplary processor design hierarchy of FIG. 21. The control and data path in stage 1 and stage 2 of the pipeline are specially configured, and the instructions and extensions of the 32/16-bit ISA are integrated. For example, in the context of the ARCtangent processor hierarchy of FIG. 21, the main modules affected in the core configuration are: (i) arcutil, extutil,xdefs (for the register, operands and opcode mapping for the 32-bit ISA, appropriate constants are required); (ii) rctl (configuration to support the additional instruction format); (iii) coreregs, aux_regs, bigalu (the new formats for certain basecase instructions may under certain circumstances result in modifications to these files); (iv) xalu, xcore_regs, xrctl, xaux_regs (Shift and Add extension requires proper configuration of these files); and (v) asmutil, pdisp (configuration of the pipeline display mechanism for the ISA). Additionally, new extension instructions require properly configured extension placeholder files; i.e., xrctl, xalu, xaux_regs, and xcoreregs.

These blocks are partitioned into these respective modules to allow the optimization of internal critical paths without excessive cross-boundary optimization being necessary. Each of the parent modules for these extension files, control, alu, auxiliary and registers, is internally flattened to assist the synthesis process. Specifically referring to the exemplary hierarchy of FIG. 21, all hierarchy below blocks control, registers, auxiliary and alu is flattened.

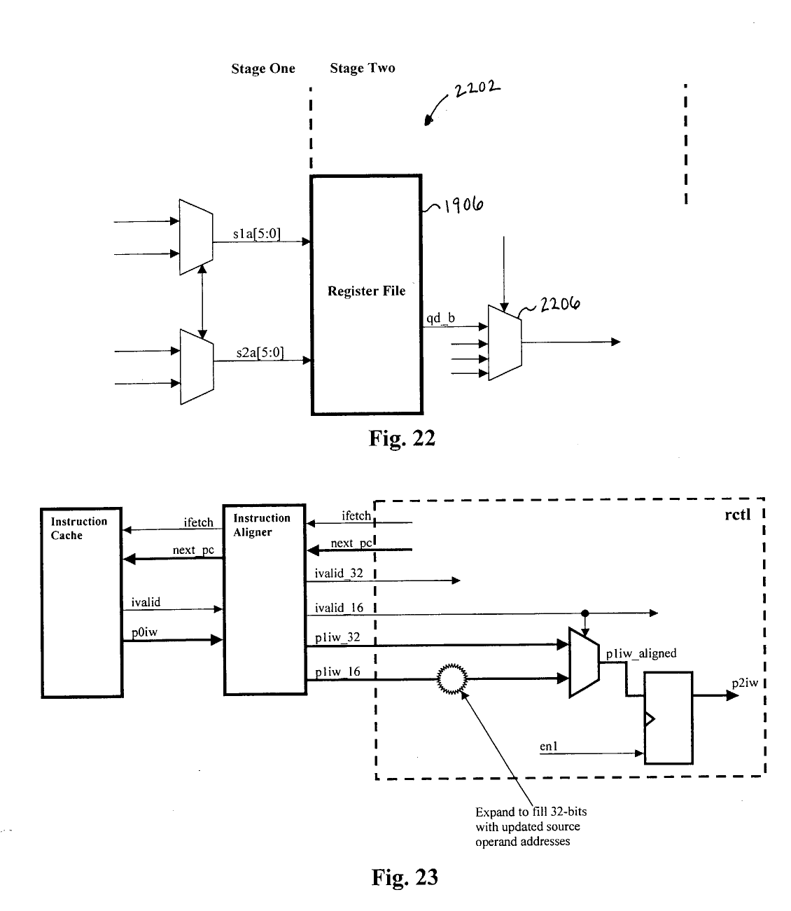

Referring now to FIG. 22, the instruction decode, execute, writeback, and fetch interfaces of the present invention are described in detail.

In the illustrated embodiment of FIG. 22, the second stage 2202 of the processor selects the operands from the register file 1906 in addition to generating the target address for Branch operations. In this stage, the control unit (rctl) flags that the next longword should be long immediate data, and this is signalled to the aligner 1908 (see FIG. 19) in stage 1. The second stage 2202 also updates the load scoreboard unit (1su) when LDs are generated.

Referring back to FIG, 21, the sub-modules that are reconfigured to support a combined 32/16-bit ISA (with associated signals) of the present embodiment are as shown in Table 10.

TABLE 10

| Submodule | Signal(s) |
|---|---|
| rctl | p2iv, en2, mload, mstore, p2limm |
| cr_int | currentpc, en2, s1val, s2val |
| lsu | en2, mload, mstore |
| aux_regs, pcounter, flags | currentpc, en2 |
| loopcnt | currentpc |
| int_unit | p2iv, p2int, en2 |
| sync_regs | en2 |

The adder 4006 (see FIG. 40) in stage 2 2202 of the pipeline for generating target addresses for branches is modified so that it is 32-bits wide. There are also other aspects of the decode stage configuration which support the added instruction formats. For example, the CMP BRANCH instruction necessitates configuring the control logic so that the delay slot mechanism remains unchanged. Therefore, branches will be taken in stage 2 before knowing whether the condition is true, since this is evaluated in the ALU stage. Hence, a comparison that proves to be untrue will result in the jump being killed, and retracing the pipeline to the point after the branch and continue execution from that point.

The fourth stage of the pipeline of the exemplary RISC processor described herein is the writeback stage, where the results of operations such as returning loads and logical operation results are written to the register file 1906; e.g. LDs and MOVs. The sub-modules configured to support a combined 32/16-bit ISA (with associated signals) are as follows:

| | |
|---|---|
| 1. | rctl - p3iv, en3, p3_wben, p3lr, p3sr |
| 2. | cr_int - next_pc, en2 |
| 3. | aux_regs, pcounter, flags - p3sr, p3lr, en3 |
| 4. | loopcnt - next_pc |
| 5. | int_unit - p3iv, en3 |
| 6. | bigalu - en3, mc_addr, p3int |
| 7. | sync_regs - en2 |

Additional multiplexing logic is added in front of 32-bit adder in stage 3 of the pipeline for generating addresses and other arithmetic expressions. This includes masking and shifting logic for the instructions, e.g. Shift Add (SADD), Shift Subtract (SSUB). The output of the ALU also contains additional multiplexing logic for the incrementing modes for PUSH/POP instructions. Such logic is readily generated by those of ordinary skill given the disclosure provided herein, and accordingly not described in greater detail.

The interrupts in the exemplary processor described herein are configured so that the hardware stores both the value in the new Status register (mapped into auxiliary register space) and the 32-bit PC when an interrupt is serviced. The registers employed for interrupts are as follows:

(i) Level 1 Interrupt

32-Bit PC—ILINK1 (r29)

Status information—Status_i11

(ii) Level 2 Interrupt

32-Bit PC—ILINK2 (r30)

Status information—Status_i12

The format of the status registers are defined in the same way as the Status32 register.

The configuration of the instruction fetch (ifetch) interface of the processor needed to support the combined 32/16-bit ISA of the invention is now described. The signals at the instruction fetch interface are defined in Table 11.

TABLE 11

| Signal | Input/ | Bus | |
|---|---|---|---|
| Name | Output | Width | Description |
| do_any | input | 1 | A jump/branch has been taken |
| en1 | output | 1 | This is the enable for stage 1 of the |
| | | | pipeline. |
| ifetch | output | 1 | This is the instruction fetch signal |
| | | | from the processor. |
| ivalid | input | 1 | Instruction returning from the cache is |
| | | | valid and is 32-bits. |
| ivic | output | 1 | Invalidate instruction cache to reset the |
| | | | cache and the aligner. |
| inst_16 | input | 1 | Instruction returning from the cache |
| | | | is 16-bits. |
| next_pc | output | 31 | This is the address of the instruction |
| | | | requested by the processor. |
| p1iw | output | 16 | The 32-bit instruction returning to the |
| | | | processor. |
| p2limm | output | 1 | The next longword is long immediate data. |

The signals that are generated in the instruction fetch stage for use by the register file, and program counter, and the associated interrupt logic are now described in detail.

An exemplary datapath for stage 1 is shown in FIG. 23. It exists between the instruction cache 1902 (i.e., code RAM, etc.) and the register p2iw_r in the control unit rctl for stage 2. This is shown in FIG. 23, where the aligner 1908 formats the signals to and from the instruction cache block. The behaviour of the instruction cache 1902 remains unchanged although certain signals have been renamed in the control block due to inclusion of the aligner block (i.e., the p1 iw signal becomes p0iw; and the ivalid signal is split into ivalid0).

The format of the instruction word for 16-bit ISA from the aligner 1908 is further formatted so that it expands to fill the 32-bit value, which is read by the control unit. The logic for expanding the 16-bit instruction into the 32-bit instruction longword space is necessary since the same register file is employed, and source operand encoding in the 16-bit ISA is not a direct mapping of the 32-bit ISA. Refer to Table 11 for the register encodings between 16-bit and 32-bit ISAs. In the present embodiment, the 16-bit ISA is mapped to the top 16-bits of the 32-bit instruction longword. The encoding of the 16-bit ISA to the mapping of the 32-bit instruction allows the decoding process in stage 2 to be simpler as compared to prior art approaches since the opcode field is always between [31:27]. The source register locations are encoded in the following manner:

(i) Source1 address register

26:24 (16-bit)

26:24 & 14: 12 (32-bit)

(ii) Source2 address register

23:21 (16-bit)

5:0 (32-bit)

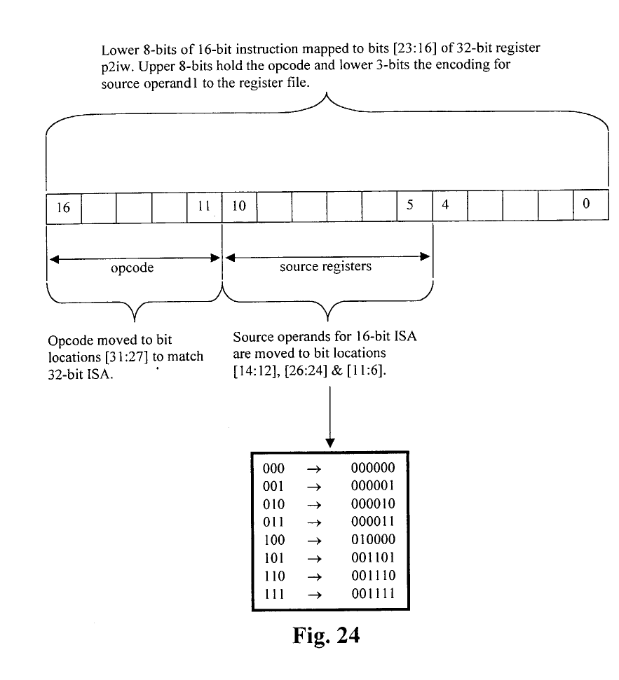

The remaining encoding for the 16-bit ISA (not including the opcode) is defined between [20:16]. FIG. 24 graphically illustrates the expansion process. The data path in stage 1 that encompasses the instruction cache remains unchanged. Specifically, in the illustrated embodiment, the lower 8-bits of the 16-bit instruction are mapped to bits [23:16] of the 32-bit register file p2iw. The upper 8-bits are employed to hold the opcode and the lower 3-bits for the encoding of source operand1 to the register file. The opcode is moved to reside in bit locations [31:27] so that it matches the 32-bit ISA. The source operands for the 16-bit ISA are moved to bit locations [14:12], [26:24] and [11:6].

The interface to the register file is also modified when generating operands in stage 2. This logic is described in the following sections.

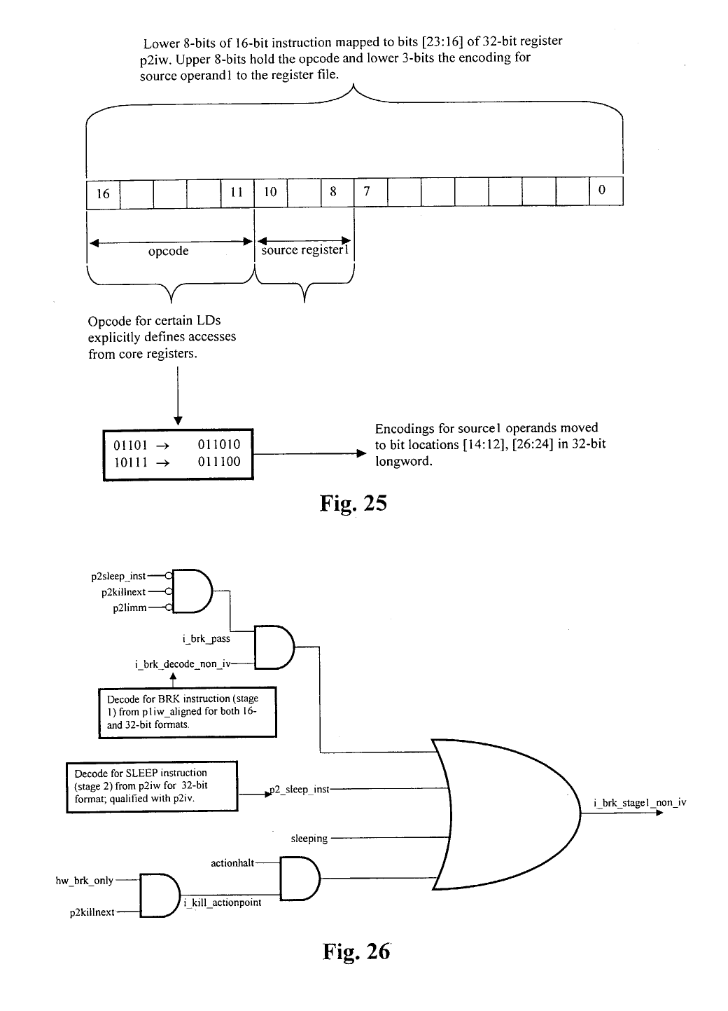

LD Relative to SP/GP—The encoding for 16-bit LDs which relatively address from the Stack pointer or the Global pointer is implicit in the instruction. This means that this encoding has to be translated to conform to the encoding specified in the 32-bit ISA. The LDs for GP relative (r26) are opcode 0×0D, and LDs for SP relative (r28) are opcode 0×17 (refer to FIG. 25).

The PUSH/POP instructions do not specify that the address in stack pointer register should be auto-incremented (or decremented). This is inherent by the instruction itself so for POP/PUSH instructions there is a writeback to the SP.

Operand Addressing—The operands required by the instruction are derived from the register file, extensions, long immediate data or is embedded in the instruction itself as a constant. The register address (s1a) for the source one field is derived from the following sources:

1. p1c_field (p1iw[11:6])—32-bit instructions (p1opcode=0×04, 0×05) when it is a MOV, RCMP or RSUB

2. p1hi_reg16 (p1iw[18:16] & p1iw[23:21])—16-bit instructions (p1opcode=0×0E) where requires access to all 64 core register locations

3. rglobalptr (0×1A)—Global pointer operations (p1opcode=0×19)

4. rstackptr (0×1C)—Global pointer operations (p1 opcode=0×18)

5. p1b_field (p1iw[14:12] & p1iw[26:24])—for all other instructions

The logic required to obtain the register address (fs2a) for the source two field is derived from various sources and these are as follows:

1. p1b_field (p1iw[14:12] & p1iw[26:24])—32-bit instructions (p1opcode=0×04, 0×05) when it is a MOV, RSUB. For 16-bit instructions (p1opcode=0×0E), 0×0F)

2. p1hi_reg16 (p1iw[18:16] & p1iw[23:21])—16-bit instructions (p1opcode=0×0E) where requires access to all 64 core register locations for MOV and CMP instructions

3. rblink (0×1F)—Branch & link register updates (p1opcode=0×0F) for 16-bit jump & link instructions

4. p1c_field (p1iw[14:12] & p1iw[26:24])—for all other instructions.

Stage 1 Control Path

The control signals in stage 1 of the processor pipeline that are configured to support the combined ISA are as follows:

TABLE 12

| Control Signal | Description |
|---|---|
| en1 | enable for registers that update signals to |
| | stage, i.e. p1iw |
| ifetch | request signal for next instruction |
| p2limm | this is true when the next longword from |
| | the instruction cache is long immediate data |
| pcen | enable for updating the program counter, i.e. next_pc |
| pcen_niv_nbrk | enable for updating the program counter, i.e. next_pc, |
| | does not employ BRK or ivalid as qualifiers |
| ipending | instruction pending signal |
| brk_inst_non_iv | BRK instruction detected in stage 1 |

The sub-modules configured to support the combined ISA are rctil, 1su and cr_int. The foregoing control signals are now described in greater detail.

Pipeline Enable (en1)—The enable for registers in pipeline stage 1, en1, is false if any of the following conditions are true:

1. Processor core is halted, en=0

2. Instruction in stage 1 is not valid, NOT(ivalid)

3. Breakpoint or a valid actionpoint is detected so stage 2 has to be halted while remaining stages have to be flushed, break_stage1_non_iv=1

4. Single Instruction step has moved instruction to stage 2 and there are no dependencies in stage 1, p2step AND NOT(p2p1dep) AND NOT(p2int)

5. There is no instruction available from stage 1, (p2int OR p2iv) AND p2_real_stall

6. The BRcc instruction has failed to be taken so kill instruction in delay slots.

The expressions defined above are described in more detail below.

For the case when a breakpoint or a valid actionpoint is detected, break_stage1_non_iv, pipeline stage 1 is disabled based upon the signals defined in FIG. 26. The signal i_brk_decode_non_iv is the decode the BRK instruction in stage 1 of the pipeline from p1iw_aligned for the 16-bit and 32-bit instruction format. The signal p2_sleep_inst is the decode for the SLEEP instruction in stage 2 of the pipeline from p2iw for the 32-bit instruction format (and is qualified with p2iv).

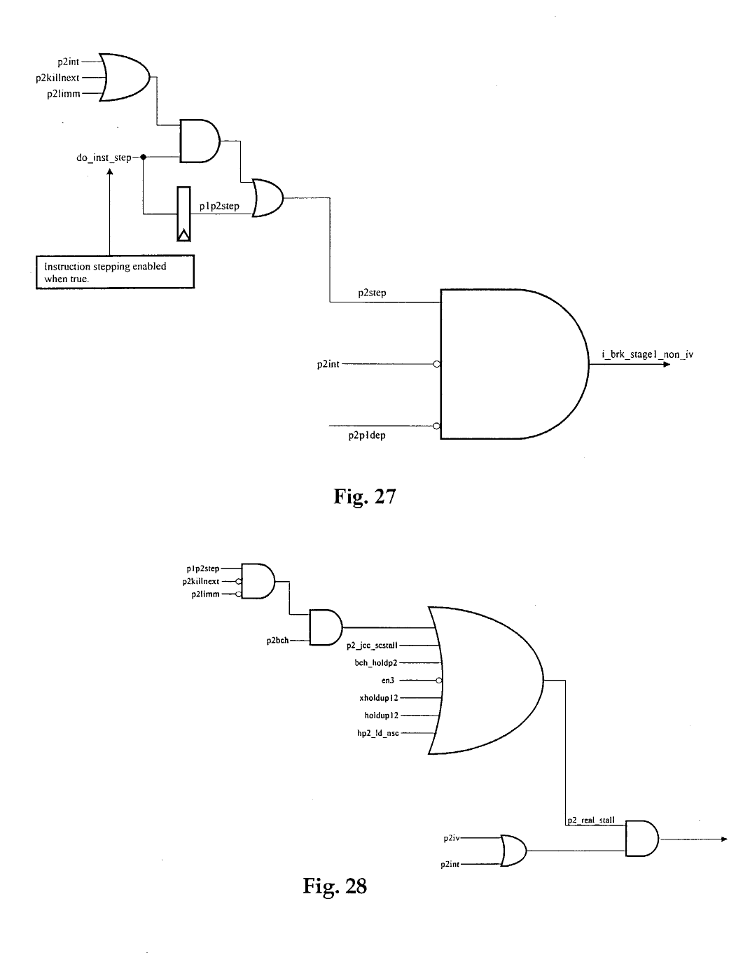

FIG. 27 illustrates exemplary disabling logic for stage 1 of the pipeline when performing single instruction stepping. In the illustrated example, the host has performed a single instruction step operation and the instruction in stage 2 has no dependencies in stage 1. Similarly, the pipeline enable is also not active when there is no instruction available from stage 1 (as shown in FIG. 28).

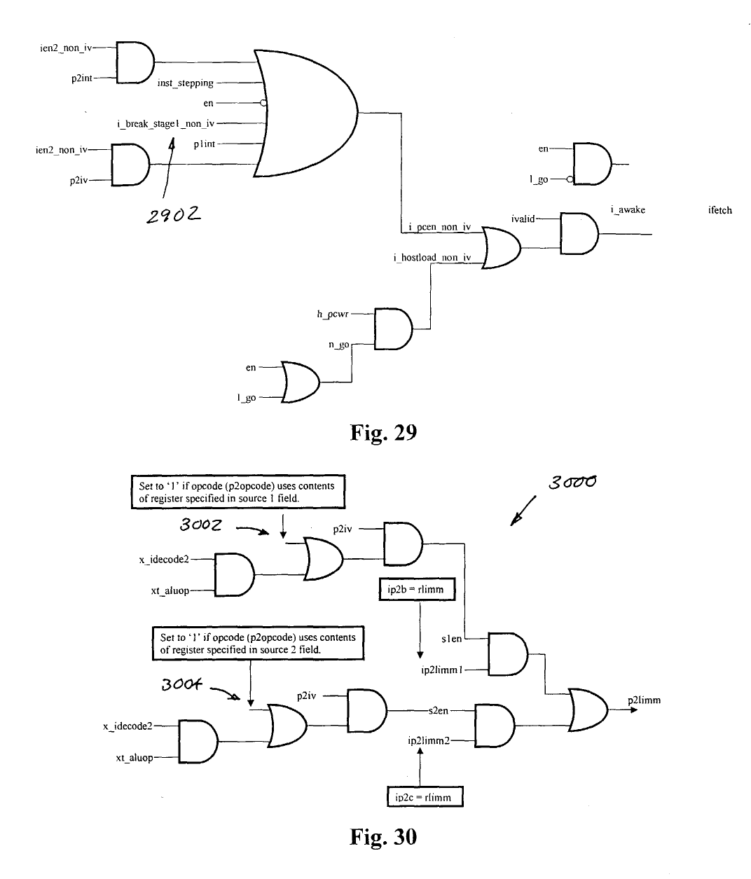

Instruction Fetch (ifetch)—The instruction fetch (ifetch) signal qualifies the address of the next instruction (next_pc) that the processor wants to execute. FIG. 29 illustrates one exemplary embodiment of the ifetch logic of the invention. The signal employed for flushing the pipeline when there is halt caused by the processor, SLEEP, BRK or the actionpoints, i.e. i_break_stage1_non_iv 2902, is specifically adapted for the 16/32-bit ISA.

Long Immediate Data (p2limm)—The exemplary embodiment of the processor of the present invention supports long immediate data formats; this is signalled when the signal p2limm is true. FIG. 30 illustrates exemplary logic 3000 for implementing this functionality. The derivation of the enables for the source registers (s1en, s2en) are gained from stage 2 and include 16-bit instruction formats. Note that the logic inputs 3002, 3004 shown in FIG. 30 are set to “1” if the opcode (p2opcode) utilizes the contents of the register specified in the source one and source two fields, respectively.

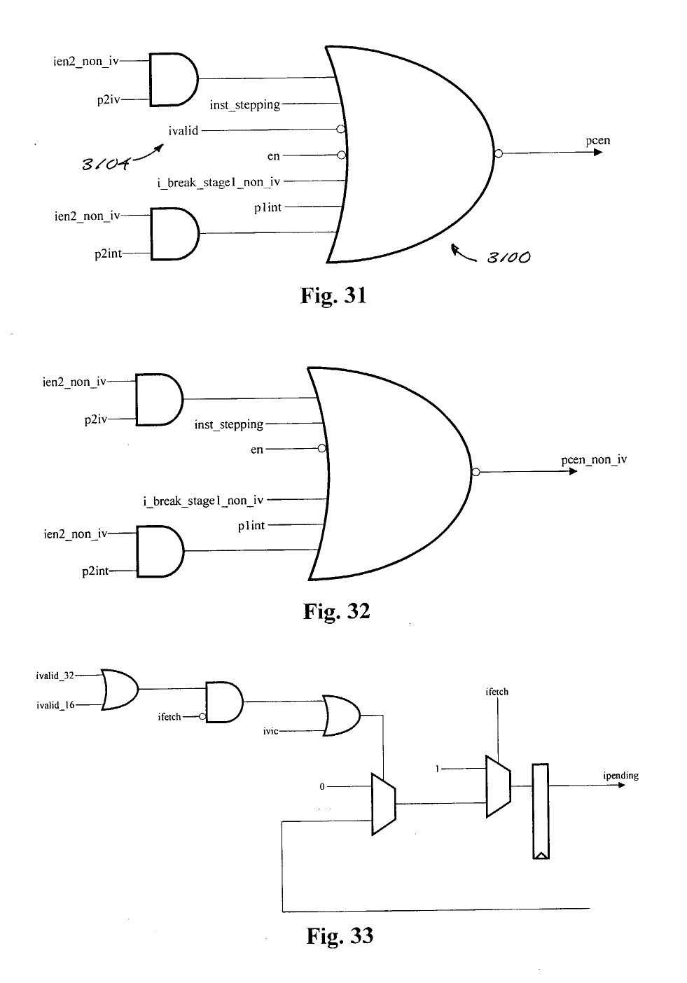

Program Counter Enable (pcen)—FIG. 31 illustrates exemplary program counter enable logic 3100. The enable for the program counter (pcen) is not active when: (i) the processor is halted, en=0; (ii) the instruction in stage 1 is not valid, NOT(ivalid); (iii) a breakpoint or a valid actionpoint is detected so the remaining stages have to be flushed, break_stage1_non_iv; (iv) a single Instruction step has moved instruction to stage 2 and there are no dependencies in stage 1, inst_stepping; (v) an interrupt has been detected in stage 1, p1int, so the current instruction should be killed so the correct PC is stored to ilink register; (vi) an interrupt has been detected in stage 2, p2int, so the instruction in stage 1 should be killed; or (vii) an instruction is in stage 2, p2iv, and the instruction in stage 1 should be killed since long immediate data.

In an alternate configuration (FIG. 32), the enable for the PC enable (pcen_non_iv) is not qualified with instruction valid (ivalid) signals 3104 from stage 1 as in the embodiment of FIG. 31, so that the enable is optimized for timing.

Instruction Pending (ipending)—The ipending signal shows that an instruction is currently being fetched. An instruction is said to be pending when the instruction fetch (ifetch) signal is set, and it is only cleared when an instruction valid (ivalid_{—}16, ivalid_{—}32) signal is set and the ifetch is inactive or the cache is being invalidated. FIG. 33 illustrates exemplary logic for implementing this functionality.

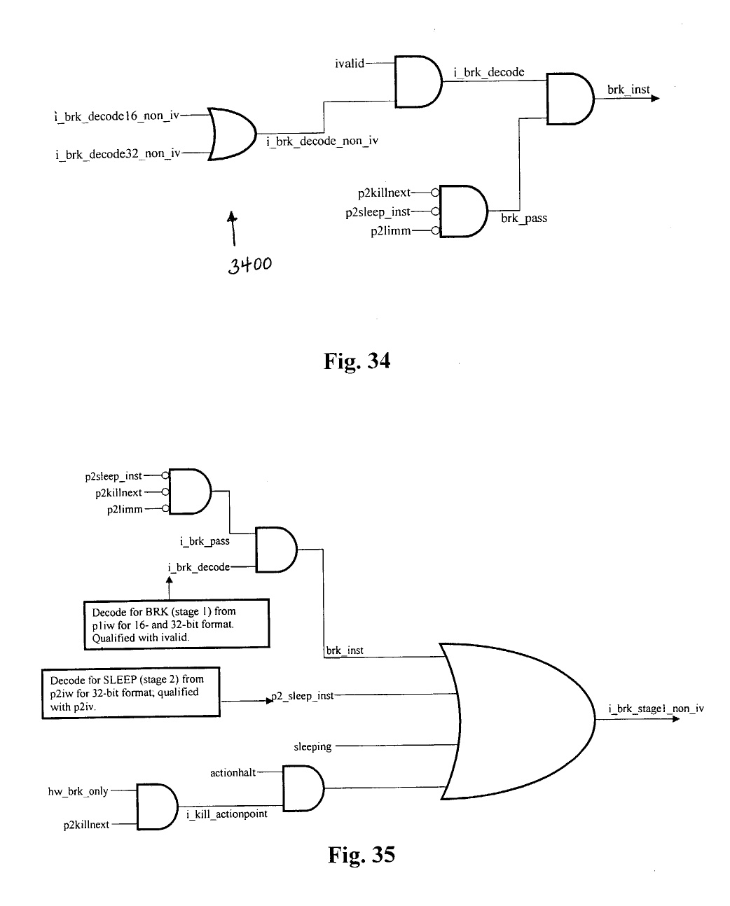

BRK Instruction—The BRK instruction causes the processor core to stall when the instruction is decoded in stage 1 of the pipeline. FIG. 34 illustrates exemplary BRK decode logic 3400. The instructions in stage 2 are flushed, provided that they do not have any dependencies in stage 1; e.g., BRK is in the delay slot of a Branch that will be executed. The BRK instruction is decoded from the p1iw_aligned signal, which is provided to the processor via the instruction aligner 1908 previously described (see FIG. 19). In the present embodiment, there are two encodings for the BRK instruction, i.e. one qualified with ivalid, and the other not.

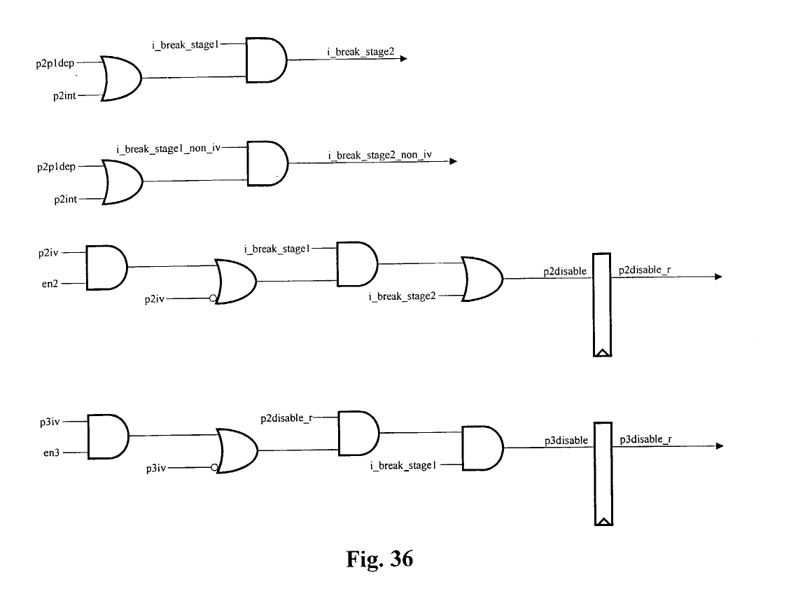

Referring now to FIGS. 35-36, the pipeline flush mechanism of the invention is described in detail. The mechanism utilized in the present embodiment for flushing the processor pipeline when there is a BRK instruction in stage 1 (or an actionpoint has been triggered) allows instructions that are in stage 2 and stage 3 to complete before halting. Any instructions in stage 2 that have dependencies in stage 1; e.g., delay slots or long immediate data, are held until the processor is enabled by clearing the halt flag. The logic that performs this function is employed by the control signals in stage 2 and three. The signals for flushing the pipeline are as follows:

1. i_brk_stage1—Stall signal for stage 1 (FIG. 35).

2. i_brk_stage1_non_iv—Stall signal for stage 1 (refer to FIG. 35).

3. i_brk_stage2—Stall signal for stage 2 (refer to FIG. 36).

4. i_brk_stage2_non_iv—Stall signal for stage 2 (refer to FIG. 36).

5. i_p2disable—Valid signal for stage 2 (refer to FIG. 36).

Instruction in stage 2 has dependency in stage 1 (break_stage2)

An actionpoint has been triggered (or BRK) and the instruction stage 2 is allowed to move forward (en2)

An actionpoint has been triggered (or BRK) and the instruction in stage 2 is invalid (NOT p2iv)

6. i_p3disable—Valid signal for stage 3 (refer to FIG. 40).

Instruction in stage 2 is invalid (i_p2disable_r) and the instruction stage 3 is also invalid (NOT p3iv)

Instruction in stage 2 is invalid (i_p2disable_r) and the instruction in stage 3 is enabled (en3)

The configuration of the instruction decode interface necessary to support the combined 32/16-bit ISA previously described is now described in further detail. The signals at the instruction fetch interface are defined in Table 13.

TABLE 13

| Signal | Input/ | Bus | |
|---|---|---|---|
| Name | Output | Width | Description |
| aluflags | input | 4 | These are the registered version of the zero, |
| | | | negative, carry, overflow flags from stage 3. |
| brk_inst | output | 1 | A BRK instruction has been detected in stage 1. |
| dest | output | 6 | The destination register for result of an instruction. |
| desten | output | 1 | The enable for destination register. |
| dojcc | output | 1 | Perform a jump. |
| dorel | output | 1 | Perform a relative jump. |
| en2 | output | 1 | Enable to pipeline stage 2. |
| fs2a | output | 6 | The source register for operand 2. |
| holdup12 | input | 1 | This is the stall signal for stages 1 and 2 and is |
| | | | generated by the lsu. |
| mload2 | output | 1 | LD requested in stage 2. |
| mstore2 | output | 1 | ST requested in stage 2. |
| p2_alu_cc | output | 1 | ALU operation condition code field present at stage |
| | | | 2 for detecting MAC/MUL instructions. |
| p2bch | output | 1 | There is a branch in stage 2. |
| p2condtrue | output | 1 | This is from the result of the condition code unit in |
| | | | stage 2. |
| p2cc | output | 4 | This is the condition code field. |
| p2opcode | output | 5 | Opcode for instruction |
| p2int | input | 1 | The interrupt has entered into stage 2. |
| p2iv | output | 1 | Instruction valid in stage 2. |
| p2jblcc | output | 1 | There is a branch & link instruction. |
| p2killnext | output | 1 | A branch/jump is in stage 2 and the delay slot is to |
| | | | be killed. |
| p2ldo | output | 1 | This is a LD operation in stage 2. |
| p2lr | output | 1 | LR is requested in stage 2. |
| p2offset | output | 20 | This is the offset for a branch instruction. |
| p2q | output | 5 | Condition code field. |
| p2setflags | output | 1 | The current instruction has flag setting enabled. |
| p2shimm | output | 1 | There is short immediate data. |
| p2shimm_data | output | 13 | This is the short immediate data.from p2iw_r |
| p2st | output | 1 | There is ST instruction in stage 2. |
| s1a | output | 6 | The source register for operand 1. |
| s1en | output | 1 | The enable for source register 2. |
| s2en | output | 1 | The enable for source register 1. |
| xholdup112 | input | 1 | Extension stall signal for stages 1 and 2. |
| x_idecode2 | input | 1 | This is the decode for the extensions. |
| xp2idest | input | 1 | This indicates the register specified in the |
| | | | destination field will not be written to. |
| xp2ccmatch | input | 1 | This signal is from the extension condition code |
| | | | unit from stage 2, and the alu flags from stage 3 |
| | | | performs some operation on them to generate this |
| | | | signal. |
| x_p2nosc1 | input | 1 | This indicates the register in fs1a does not allow |
| | | | short-cutting. |
| x_p2nosc2 | input | 1 | This indicates the register in s2a does not allow |
| | | | short-cutting. |

The decode logic in stage 2 of the pipeline impacts upon the following modules:

1. rctl—Split encoding of instruction word to represent source/destination, opcode, sub-opcode fields, etc

2. 1su—Generation of stall logic for stages 1 and 2 (holdup12)

3. cr_int—Generating the operands and writeback in addition to shifting logic for new instructions

4. aux_regs—Modifications to the PC/Status register

The primary considerations for the functionality of the data-path in stage 2 include (i) generating the operands for stage 3; (ii) generating the target address for jumps/branches; (iii) updating the program counter; and (iv) load scoreboarding considerations. The instruction modes provided as part of the processor such as masking, scaled addressing, and additional immediate data formats require multiplexing for addressing for branches and source operand selection. The supporting logic is described in the following sub-sections.

Field Extraction—The information extracted from the 32-bit instruction longword of the illustrated embodiment is as shown in Table 14:

TABLE 14

| Field | Information |
|---|---|
| Destination (p2a_field) field | p2iw_r[5:0] |
| Address writeback (p2a_fieldwb_r) field | p2iw_r[:] |
| Source 1 Operand (p2b_field_r) field | p2iw_r[:] |
| Source 2 Operand (p2c_field_r) field | p2iw_r[:] |
| Major Opcode (p2opcode) field | p2iw_r[31:27] |
| Minor Opcode (p2subopcode) field | p2iw_r[21:16] |

These signals are latched into stage 3 when i_enable2 is set true.

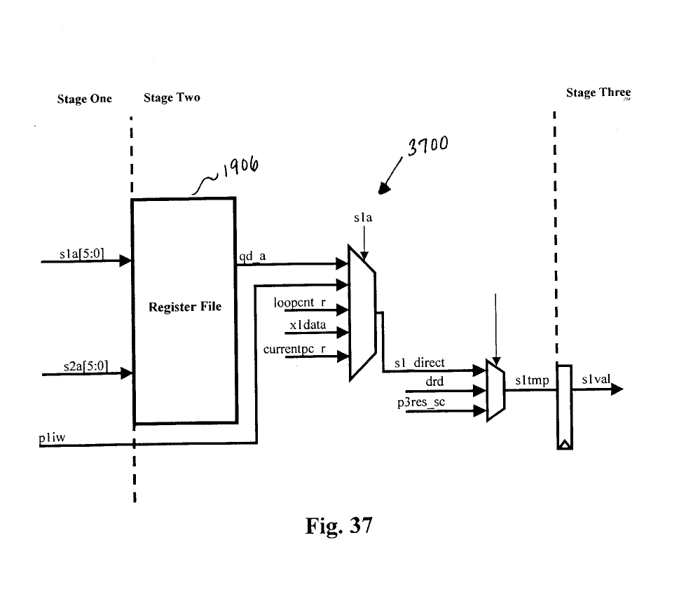

Operand Fetching—The operands required by the instruction are derived from the register file, extensions, long immediate data, or alternatively is embedded in the instruction itself as a constant. Exemplary logic 3700 required to obtain the operand (s1val) from the source one field is as shown in FIG. 37. This operand is derived from various sources:

1. Core register file provides r0 to r31

2. ×1data for extensions that occupy r32 to r59

3. loopcnt_r register when accessing r60

4. Long immediates (p1iw_aligned) are selected when register r62 is encoded

5. Read only value of the PC is selected when register r63 is encoded

6. Returning loads (drd) are selected when shortcutting is enabled (sc_load2) and the flag rct_fast_load_returns are both set

7. Shortcut result from stage 3 (p3res_sc).

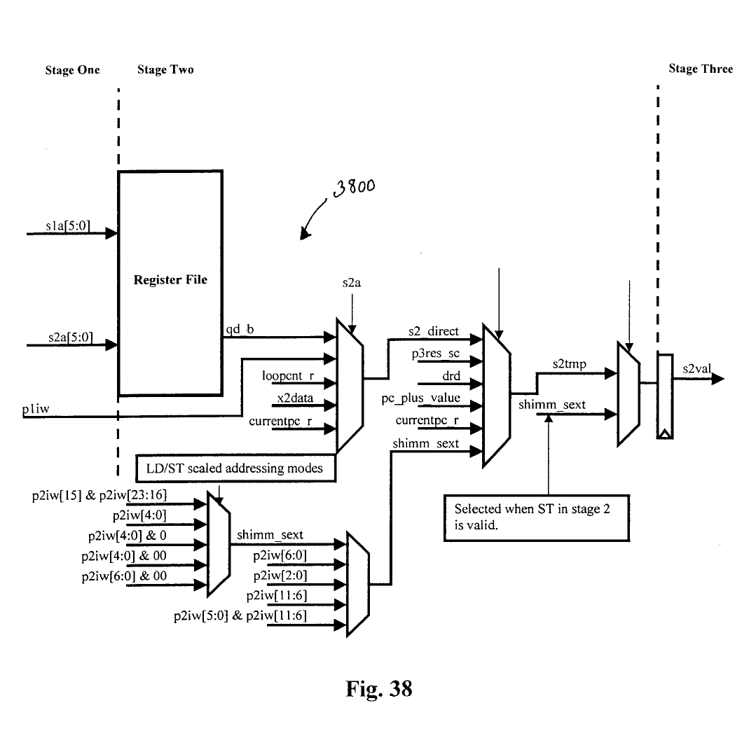

Exemplary logic 3800 required to obtain the operand (s2val) from the source two field is shown in FIG. 38. This operand is derived from various sources as follows:

1. Core register file provides r0 to r31

2. ×2data for extensions that occupy r32 to r59

3. loopcnt_r register when accessing r60

4. Long immediates (p1iw) are selected when register r62 is encoded

5. Read only value of the PC is selected when register r63 is encoded

6. Immediate data types (shimmx) based upon the opcode since explicitly defined within instruction, s2_shimm

7. Returning loads (drd) are selected when shortcutting is enabled (sc_load2) and the flag rct_fast_load_returns are both set.

8. Shortcut result from stage 3 (p3res_sc) when shortcutting is enabled, sc_reg2 is true

9. Program count+4 (or 2 for 16-bit instructions) is selected when JL or BL is taken, i.e. s2_ppo is set

10. Program counter (currentpc_r) is selected when there is an interrupt in stage 2, i.e.s2_currentpc is set

11. Final multiplexer before latch selects 1s_shimm_sext when there is a valid ST in stage 2(p2iv AND p2st) else it defaults to s2tmp.

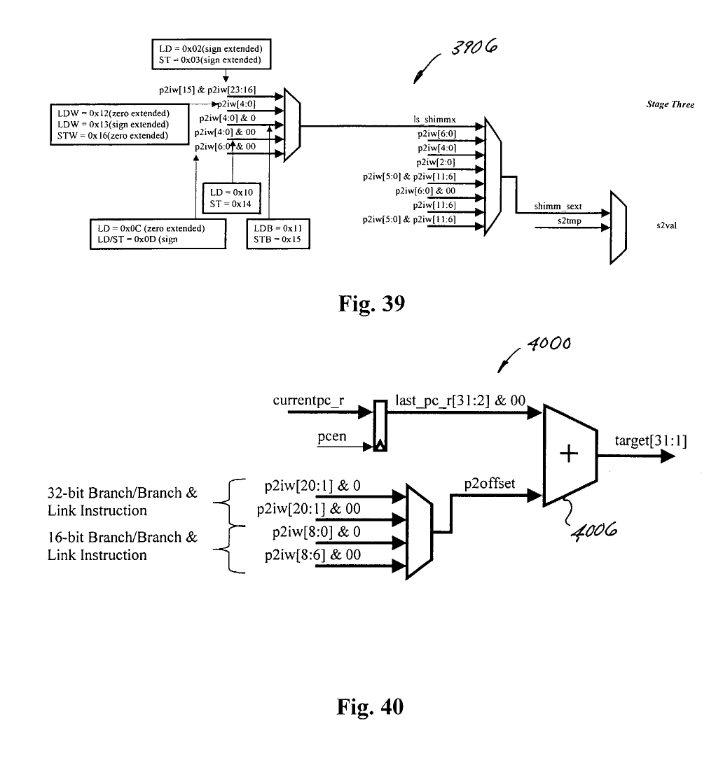

Scaled Addressing for Source Operand 2—The scaled addressing mode of the illustrated embodiment (FIG. 39) is performed in stage 2 of the processor and is latched into s2val. The scaled addressing modes are encoded in the opcode field for the 16-bit ISA. The short immediate value is scaled from between 0 to 2 locations: (i) LD/ST with shimm (LDB/STB); (ii) LD/ST with shimm scaled 1-bit shift left (LDW/STW); and/or (iii) LD/ST with shimm scaled 2-bits shift left (LD/ST). The opcodes that specify the scaling factors are shown in FIG. 39. The 1s_shimmx signal 3906 provides all the LD/ST short immediate constants for both 32-bit and 16-bit instructions.

Short Immediate Data for ALU Instructions—The selection for short immediate data for ALU operations (FIG. 39) is as shown in Table 15:

TABLE 15

| Opcode | Data/Operation |
|---|---|
| Opcodes 0x05 to 0x7 | unsigned 6-bit constant when field |
| | p2iw_r[23:22] = 01 or p2iw_r[23:22] = 11 |
| Opcodes 0x05 to 0x7 | signed 12-bit constant when field |
| | p2iw_r[23:22] = 10 |
| Opcode 0x0D | ADD with unsigned 9-bit constant |
| Opcode 0x0E | ADD/SUB/ASL/ASR with unsigned 3-bit |
| | constant |
| Opcode 0x18 | ASL/ASR/LSR with unsigned 5-bit |
| | constant |
| Opcodes 0x17/0x1C/0x1D | ADD/SUB/MOV/CMP with unsigned 7- |
| | bit constant |

Branch Addresses (target)—The build sub-module cr_int provides the address generation logic 4000 for jumps and branch instructions (refer to FIG. 40). This module takes addresses from the offset in the branch instruction and adds it to the registered result of the currentpc. The value of currentpc_r is rounded down to the nearest long word address before adding the offset. All branch target addresses are 16-bit aligned whereas branch and link (BL) target addresses are 32-bit aligned. This means that the offset for the branches have to be shifted one place left for 16-bit aligned and two places left for 32-bit aligned accesses. The offsets are also sign extended.

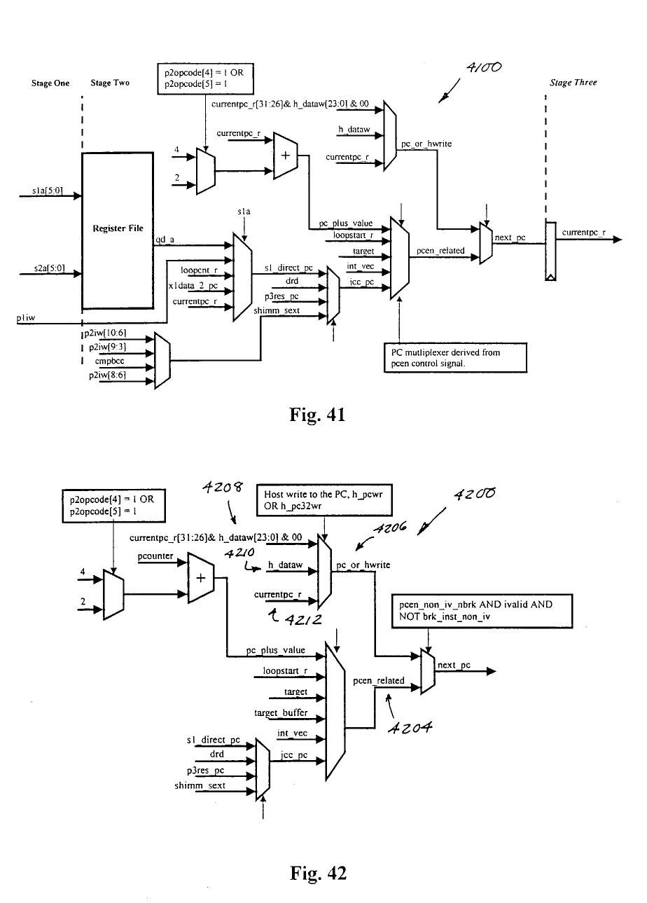

Next Program Count (next_pc)—The next value for the program count is determined based upon the current instruction and the type of data encoding (as shown in the exemplary Next PC logic 4100 of FIG. 41). The primary influences upon the next PC value include: (i) jump instructions jcc_pc); (ii) branches instructions (target); (iii) Interrupts (int_vec); (iv) zero overhead loops (loopstart_r); and (v) host Accesses (pc_or_hwrite). The PC sources for the jump instruction jcc_pc) are derived as follows:

Core register file provides r0 to r31

×1 data for extensions that occupy r32 to r59

loopcnt_r register when accessing r60

Long immediates (p1iw) are selected when register r62 is encoded

Read only value of the PC (currentpc_r) is selected when register r63 is encoded

Sign extended immediate data types (shimm_sext) based upon the sub-opcode

Returning loads (drd) are selected when shortcutting is enabled (sc_load2) and the flag rct_fast_load_returns are both set

Shortcut result from stage 3 (p3res_sc)

The next level of multiplexing for the PC generation logic 4200 (shown in the exemplary configuration of FIG. 42) provides all the logic associated with PC enable signal, i.e. pcen_niv_nbrk, including: (i) jump instructions (jcc_pc) when dojcc is true; (ii) interrupt vector (int_vec) when p2int is true; (iii) branch target address (target) when dorel is true; (iv) compare and branch target address (target_buffer) when docmprel is true; (v) loopstart_r when doloop is set; and (vi) otherwise move to the next instruction (pc_plus_value). Note that the increment to the next instruction depends upon the size of the current instruction, so accordingly 16-bit instructions require an increment by 2, and 32-bit instructions require an increment by 4.

The final portion of the selection process for the PC is between pcen_related 4204 and pc_or_hwrite 4206 as shown in FIG. 42. In the illustrated embodiment, these selections are based upon the following criteria:

1. pcen_related 4204 when:

BRK instruction is not detected in stage 1;

Instruction in stage 1 is valid (ivalid); and

Program counter is enabled (pcen_niv_nbrk)

2. currentpc_r[31:26] and h_dataw[23:0] 4208 when there is a write from the host to the status register (h_pcwr)

3. h_dataw[31:0] 4210 when there is a write from the host to the 32-bit PC (h_pc32wr)

4. currentpc_r 4212 for all remaining cases.

Short Immediate Data (p2shimm data)—The short immediate data (p2shimm_data) is derived from the instruction itself and then merged into the second operand (s2val) to be used in stage 3. The short immediate data is derived from the instruction types based upon the criterion of the major and minor opcodes as shown in Table 16. The short immediate data is forwarded to the selection logic for s2val.

TABLE 16

| Instruction Type | Opcode | Subopcode | Shimm Location |
|---|---|---|---|
| LD (op_ld) | 0x02 | N/A | sxt(p2iw_r[8]& |
| | | | p2iw_r[23:16],13) |
| ST (op_st) | 0x03 | N/A | sxt(p2iw_r[8]& |
| | | | p2iw_r[23:16],13) |
| ADD (op_fmt1) | 0x04 | p2iw_r[23:22] = | ext(p2iw_r[11:6],13) |
| | | 0x1 (p2format_r = | |
| | | fmt_u6) | |
| ADD (op_fmt1) | 0x04 | p2iw_r[23:22] = | ext(p2iw_r[11:6],13) |
| | | 0x3 (p2format_r = | |
| | | fmt_cond_reg) | |
| ADD (op_fmt1) | 0x04 | p2iw_r[21:16] = | sxt(p2iw_r[11:0],13) |
| | | 0x2 (p2format_r = | |
| | | fmt_s12) | |
| ADD/ASL | 0x0D | N/A | ext(p2iw_r[20:16],11) |
| (op_16_arith) | | | |
| LD (op_16_ld_u7) | 0x10 | N/A | ext(p2iw_r[20:16],13) & “00” |
| LDB (op_16_ldb_u5) | 0x11 | N/A | ext(p2iw_r[20:16],13) |
| LDW | 0x12 | N/A | ext(p2iw_r[20:16],13) & ‘0’ |
| (op_16_ldw_u6) | | | |
| LDW.X | 0x13 | N/A | ext(p2iw_r[18:16],13) & ‘0’ |
| (op_16_ldwx_u6) | | | |
| ST (op_16_st_u7) | 0x14 | N/A | ext(p2iw_r[20:16],13) & “00” |
| STB (op_16_stb_u5) | 0x15 | N/A | ext(p2iw_r[20:16],13) |
| STW (op_16_stw_u6) | 0x16 | N/A | ext(p2iw_r[20:16],13) & ‘0’ |
| ASL/ASR/SUB/ | 0x17 | p2iw_r[23:21]= | ext(p2iw_r[20:16],13) |
| BMSK/BCLR/BSET | | 0x7 | |
| | | (p2subopcode3_r = | |
| | | op_16_btst) | |
| LD/ST/POP/PUSH | 0x18 | N/A | ext(p2iw_r[20:16],11) & “00” |
| (op_16_sp_rel) | | | |
| LD (op_16_gp_rel) | 0x19 | N/A | sxt(p2iw_r[22:16],11) & “00” |
| LD (op_16_ld_pc) | 0x1A | N/A | ext(p2iw_r[23:16],11) & “00” |
| MOV (op_16_mov) | 0x1B | N/A | ext(p2iw_r[23:16],13) |
| ADD | 0x1C | N/A | ext(p2iw_r[22:16],13) |
| (op_16_addcmp) | | | |
| BRcc (op_16_brcc) | 0x1D | N/A | sxt(p2iw_r[22:16],12) & ‘0’ |
| Bcc (op_16_bcc) | 0x1E | N/A | ext(p2iw_r[24:16],12) & ‘0’ |
| Bcc | 0x1F | N/A | sxt(p2iw_r[21:16],11) & ‘0’ |

Sign Extend (i_p2sex)—The sign extend for returning loads (i_p2sex) is generated as follows: (i) op_{—}16_{—}1dwx_u6 (p2opcode=0×13)—sign extend when performing a LDW instruction with 6-bit unsigned data; (ii) sign extending is disabled for all other 16-bit LD operations; and (iii) LD (p2opcode=0×02)—sign extend load based upon p2iw_r[6].

Status & PC Auxiliary Registers—The status register and the 32-bit PC register of the illustrated embodiment employ the same registers where appropriate; i.e., the PC in the current status register in locations PC32[25:2] of the new register.

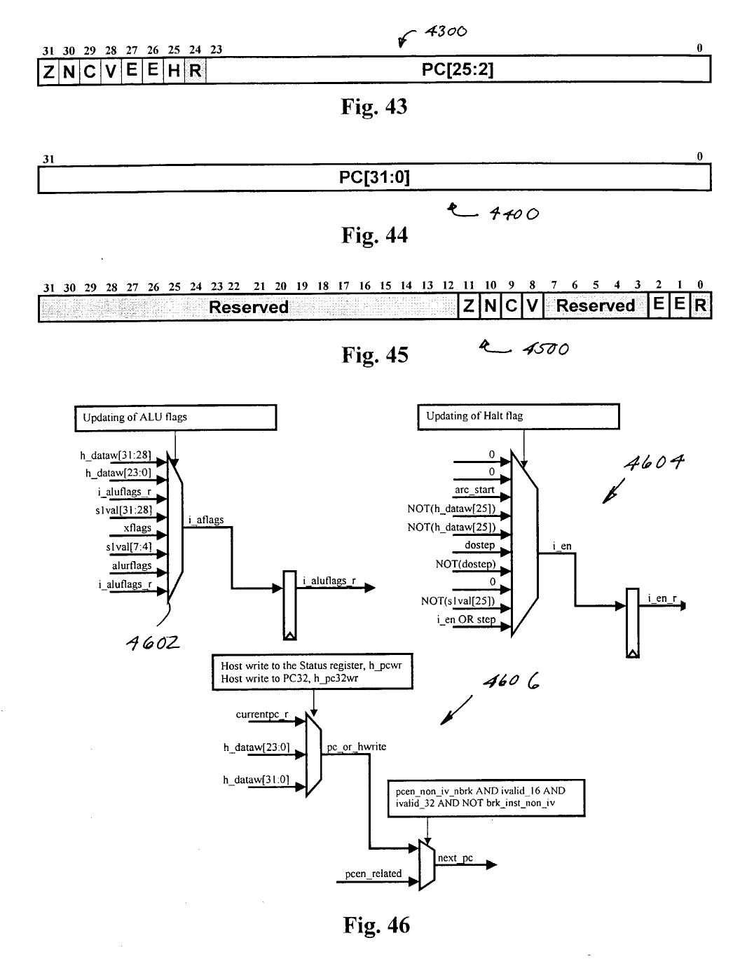

A write to the status register 4300 (FIG. 43) means that the new PC32 register 4400 (FIG. 44) is only updated between PC32[25:2] while the remaining part is unchanged. The ALU flags, interrupt enables and the Halt flag are also updated in the status32 register 4500 (FIG. 45). A write to PC32 register 4400 also works in reverse in that PC[25:2] is updated in the status register 4300 and the remaining fields are unchanged. The behavior of the Status32 register 4500 is the same with regards to updating the ALU flags, interrupt enables and the Halt flag. All the registers discussed in this section are auxiliary mapped.

Exemplary data paths 4602, 4604, 4606 for updating the aforementioned registers are shown in FIG. 46. The status register 4300 is updated via the host when (i) a write is performed to the Status register 4300 (h_pcwr); or (ii) a write is performed to the PC32 register 4400 (h_pc32wr). Otherwise, the current value of the PC is forwarded.

The Halt flag is updated when (i) an external halt signal is received, e.g., i_en=0; (ii) the Halt bit is written to the Debug register (h_db_halt), e.g., i_en=0; (iii) a reset has been performed (i_postrst) and the processor is set to user-defined halt status, e.g., i_en=arc_start; (iv) a host write is performed to the Status register 4300 (h_en_write), e.g., i_en=NOT h_data w(25); (v) a host write is performed to the Status32 register (h_en32_write), i.e. i_en=NOT h_data_w(25); (vi) a single cycle step operation is performed (1_do_step AND NOT do_inst_step), i.e. i_en=dostep; (vii) an instruction step operation is performed (do_inst_step), i.e. i_en=NOT stop_step; (viii) a Halt of the processor from an actionpoint has been triggered, or there is an BRK instruction, i.e. i_en=0; or (ix) a flag operation is performed (doflag AND en3) and the Halt flag set to appropriate value, i.e. i_en=NOT s1val(0). Otherwise, the bit is set to the previous value of halt bit, or a single cycle step performed; i.e. i_en=i_en_r OR step.

The ALU flags are updated in a similar manner, when: (i) a host write is performed to the Status register (hostwrite), i.e. i_aflags=h_data-w(31:28); (ii) a host write is performed to the Status32 register (host32 write), i.e. i_aflags=h_data_w(31:28); (iii) the pipeline stage 3 is stalled (NOT en3), i.e. i_aflags=i_aluflags_r; (iv) a JLcc.f is in stage 3 (ip3dojcc) so update the flags, i.e. i_aflags=s1val[31:28]; (v) an extension instruction with flag setting enabled (extload) has executed, i.e. i_aflags=xflags; (vi) a flag operation is performed (doflag AND NOT s1val(0)) and the ALU flags set to appropriate values provided the processor is not halted, i.e. i_aflags=s1val[7:4]; or (vii) a valid instruction with flag setting enabled has executed (alurload), i.e. i_aflags=alurflags. Otherwise, the ALU flags are set to the previous value of the ALU flags, i.e. i_aflags=i_aluflags_r.

Stage 2 Control Path

The control signals for stage 2 of the processor that are configured to support the 16/32-bit ISA are as shown in Table 17 below:

TABLE 17

| Control Signal | Description |
|---|---|
| en2 | Enable for Stage 2 |
| p2iv | Stage 2 instruction valid |
| s1a, fs2a | Source addresses to register file |
| pcen | enable for updating the program counter |
| p2killnext | Kill Instruction in Stage 2 - Stall Stages 1 & 2 - |
| | holdup12 |
| ins_err | instruction error |
| h_pcwr, h_pc32wr, etc | Other misc. control signals |

The foregoing signals are now described in greater detail.

Stage 2 Pipeline Enable (en2)—The enable for registers in pipeline stage 2, en2, is false if any of the following conditions are true:

1. Processor core is halted, en=0;

2. A valid instruction in stage 3 is held up, en3=0;

3. A register referenced by the instruction is held-up due to a delayed load, holdup12 OR hp2_{—}1d_nsc;

4. Extensions require that stage 2 be held, xholdup12=1;

5. The interrupt in stage 2 is waiting for a pending instruction fetch before issuing a fetch for the interrupt vector, p2int AND NOT (ivalid);

6. The branch in stage 2 is waiting for a valid instruction in stage 1 (delay slot), i_branch_holdup2 AND (ivalid);

7. The instruction in stage 2 requires long immediate data from stage 1, ip2limm AND (ivalid);

8. Instruction in stage 3 is setting flags, and the branch in stage is dependent upon this so stall stages 1, and 2, i.e. i_branch_holdup2;

9. The opcode is not valid (p2iv=0) and this is not due to an interrupt (p2int=0);

10. An actionpoint (or BRK) is triggered which disables instructions from going into stage 3 if the delay slot of a branch/jump instruction is in stage 1;

11. There is a branch/jump (I_p2branch) in stage 2 with a delay slot dependency (NOT p2limm AND p1p2step) in stage 1 that is not killed (NOT p2killnext);

12. A comparison that is false in stage 3 for Compare/Branch instruction results in instruction in stage 2 being stalled (cmpbcc_holdup12); or

13. A conditional jump with a register is detected in stage 2 for which shortcutting is required from an instruction in stage 3. This is not available so stall the pipeline (ip2_jcc_scstall).

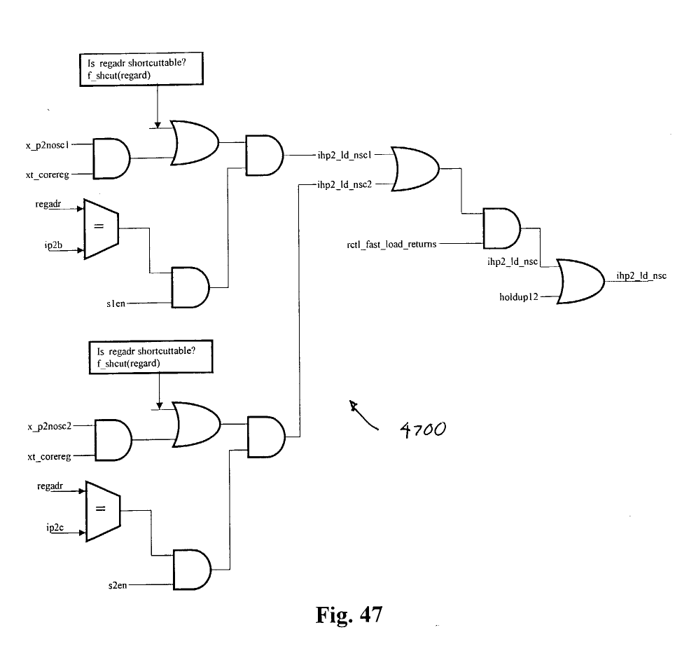

For the case when a register referenced by the instruction is held-up due to a delayed load (3), holdup12 OR hp2_{—}1d_nsc, pipeline stage 2 is disabled based upon the signals defined in the exemplary disabling logic 4700 of FIG. 47.

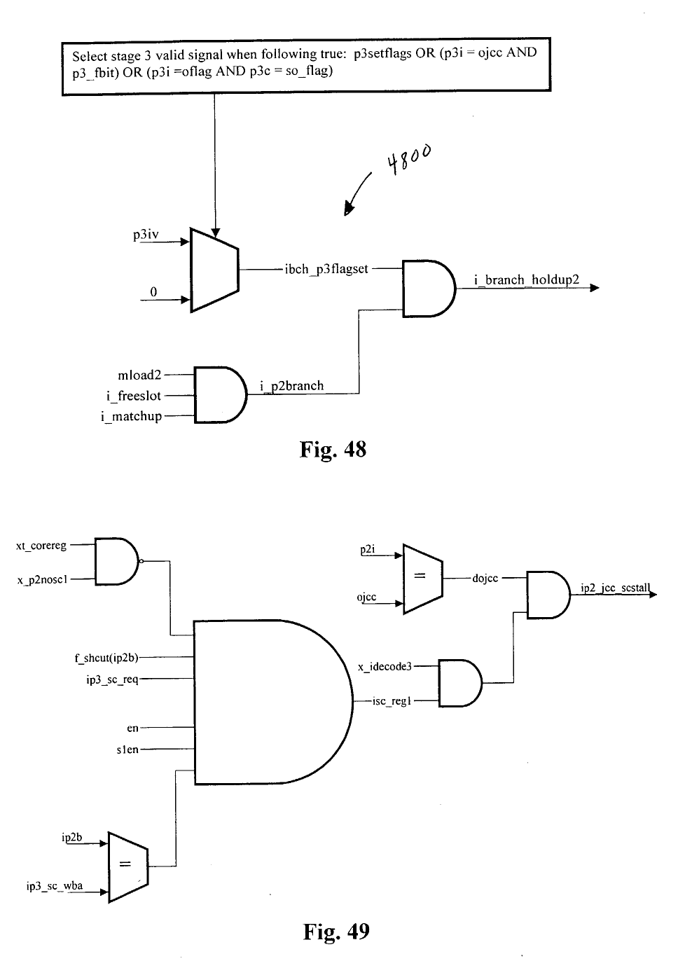

A branch in stage 2 requiring the state of the flags for the operation in stage 3 that has flag setting enabled will need to stall stage 1 and two (holdup); this stall is implemented using the exemplary logic 4800 of FIG. 48. Note that in the present embodiment, this condition is not applicable to BRcc instruction.

The disabling mechanism is activated when a conditional jump with a register containing the address is detected in stage 2 for which shortcutting is required from an instruction in stage 3 (refer to FIG. 49). When this is not available, the pipeline stage is stalled. As shown in FIG. 49, the conditions that have to be met for stage 2 to be stalled include (i) a conditional jump is in stage 2; (ii) a register shortcut will be performed from stage 3 to stage 2; (iii) processor is running, en=1; (iv) enable to source 1 address is active, s1en=1; (v) an extension core register without shortcutting has not been accessed; (vi) the register being accessed can be shortcut, f_shcut(ip2b)=1; (vii) a writeback address has been generated for shortcutting; (viii) a writeback request has been generated in stage 3; and (ix) there is an extension instruction in stage 3.

The address for selecting from the core register for operand one (s1a) is determined in the following way (Table 18a):

TABLE 18a

| Source | Description |
|---|---|
| C-field (i_p2c_field_r) | For 32-bit instructions when major opcode is 0x04 (p2opcode_r = |
| | op_fmt1) for MOV, RSUB and RCMP instructions |
| 16-bit High register | The major opcode is 0x0D (p2opcode_r = op_16_mv_add) for |
| (i_p2hi_reg16_r) | MOV instruction where source address 0 to 63 |
| 0x1A (rglobalp) | The major opcode is 0x19 (p2opcode_r = op_16_gp_rel) for |
| | LD instructions which are relative to the global pointer |
| 0x1C (rstackp) | The major opcode is 0x18 (p2opcode_r = op_16_sp_rel) for |
| | LD, ST, PUSH and POP instructions which are relative to the |
| | stack pointer |
| B-field (i_p2b_field_r) | For all other 32/16-bit instructions |

The address for selecting from the core register for operand two (s2a) is determined in the following way (Table 18b):

TABLE 18b

| Control Signal | Description |
|---|---|
| B-field (i_p2b_field_r) | For 32-bit instructions when major opcode is 0x04 (p2opcode_r = |
| | op_fmt1) for RSUB and RCMP instructions. For 16-bit |
| | instructions when major opcode is 0x0F (p2opcode_r = |
| | op_16_alu_gen) for single operand instructions |
| | (p2subopcode2_r = so16_sop) for SUB.NE for clearing |
| | registers. Also for major opcode is 0x0D (p2opcode_r = |
| | op_16_mv_add) for MOV instruction where destination |
| | address from 0 to 63 |
| 16-bit High register | The major opcode is 0x0D (p2opcode_r = op_16_mv_add) for |
| (i_p2hi_reg16_r) | MOV or CMP instruction where source address 0 to 63 |
| 0x1F (rblink) | For 16-bit instructions when major opcode is 0x0F |
| | (p2opcode_r = op_16_alu_gen) for single operand instructions |
| | (p2subopcode2_r = so16_sop) and zero operand instructions |
| | (i_p2c_field_r = so16_zop) for jumps, i.e. JEQ, JNE, J and J.D. |
| C-field (i_p2c_field_r) | For all other 32/16-bit instructions |

Destination Address (dest)—The destination address (dest) for writebacks to the core register is fed to the load scoreboarding unit (1su), and to the ALU in stage 3. These destination addresses are based upon the instruction encodings.

TABLE 19

| Control Signal | Description |
|---|---|
| B-field (i_p2b_field_r) | For 32-bit instructions when major opcode is 0x04 |
| | (p2opcode_r = op_fmt1) for MOV, single operand instructions |
| | (i_p2subopcode_r = so_sop) in addition to formats, signed 12- |
| | bit and conditional execution. For 16-bit instructions when |
| | major opcode is 0x0F (p2opcode_r = op_16_alu_gen) as well |
| | as major opcode is 0x0D (p2opcode_r = op_16_mv_add) for |
| | MOV instruction where destination address from 0 to 63. The |
| | major opcode is 0x18 (p2opcode_r = op_16_sp_rel) for LD, |
| | ST, PUSH and POP instructions which are relative to the stack |
| | pointer. The 16-bit shift/subtract instructions major opcode is |
| | 0x17 (p2opcode_r = op_16_ssub) when not performing bit test |
| | operation (p2subopcode3_r = so16_add_u7). The 16-bit |
| | instruction major opcode is 0x1B (p2opcode_r = op_16_mv) |
| | for MOV instruction |
| 0x0 (r0) | The major opcode is 0x19 (p2opcode_r = op_16_gp_rel) |
| | for all instructions which are relative to the global pointer |
| 16-bit High register | The major opcode is 0x0D (p2opcode_r = op_16_mv_add) for |
| (i_p2hi_reg16_r) | MOV or CMP instruction where source address 0 to 63 |
| C-field (i_p2c_field_r) | For 16-bit LD/ST instructions for major opcodes between 0x10 |
| | and 0x16 in addition to 0x0D (p2opcode_r = op_16_arith) |
| 0x1C (rstackp) | The major opcode is 0x18 (p2opcode_r = op_16_sp_rel) for |
| | ADD and SUB instructions which are relative to the stack |
| | pointer |
| 0x3F (rlimm) | For the 16-bit instruction when major opcode is 0x0F |
| | (p2opcode_r = op_16_alu_gen) for single operand instructions |
| | (p2subopcode2_r = so16_sop) when zero operand instructions |
| | (i_p2c_field_r = so16_zop) are performed |
| A-field (i_p2a_field_r) | For all other 32/16-bit instructions |

Stage 2 Instruction Valid (p2iv)—The instruction valid (p2iv) signal for stage 2 qualifies each instruction as it proceeds through the pipeline. It is an important signal when there are stalls, e.g. an instruction in stage 2 causes a stall and the instruction in stage 3 is executed, so when the instruction in stage 2 is allowed to proceed the instruction in the later stage is invalidated since it has already completed. The stage 2 invalid signal is updated when: (i) Stage 2 is allowed to move on while stage 1 is held (en2 AND NOT en1), hence the instruction in stage 2 must be killed so that it is not re-executed when the instruction in stage 1 is available, i_p2iv=0; (ii) Stage 1 is stalled (NOT en1) therefore the state of p2iv is retained, i_p2iv=i_p2iv r; or (iii) an interrupt is in stage 1 or stage 2 or long immediate data is present or the delay slot is to be killed, i_p2iv=0. Otherwise the stage 2 valid signal is set to the instruction valid signal for stage 1, i_p2iv=ivalid.

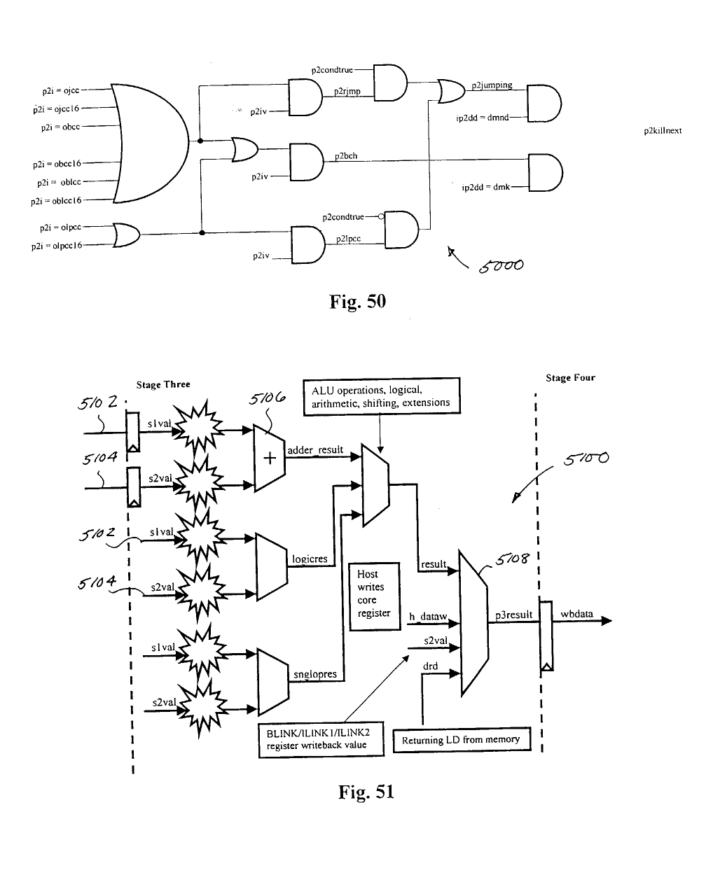

Kill Next Instruction in Stage 2 (p2killnext)—The kill signal for destroying instructions in the delay slots of jumps/branches based upon the mode selected is implemented using the exemplary logic 5000 of FIG. 50. A delay slot is killed according to the following criteria: (i) the delay slot is killed and Branch/Jump is taken; (ii) the delay slot is always killed and Branch/Jump is not taken.

Instruction error (instruction error)—This error is generated when a Software Interrupt (SWI) instruction is detected in stage 2. This is identical to an unknown instruction interrupt, but a specific encoding has been assigned in the present embodiment to generate this interrupt under program control. An instruction error is triggered when any of the following are true: (i) a major opcode is invalid and the sub-opcode are both invalid for the 32-bit ISA (f_arcop(p2opeode, p2subopcode)=0); (ii) a major Opcode is invalid for the 16-bit ISA (f_arcop16(p2opcode)=0) and this is not an extension instruction (NOT x_idecode2 AND NOT xt_aluop); (iii) an SWI instruction has been detected. The state of p2iv is passed to the instruction_error when any of the conditions stated above is true.

Condition Code Evaluation (p2condtrue)—The condition code field in the instruction is employed to specify the state of the ALU flags that need to be set for the instruction to be executed. The p2ccmatch and p2ccmatch16 signals are set when the conditions set in the condition code field match the setting of the appropriate flags. These signals are set by the following functions for 32 and 16 bit instructions respectively:

1. For 32-bit ISA the p2ccmatch is set when (f_ccunit(aluflags_r, i_p2q₁₃ r)=1)

2. For 16-bit ISA the p2ccmatch16 is set when (f_ccunit16(aluflags_r, i_p2q16_r)=1)

3. The p2condtrue signal enables the execution of an instruction if the specified condition is true and is as shown below.

4. For Branches, p2condtrue=‘1’

Opcode, p2opcode=0×0 (op_bcc)

Conditional execution, p2iw_r[4]/=0×1

5. For Basecase instructions, p2condtrue=‘1’

Opcode, p2opcode=033 4 (op_fmt1)

Conditional register operation, p2iw_r[23:22]=0×3

6. Condition code extension bit is not set, p2condtrue=p2ccmatch

7. Condition code extension bit is set, p2condtrue=xp2ccmatch

8. The p2condtrue16 signal enables the execution of an instruction if the specified condition is true and is as shown below

9. Opcode, p2opcode=0×1E (op_{—}16_bcc), p2condtrue16=p2ccmatch16

10. Opcode, p2opcode=0×1F (op_{—}16_bl), p2condtrue16=p2ccmatch16

Register Field Valid to LSU (s1en, s2en, desten)—These signals act as enables to the load scoreboard unit (1su) to qualify the register address buses, i.e. s1a, fs2a and dest. These signals are decoded from the major opcode (p2opcode) and the minor opcode (p2subopcode). Each of the enables is qualified with the instruction valid (p2iv_r) signal and they are as follows:

1. Source 1 operand enable—s1en

f_s1en (function is true when using valid core register)

OR an extension instruction that writes to a core register

OR an extension operation that writes to a core register

2. Source 2 operand enable—s2en

f_s2en (function is true when using valid core register)

OR an extension instruction that writes to a core register

3. Destination address enable—desten

f_desten (function is true when using valid core register)

OR an extension instruction that writes to a core register

Detected PUSH/POP Instruction (p2pushpop)—There is a PUSH or POP instruction in stage 2 when: (i) PUSH—Opcode (p2opcode)=0×17 and subopcode (p2subopcode)=0×6; or (ii) POP—Opcode (p2opcode)=0×17 and subopcode (p2subopcode)=0×7. These are a special encoding of LD/ST instructions. There is a separate signal for PUSH and POP instructions, i.e. p2push and p2pop respectively.

Detected Loads & Stores—The encodings for a LD or a ST detected in stage 2 are defined in Table 20. These are derived from the major opcode (p2opcode) and subopcodes for the 32/16-bit ISA. The main signals are denoted as follows:

p2st—This is the decode of all STs in stage 2

p21d—This is the decode of all LDs in stage 2

p2sr—This is the decode of an auxiliary SR in stage 2

p21r—This is the decode of an auxiliary LR in stage 2

TABLE 20

| LD/ST Type | Opcode | Subopcode |
|---|---|---|
| LD (op_ld) | 0x02 | N/A |
| LD (op_fmt1) | 0x04 | p2iw_r[21:16] = 0x30 (p2subopcode_r = so_ld) |
| LDB (op_fmt1) | 0x04 | p2iw_r[21:16] = 0x32 (p2subopcode_r = so_ldb) |
| LDB.X (op_fmt1) | 0x04 | p2iw_r[21:16] = 0x33 (p2subopcode_r = |
| | | so_ldb_x) |
| LDW (op_fmt1) | 0x04 | p2iw_r[21:16] = 0x34 (p2subopcode_r = so_ldw) |
| LDW.X (op_fmt1) | 0x04 | p2iw_r[21:16] = 0x35 (p2subopcode_r = |
| | | so_ldw_x) |
| LD (op_16_ld_add) | 0x0C | p2iw_r[20:19] = 0x00 (p2subopcode1_r = |
| | | so16_ld) |
| LDB (op_16_ld_add) | 0x0C | p2iw_r[20:19] = 0x01 (p2subopcode1_r = |
| | | so16_ldb) |
| LDW (op_16_ld_add) | 0x0C | p2iw_r[20:19] = 0x10 (p2subopcode1_r = |
| | | so16_ldw) |
| LD (op_16_ld_u7) | 0x10 | N/A |
| LDB (op_16_ldb_u5) | 0x11 | N/A |
| LDW (op_16_ldw_u6) | 0x12 | N/A |
| LDW.X (op_16_ldwx_u6) | 0x13 | N/A |
| LD (op_16_sp_rel) | 0x18 | p2iw_r[23:21] = 0x0 (p2subopcode3_r = |
| | | so16_ld_sp) |
| LDB (op_16_sp_rel) | 0x18 | p2iw_r[23:21] = 0x1 (p2subopcode3_r = |
| | | so16_ldw_sp) |
| POP (op_16_sp_rel) | 0x18 | p2iw_r[23:21] = 0x7 (p2subopcode3_r = |
| | | so16_pop_u7) |
| LD (op_16_gp_rel) | 0x19 | p2iw_r[23] = 0x0 (p2subopcode4_r = so16_ld_gp) |
| LD (op_16_ld_pc) | 0x1A | N/A |
| ST (op_st) | 0x03 | N/A |
| ST (op_16_st_u7) | 0x14 | N/A |
| STB (op_16_stb_u5) | 0x15 | N/A |
| STW (op_16_stw_u6) | 0x16 | N/A |
| ST (op_16_sp_rel) | 0x18 | p2iw_r[23:21] = 0x2 (p2subopcode3_r = |
| | | so16_st_sp) |
| STB (op_16_sp_rel) | 0x18 | p2iw_r[23:21] = 0x3 (p2subopcode3_r = |
| | | so16_stb_u7) |
| PUSH (op_16_sp_rel) | 0x18 | p2iw_r[23:21] = 0x6 (p2subopcode3_r = |
| | | so16_pop_u7) |
| ST (op_16_gp_rel) | 0x19 | p2iw_r[23] = 0x1 (p2subopcode4_r = so16_st_gp) |

A valid LD/ST instruction in stage 2 is qualified as follows: (i) mload2—p21d AND p2iv; and (ii) mstore2—p2st AND p2iv. Note that the subopcodes for the 16-bit ISA are derived from different locations in the instruction word depending upon the instruction type. It is also important to note that all 16-bit LD/ST operations do not support the .DI (direct to memory bypassing the data cache) feature in the present embodiment.

Update BLINK Register (p2dolink)—This signal flags the presence of a valid branch and link instruction (p2iv and p2jblcc) in stage 2, and the pre-condition for executing this BLcc instruction is also valid (p2condtrue). The consequence of this configuration is that the BLINK register is updated when it reaches stage 4 of the pipeline.

Perform Branch (dorel/doicc)—A relative branch (Bcc/BLcc) is taken when: (i) the condition for the branch is true (p2condtrue); (ii) the condition for the loop is false (NOT p2condtrue); and (iii) the instruction in stage 2 is valid (p2iv). An indirect jump (Jcc) is taken when: (i) the condition for the jump is true (p2condtrue); (ii) the instruction is a jump (p2opcode=ojcc); and (iii) the instruction in stage 2 is valid (p2iv).

Instruction Execute Interface

The instruction execute interface configuration needed to support the combined 32/16-bit ISA is now described in greater detail, specifically with regard to the third (execute) stage of the pipeline. In this stage, LD/ST requests are serviced and ALU operations are performed. The third stage of the exemplary processor includes a barrel shifter for rotate left/right, arithmetic shift left/right operations. There is an ALU, which performs addition and subtraction for standard arithmetic operations in addition to address generation. Exemplary signals at the instruction execute interface are defined in Table 21.

TABLE 21

| | Input/ | Bus | |
|---|---|---|---|
| Signal Name | Output | Width | Description |
| ap_p3disable_r | output | 1 | This indicates that stage 3 of the pipeline has been |
| | | | stalled once it has been flushed due a BRK or |
| | | | actionpoint. |
| en3 | output | 1 | Enable to pipeline stage 3. |
| ldvalid | input | 1 | A delayed load writeback will occur on the next |
| | | | cycle. |
| ldvalid_wb | input | 1 | Controls the multiplexing to the register file for LD |
| | | | writeback path. |
| mload | output | 1 | A valid load is in stage 3. |
| mstore | output | 1 | A valid store is in stage 3. |
| mwait | input | 1 | Direct memory pipeline cannot accept any further |
| | | | LD/ST accesses. |
| nocache | output | 1 | Indicates that the LD/ST should bypass the data |
| | | | cache. |
| p3a | output | 6 | Destination field in stage 3. |
| p3_alu_cc | output | 1 | ALU operation condition code field present at stage |
| | | | 3 for detecting MAC/MUL instructions. |
| p3c | output | 6 | Condition code field. |
| p3cc | output | 4 | This is the condition code field. |
| p3condtrue | output | 1 | This is from the result of the condition code unit in |
| | | | stage 3. |
| p3dolink | output | 1 | BLcc/JLcc is taken in stage 2 so update the blink |
| | | | register. Registered p2dolink signal. |
| p3opcode | output | 5 | Opcode for instruction |
| p3ilev1 | input | 1 | |
| p3int | input | 1 | The interrupt has entered into stage 3. |
| p3iv | output | 1 | Instruction valid in stage 3. |
| p3lr | output | 1 | LR is requested in stage 3. |
| p3_ni_wbrq | output | 1 | |
| p3q | output | 5 | Condition code field. |
| p3setflags | output | 1 | The current instruction has flag setting enabled. |
| p3sr | output | 1 | There is a SR instruction in stage 3. |
| p3wba | output | 6 | Writeback address |
| p3wb_en | output | 1 | This is the writeback enable signal in stage 3. |
| p3wb_nxt | output | 1 | |
| regadr | input | 6 | Register address for returning loads. |
| sc_load1 | output | 1 | |
| sc_load2 | output | 1 | |
| sc_reg1 | output | 1 | |
| sc_reg2 | output | 1 | |
| sex | output | 1 | Sign extend returning load. |
| size | output | 2 | This indicates the size of the LD/ST operation: |
| | | | 0x0 - longword |
| | | | 0x1 - word |
| | | | 0x2 - byte |
| | | | 0x3 - reserved |
| xholdup123 | input | 1 | Extension stall signal for stages 1, 2 and 3. |
| x_idecode3 | input | 1 | This is the decode for the extensions. |
| Xnwb | input | 1 | |
| xshimm | input | 1 | Sign extend short immediate. |
| xp3ccmatch | input | 1 | This signal is from the extension condition code unit |
| | | | from stage 3. |

The execution logic in stage 3 requires configuration of the following modules: (i) rctl—Control for additional instructions, i.e. CMPBcc, BTST, etc; (ii) bigalu—Calculation of arithmetic and logical expressions in addition to address generation for LD/ST operations; (iii) aux_regs—This contains the auxiliary registers including the loopstart, loopend registers; and (iv) 1su—Modifications to scoreboarding for the new PUSH/POP instructions.

Stage 3 Data Path—Referring no to FIG. 51, an exemplary configuration of the stage 3 data path according to the present invention is described. Specific functionalities considered in the design of this data path include: (i) address generation for LD/ST instructions; (ii) additional multiplexing for performing pre/post incrementing logic PUSH/POP instructions; (iii) MIN/MAX instruction as part of basecase ALU operation; (iv) NOT/NEG/ABS instruction; (v) the configuration of the ALU unit; and (vi) Status32_L1/Status32_L2 registers. The data path 5100 of FIG. 51 shows two operands, s1val 5102 and s2val 5104, are latched into stage 3 wherein the adder 5106 and other hardware performs the appropriate computation; i.e. arithmetic, logical, shifting, etc. In the present configuration, an instruction cannot be killed once it has left stage 3, therefore all writebacks and LD/ST instructions will be performed.

A multiplexer 4602 (FIG. 46)_is also provided for selecting the flags based upon the current operation or the last flag setting operation if flag setting is disabled.

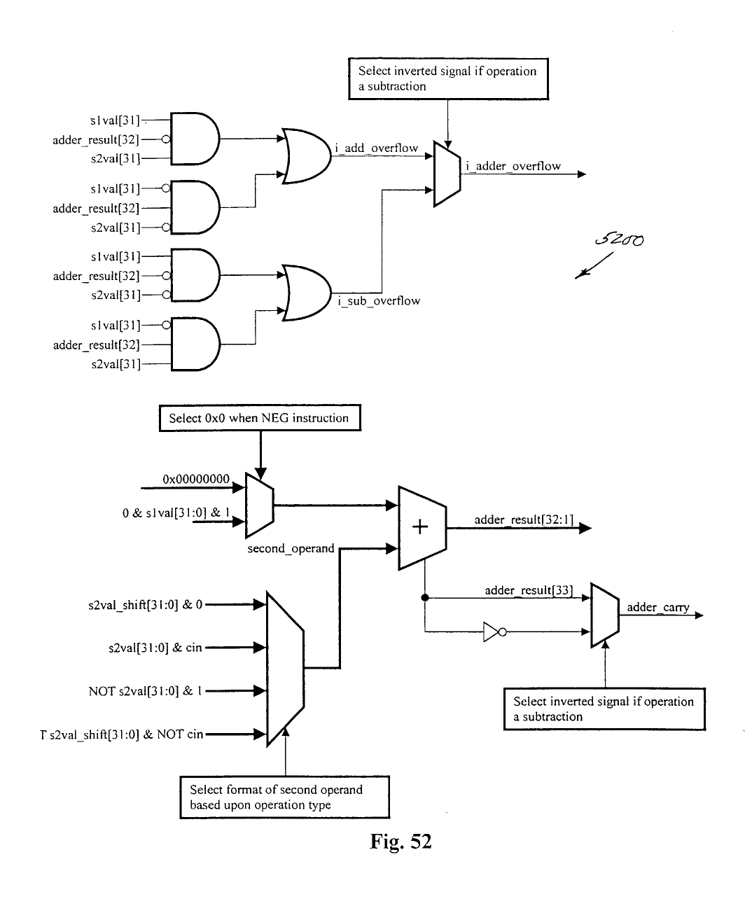

The stage 3 arithmetic unit of the present embodiment performs the necessary calculations for generating addresses for LD/ST accesses and standard arithmetic operations, e.g. ADD, SUB, etc. The outputs from stage 2; i.e. s1val 5102 and s2val 5104 are fed into stage 3, and these inputs are formatted (depending upon the instruction type) before being forwarded into the 32-bit adder 5106. The adder has four modes of operation including addition, addition with a carry in, subtraction, and subtraction with a carry in. These modes are derived from the instruction opcode and the subopeode for 32-bit instructions. Exemplary logic 5200 associated with arithmetic unit is shown in FIG. 52. The signal s2val_shift is associated with the shift ADD/SUB instructions as previously defined.

The instructions that use the adder 5106 in the ALU to generate a result are shown in Table 22. The opcodes are grouped together to select the appropriate value for the second operand.

TABLE 22

| | Opcode/ | |
|---|---|---|
| Instruction | Subopcode | Arithmetic Type |
| LD | 0x02 | Addition |
| ST | 0x03 | Addition |
| | 0x04 | |
| NEG | 0x04/0x13 | Subtraction |
| ABS | 0x04/0x2F/0x09 | Subtraction |
| MAX | 0x04/0x08/0x3E | Subtraction |
| MIN | 0x04/0x09/0x3E | Subtraction |
| LD/ST | 0x0D | Addition |
| ADD | 0x0E/0x0 | Addition |
| CMP | 0x0E/0x2 | Subtraction |
| LD | 0x10 | Addition |
| LDB | 0x11 | Addition |
| LDW | 0x12 | Addition |
| LDW.X | 0x13 | Addition |
| ST | 0x14 | Addition |
| STB | 0x15 | Addition |
| STW | 0x16 | Addition |
| LD PC | 0x1A | Addition |
| relative/ | | |
| LD SP | 0x18/0x00 | Addition |
| relative | | |
| PUSH | 0x18/0x07 | Subtraction |
| POP | 0x18/0x06 | Addition |
| ADD GP | 0x19/0x03 | Addition |
| relative | | |
| ADD | 0x0D/0x00 | Addition |
| SUB | 0x17/0x03 | Subtraction |

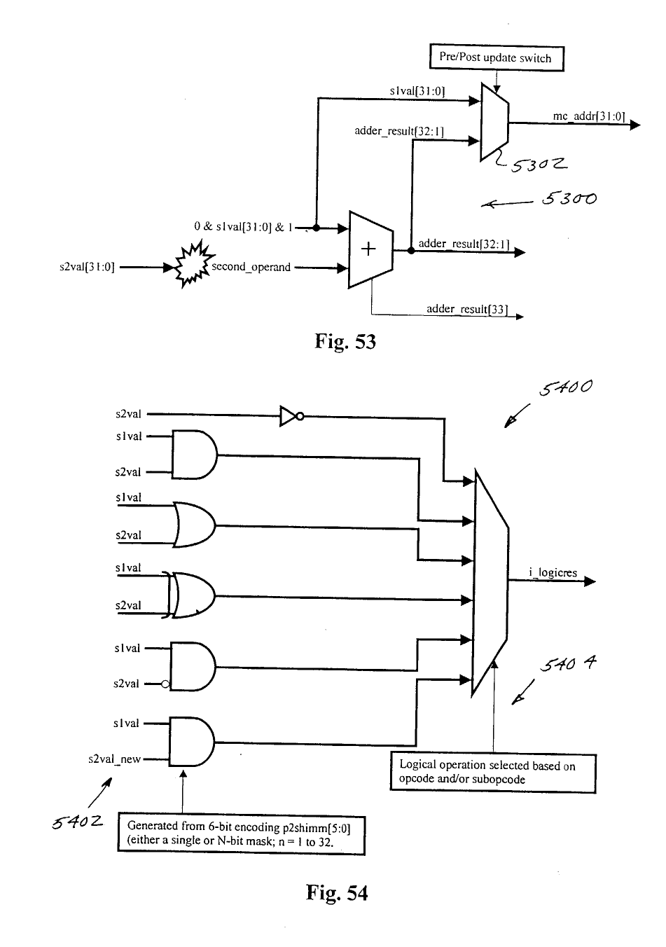

The address generation logic 5300 for LD/STs (FIG. 53) allows pre/post update logic for writeback modes. This requires a multiplexer 5302, which should select from either s1val (pre-updating) or the output of the adder (post-update). The PUSH/POP instructions also employ this logic since they automatically increment/decrement the stack pointer as items of data are added and removed from it.

The logical operations (e.g., i_logicres) performed in stage 3 are processed using the exemplary logic 5400 shown in FIG. 54. The instruction types that are available in the processor described herein are as follows: (i) NOT instruction; (ii) AND instruction; (iii) OR instruction; (iv) XOR instruction; (v) BIC (Bitwise AND operator) instruction; and (vi) AND & MASK instruction. The type of logical operation provided by the logic 5400 is selected via the opcode/subopcode input 5404. Note that the signal s2val_new 5402 is part of the functionality for masking logic and bit testing. This value is generated from a 6-bit encoding p2shimm [5:0] which can produce either a single bit mask or an n-bit mask where n=1 to 32.

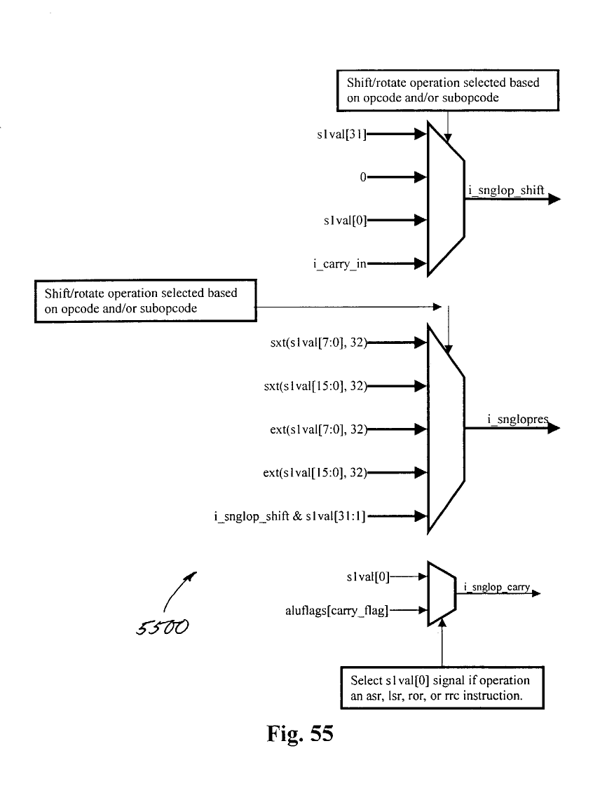

Referring now to FIG. 55, the shift and rotate instruction logic 5500 and associated functionality is now described. Shift and rotating instructions are provided in the processor to perform single bit shifts in both the left and right direction. These instructions are all single operand instructions in the illustrated embodiment, and they are qualified as shown in Table 23:

TABLE 23

| Operation | Description |
|---|---|
| Sign extend byte | Lower 8-bits of source 1 operand (s1val) are sign extended |
| Sign extend word | Lower 16-bits of source 1 operand (s1val) are sign extended |
| Zero extend byte | Lower 8-bits of source 1 operand (s1val) are zero extended |
| Zero extend word | Lower 16-bits of source 1 operand (s1val) are zero extended |
| Arithmetic shift right | Concatenate the shifted value (snglop_shift) with the bottom |
| | 31-bits from source operand 1 (s1val) |
| Logical shift right | Concatenate the shifted value (snglop_shift) with the bottom |
| | 31-bits from source operand 1 (s1val) |
| Rotate right | Concatenate the shifted value (snglop_shift) with the bottom |
| | 31-bits from source operand 1 (s1val) |
| Rotate right through carry | Concatenate the shifted value (snglop_shift) with the bottom |
| | 31-bits from source operand 1 (s1val) |

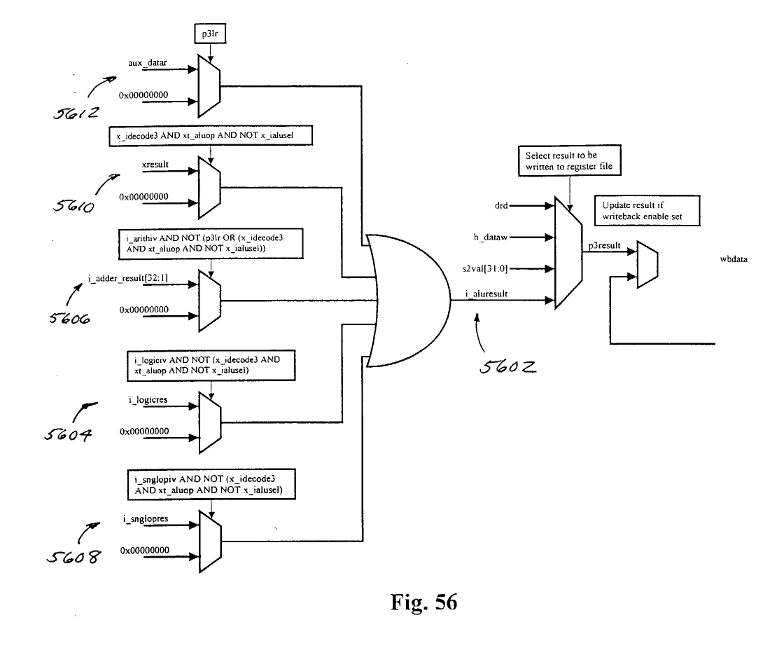

The result of an operation in stage 3 that is written back to the register file is derived from the following sources: (i) returning Loads (drd); (ii) host writes to core registers (h_dataw); (iii) PC to ILINK/BLINK registers for interrupts and branches respectively (s2val); and (iv) result of ALU operation (i_aluresult). FIG. 56 illustrates exemplary results selection logic 5600 used in the invention. Note that the result of operations from the ALU (i_aluresult) 5602 is derived from the logical unit 5604, 32-bit adder 5606, barrel shifter 5608, extension ALU 5610 and the auxiliary interface 5612.

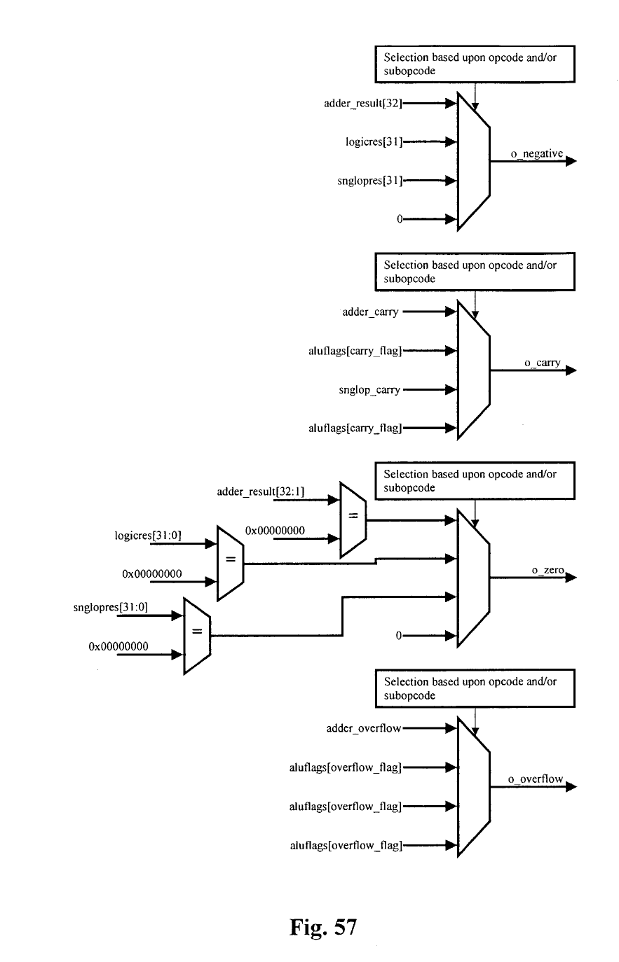

The status flags are updated under an arithmetic operation (ADD, ADC, SUB, SBC), logical operation (AND, OR, NOT, XOR, BIC) and for single operand instructions (ASL, LSR, ROR, RRC). The selection of the flags from the various arithmetic, logical and extension units is as shown in FIG. 57.

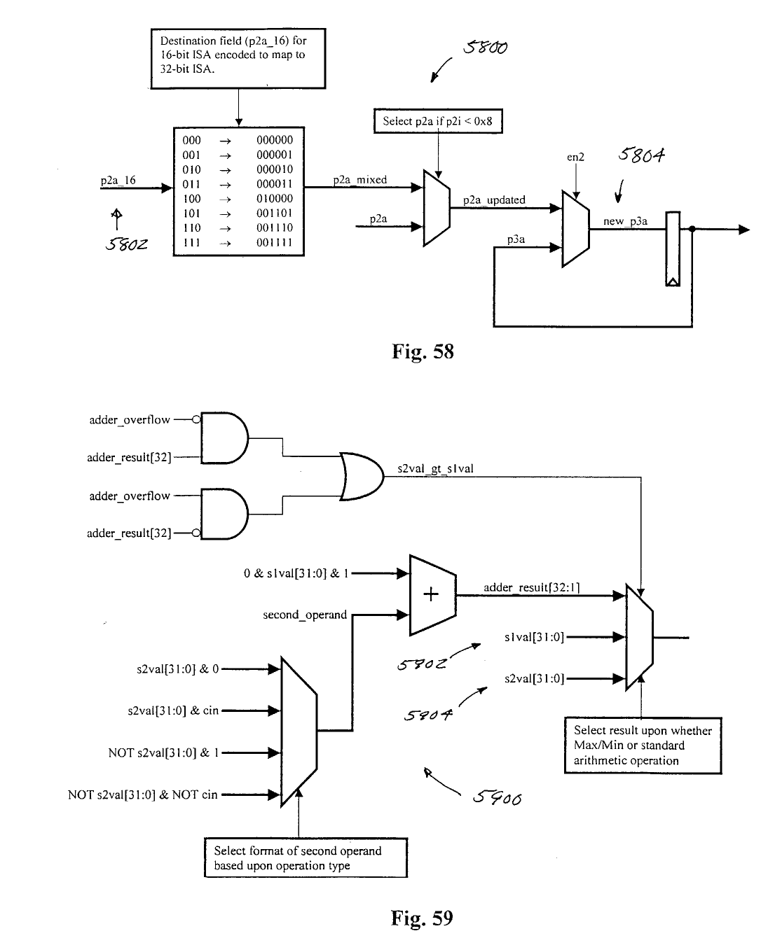

Writeback Register Address—The writeback register address is selected from the following sources, which are listed in order of priority: (1) Register address from LSU for returning loads, regadr; (2) Register address from host for writes to core register, h_regadr; (3) Ilink1 (r29) register for level 1 interrupt, rilink1; (4) Ilink2 (r30) register for level 2 interrupt, rilink2; (5) LD/ST address writeback, p3b; (6) POP/PUSH address writeback, r28; (7) Blink register for BLcc instructions, rblink; and (8) Address writeback for standard ALU operations, p3a. FIG. 58 illustrates exemplary writeback address generation logic 5800 useful with the present invention.

Delayed LD writebacks override host writes by setting the hold_host signal for a cycle. Refer to the discussion of control signals provided elsewhere herein for this data path. For the 16-bit instructions the opcodes (p3opcode) are 0×08 to 0×1f, hence, the writeback addresses have to be remapped to the 32-bit instruction encoding (performed in stage 2 of the pipeline). This applies to the p3a field, which should format the 16-bit register address so that the register file is correctly updated. The 16-bit encoding of the destination field from stage 2 is p2a_{—}16 5802, and this translated to the 32-bit encoding as shown in FIG. 62. The new writeback 5804 is latched into stage 3 based upon the opcode and the pipeline enable (en2) being set.

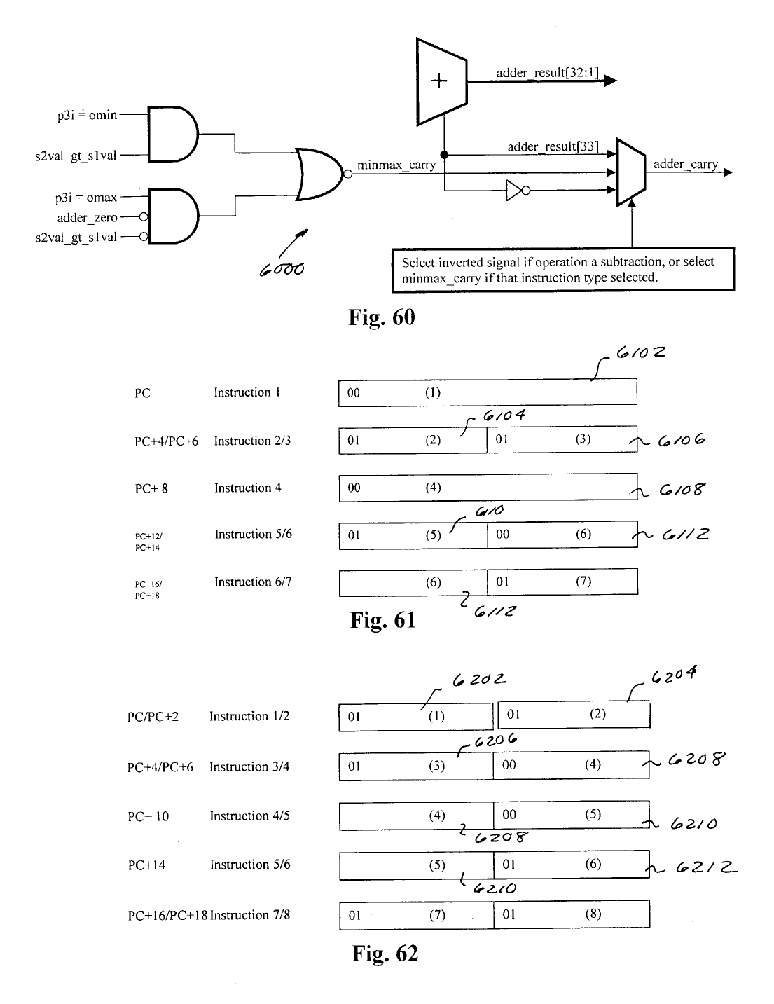

Min/Max Instructions—FIG. 59 illustrates an exemplary configuration of the MIN/MAX instruction data path 5900 within the processor. The MIN/MAX instructions of the illustrated embodiment require that the appropriate signal, i.e. s1val 5902 or s2val 5904, be passed on to stage 4 for writeback based upon the result of computation. These instructions are performed by subtracting s2val from s1val and then checking which value is larger or smaller depending upon whether MAX or MIN. There are three sources for selection from the arithmetic unit, since the value returned to stage 4 is not as a result of the computation in the adder, but is from the source operands. The values are selected as follows: (i) s1val—Opcode is MIN (p3opcode=omin) and source two operand was greater than source one operand (s2val_gt_s1val=1); (ii) s1val—Opcode is MAX (p3opcode=omax) and source two operand was not greater than source one operand (s2val_gt_s1val=0); (iii) s2val—For all other cases of MIN/MAX instruction. The flags for these instructions for zero, overflow, and negative remain unchanged from the standard arithmetic operations. The carry flag requires additional support as shown in FIG. 60, which illustrates exemplary carry flag logic 6000 for the MIN/MAX instruction.

Status32 L1 & Status32 L2 Registers—The registers employed for saving the status of the flags when a level one or two interrupt is serviced are called Status32_L1 and Status32_L2 respectively. The Status32_L1 register is updated when any of the following is true: (i) an interrupt is in stage 3 (p3int AND wba=rilink1)—Update the new value with aluflags_r, i_e1_r and i_e2_r; (ii) host access is required (h_write AND aux_access AND h_addr=rilink1)—Update the new value with h_dataw; (iii) auxiliary access is required (aux_write AND aux_access AND aux_addr=rilink1)—Update the new value with aux_dataw.

The Status32_L2 register is updated when any one of the following is true: (i) an interrupt is in stage 3 (p3int AND wba=rilink2)—Update the new value with aluflags_r, i_e1_r and i_e2_r; (ii) host access is required (h_write AND aux_access AND h_addr=rilink2)—Update the new value with h_dataw; or (iii) auxiliary access is required (aux_write AND aux_access AND aux_addr=rilink2)—Update the new value with aux_dataw. These status32 registers for the interrupts are returned to the standard status register when a jump and link with flag setting enabled is performed with ILINK1/ILINK2 as the destination.

Stage 3 Control Path—The control signals for stage 3 are as follows: (i) enables for Stage 3—en3; (ii) stage 3 Instruction Valid—p3iv; (iii) stall Stages 1, 2 & 3—holdup123; (iv) LD/ST requests—mload, mstore; (v) writeback, p3wba; (vi) other control signals, p3_wb_req. These signals support the mechanisms for performing ALU operations, extension instructions, and LD/ST accesses.

Stage 3 Pipeline Enable (en3)—The enable for registers in pipeline stage 3, en3, is false if any of the following conditions are true: (i) processor core is halted, en=0; (ii) extensions require that stages 1, 2 and 3 be held due to multi-cycle ALU operation, xholdup123 AND xt_aluop; (iii) direct memory pipeline is busy (mwait) and cannot accept any further LD/ST accesses from the processor; (iv) a delayed LD writeback will be performed on the next cycle and the instruction in stage 3 will write back to the register file, ip3_load_stall; (v) actionpoints (or BRK) has been detected and instructions have been flushed (i_AP_p3disable_r) through to stage 4. The stalling signal for a returning LD in stage 3 (ip3_load_stall) is derived from 1dvalid. For the case when rctl_fast_load_returns is enabled, the stage 3 enable is defined as follows: (i) a delayed LD writeback (1dvalid_wb) will be performed on the next cycle and the instruction in stage 3 will write back to the register file (p3_wb_req); (ii) a delayed LD writeback (1dvalid_wb) will be performed on the next cycle and the instruction in stage 3 is suppressing a write back to the register file, and wants the data and register address from the writeback stage (p3_wb_rsv).

Stage 3 Instruction Valid (p3iv)—The instruction valid (p3iv) signal for stage 3 qualifies each instruction as it proceeds through stage 3 of the pipeline. The stage 3 invalid signal is updated when: (i) stage 3 is stalled (NOT en3) therefore the state of p3iv is retained, i_p3iv=i_p3iv_r; (ii) instruction in Stage 2 (NOT en2) has not completed while the instruction in stage 3 has been performed successfully (en3) so it will move to stage 4. Hence the instruction on the following cycle should be invalidated otherwise it will be re-executed, i_p3iv=0. (iii) there is a ABS instruction in stage 2 and the operand is positive (p3killabs) so invalid the instruction in stage 3, i_p3iv=0; or (iv) a CMPBcc has reached stage 3 and the comparison is false hence the next instruction should be invalidated, i_p3iv=0. The signal p3iv is otherwise set to the instruction valid signal from the previous stage; i.e., i_p3iv=i_p2iv_r.

Writeback Address Enable (p3_wb_req)—A writeback will be requested under the following conditions: (i) branch & bink (BLcc) register writeback, p3dolink AND p3iv; (ii) interrupt link register writeback, (p3int); (iii) LD/ST Address writeback including PUSH/POP, p3m_awb; (iv) extension instruction register writeback, p3xwb_op; (v) load from auxiliary register space, p31r; or (vi) standard conditional instruction register writeback, p3ccwb_op. The BLcc instruction is qualified with p3iv so that killed instructions are accounted for while all other conditions are already qualified with p3iv. The writeback to the register file supports the PUSH/POP instructions since it must automatically update the register holding the SP value (r28).

Another writeback request to reserve stage 4 for the instruction currently in stage 3 is also provided.

Detected PUSH/POP Instruction (p3pushpop)—The state of whether there is a PUSH or POP instruction in stage 3 is updated when the pipeline enable for stage 2 (en2) is set (p3pushpop=p2pushpop) otherwise it remains unchanged. There is a PUSH or POP instruction in stage 3, respectively, when:

PUSH—Opcode (p3opcode)=0×17 and subopcode (p3subopcode) 0×6, and the instruction is valid (p3iv); or

POP—Opcode (p3opcode)=0×17 and subopcode (p3subopcode) 0×6, and the instruction is valid (p3iv)

These are a special encodings of LD/ST instructions. There is a separate signal for PUSH and POP instructions, i.e. p3push and p3pop respectively. This instruction is supported as a 16-bit instruction.

Detected Loads and Stores—The encodings for a LD, ST, LR or SR operation are detected in stage 3 and are derived from the major opcode (p3opcode) in association with the subopcode as shown in Table 24:

TABLE 24

| Operation | Description |
|---|---|
| mstore | This is the decode of all STs in stage 3, and the instruction is |
| | valid (p3iv) |
| Mload | This is the decode of all LDs in stage 3, and the instruction is |
| | valid (p3iv) |
| p3sr | This is the decode of an auxiliary SR in stage 3, and the |
| | instruction is valid (p3iv) |
| p3lr | This is the decode of an auxiliary LR in stage 3, and the |
| | instruction is valid (p3iv) |

Update BLINK Register (p3dolink)—The signal that flags that there is a valid branch and link instruction in stage 3 is p3dolink. This signal is updated from stage 2 by updating p3dolink with p2dolink when the pipeline enable for stage 2 (en2) is set. Otherwise p3dolink remains unchanged.

Writeback Register Address Selectors—The writeback register address is selected by the following control signals, which are listed in order of priority: (1) register address from LSU for returning loads, regadr; (2) register address from host for writes to core register, h_regadr; (3) Ilink1 (r29) register for level 1 interrupt, rilink1; (4) Ilink2 (r30) register for level 2 interrupt, rilink2; (5) LD/ST address writeback, p3b; (6) POP/PUSH address writeback, r28; (7) Blink register for BLcc instructions, rblink; and (8) address writeback for standard ALU operations, p3a. Delayed LD writebacks override host writes by setting the hold_host signal for a cycle. The data path is as previously described herein.

WriteBack Stage

The writeback stage is the final stage of the exemplary processor described herein, where results of ALU operations, returning loads, extensions and host writes are written to the core register file. The writeback interface is described in Table 25.

TABLE 25

| Signal | Input/ | Bus | |
|---|---|---|---|
| Name | Output | Width | Description |
| wba | output | 6 | This is the address of the core register to be |
| | | | written to when is true. |
| wben | output | 1 | This qualifies the data to be written to the |
| | | | register file. |
| wbdata | output | 32 | This is the 32-bit value written to the core |
| | | | register file. |

The pre-latched value for the writeback enable (p3wb_nxt) is updated when:

1. A host write is taking place (cr_hostw), p3wb_nxt=1;

2. A delayed load returns (1dvalid_wb), p3wb_nxt=1;

3. Tangent processor is halted (NOT en), p3wb_nxt=0;

4. Extensions require that stages 1, 2 and 3 be held due to multi-cycle ALU operation (xholdup123 AND xt_aluop), p3wb_nxt=0;

5. Direct memory pipeline is busy (mwait) and cannot accept any further LD/ST accesses from the processor, p3wb_nxt=0; or 6. A delayed LD writeback will be performed on the next cycle and the instruction in stage 3 will write back to the register file (ip3_load_stall), p3wb_nxt=0.

Otherwise when the processor is running and the instruction in stage 3 can be allowed to move on to stage 4, p3wb_nxt=1.

Instruction Fetch Interface

The instruction fetch interface performs requests for instructions from the instruction cache via the aligner. The aligner formats the returning instructions into 32-bits or 16-bits with source operand registers expanded depending upon the instruction. The instruction format for 16-bit instruction from the aligner is shown in Table 26 (note the following example assumes that the 16-bit instruction is located in the high word of the long word returned by the I-cache).

TABLE 26

| p1iw <= p0iw(31 downto 16) & | 16-bit instruction word |
|---|---|
| ‘0’ & | Flag bit |
| “00” & p0iw(26) & | B field MSBs |
| “00” & p0iw(23) & p0iw(23 downto 21) & | C field |
| “000000”; | Padding |

The 16-bit instruction source operands for the 16-bit ISA are mapped to the 32-bit ISA. The format of the opcode is 5-bits wide. The remaining part of the 16-bit ISA is decoded in the main pipeline control block (rctl).

The opcode (ip 1 opeode) is derived from the aligner output p1iw[31:27]. This opcode is latched only when the pipeline enable signal for stage 1, en1, is true to p2opcode. The addresses of the source operands are derived from the aligner output p1iw[25:12]. These source addresses are latched when the pipeline enable signal for stage 1, en1, is true to s1a, s2a. The 3-bit addresses from the 16-bit ISA have to be expanded to their equivalent in the 32-bit ISA.

The remaining fields in the 16-bit instruction word do not require any preformatting before going into stage 2 of the processor.

Exemplary constants employed to define locations of the fields in the 16-bit instruction set are shown in Table 27. Note the opcode for 16-bit ISA has been remapped to the upper part of the 32-bit instruction longword that is forwarded to the processor. This has been imposed to make the instruction decode for the combined ISA simpler.

TABLE 27

| Constant Name | Width | Description |
|---|---|---|
| isa16_width | 16 | This is width of the 16-bit ISA. |
| isa16_msb | 15 | This is most significant bit of the 16-bit ISA. |
| isa16_lsb | 0 | This is least significant bit of the 16-bit ISA. |
| opcode16_msb | 31 | This is most significant bit of the opcode field. |
| opcode16_lsb | 27 | This is least significant bit of the opcode field. |
| subopcode16_msb | 10 | This is most significant bit of the sub-opcode field. |
| subopcode16_lsb | 6 | This is least significant bit of the sub-opcode field. |
| shimm16_u9_msb | 6 | This defines most significant bit of 9-bit unsigned |
| | | constant. |
| shimm16_u9_lsb | 0 | This defines least significant bit of 9-bit unsigned |
| | | constant. |
| shimm16_u5_msb | 4 | This is most significant bit of a 5-bit unsigned immediate |
| | | data. |
| shimm16_u5_lsb | 0 | This is least significant bit of a 5-bit unsigned immediate |
| | | data. |
| shimm16_s9_msb | 6 | This is most significant bit of a 10-bit signed immediate |
| | | data. |
| shimm16_s9_lsb | 0 | This is least significant bit of a 10-bit signed immediate |
| | | data. |
| Fieldb16_msb | 11 | This is the most significant bit of the source operand one |
| | | field. |
| Fieldb16_lsb | 9 | This is the least significant bit of the source operand one |
| | | field. |
| Single_op16_msb | 7 | This is the most significant bit of the sub-opcode code |
| | | field. |
| Single_op16_lsb | 5 | This is the least significant bit of the sub-opcode field. |
| Fieldq16_msb | 7 | This is the most significant bit of the condition code field. |
| Fieldq16_lsb | 6 | This is the least significant bit of the condition code field. |
| Fieldc16_msb | 8 | This is the most significant bit of the source operand two |
| | | field. |
| Fieldc16_lsb | 6 | This is the least significant bit of the source operand two |
| | | field. |
| Fielda16_msb | 2 | This is the most significant bit of the destination field. |
| Fielda16_lsb | 0 | This is the least significant bit of the destination field. |

The constant definitions for the 32-bit ISA of the illustrated embodiment use an existing (e.g., ARCtangent A4) processor as a baseline. The naming convention therefore advantageously requires no modification, even though the locations of each of the fields in the instruction longword are particularly adapted to the present invention.

Instruction Aligner Interface

The exemplary interface to the instruction aligner is now described in detail. This module has the ability to take a 32/16-bit value from an instruction cache and format it so that the processor can decode it. The aligner configuration of the present embodiment supports the following features: (i) 32-bit memory systems; (ii) formatting of 32/16-bit instructions and forwarding them to processor; (iii) big and little endian support; (iv) aligned and unaligned accesses; and (v) interrupts. The instruction aligner interface is described in Table 28 and Appendix III hereto.

TABLE 28

| | Input/ | Bus | |
|---|---|---|---|
| Signal Name | Output | Width | Description |
| next_pc | input | 31 | This is the address of the instruction requested |
| | | | by the processor. |
| Ifetch | input | 1 | This is the instruction fetch signal from the |
| | | | processor. |
| word_fetch | output | 1 | This is the ifetch signal filtered to make sure we |
| | | | do not already have to next instruction in the |
| | | | aligner buffer |
| word_valid | input | 1 | Word returning from the cache is valid. |
| Ivalid | output | 1 | Instruction output from aligner is valid |
| p0iw | input | 32 | This is the instruction longword from the cache |
| | | | to the aligner. |
| p1iw | output | 32 | This is the instruction long word from the |
| | | | aligner |
| Dorel | input | 1 | This signal indicates that the instruction in stage |
| | | | 2 is a bcc/blcc/lpcc |
| Dojcc | input | 1 | This signal indicates that the instruction in stage |
| | | | 2 is a jcc/jlcc |
| docmprel | input | 1 | This signal indicates that the instruction in stage |
| | | | 3 is a brcc/bbit0/bbit1 |
| p2limm | input | 1 | The next longword is long immediate data so |
| | | | need not be aligned. |
| Ivic | input | 1 | Indicates that the instruction cache contents are |
| | | | invalid and, therefore, so is any information in |
| | | | the aligner. |
| inst_16 | output | 1 | This signal indicates that the instruction |
| | | | currently on p1iw is a 16-bit type instruction |
| misaligned_access | output | 1 | This signal is true when the aligner requires a |
| | | | next_pc value of current_pc + 8 |

The aligner of the illustrated embodiment is able to determine whether the requested instruction is 16-bits or 32-bits, as discussed below.

The aligner is able to determine whether an instruction is 32-bit or 16-bit by reading the two most significant bits, i.e. [31] and [30]. It determines an instruction is 32-bits wide p1iw[31:30]=“00” or 16-bits when p1iw=any of “01”, “10” or “11”. As previously described, there is provided a buffer in the aligner that holds the lower 16-bits of a longword when an access is performed that does not use the entire 32-bits of the instruction longword from the cache. The aligner maintains a history of this value and determines whether it is a 32/16-bit instruction. This allows single cycle execution for unaligned access provided the next instruction is a cache hit and the buffered value is part of the instruction. There is an additional signal from the processor, which tells the aligner that the next 32-bit longword is long immediate (p2limm) and as a consequence should be passed to the next stage unchanged.

The behavior of the aligner when it is reset (or restarted) is to determine whether the instruction is either 32-bits wide (=“00”) or 16-bits (when p1iw=any of “01”, “10” or “11”). An example of a sequential instruction flow is given in FIG. 61. As shown in the Figure, the first instruction 6102 is a 32-bit since p1iw[31:30]=“00”. The aligner does not need to perform any formatting. The second instruction 6104 is 16-bits since p1iw=“01”, “10” or “11”. Note the top 16-bits of this longword represents the instruction at address pc+4 while the lower 16-bits represents the instruction at address pc+6. As the aligner stores the lower 16-bits it must check to see whether it is a complete 16-bit instruction or the top half of a 32-bit instruction. This determines how the aligner filters the ifetch signal. The third instruction 6106 is 16-bits wide and is popped from the buffer and forwarded to the processor. No fetching is necessary from memory. The fourth instruction 6108 is 32-bits wide and is treated as the first instruction. The fifth instruction 6110 is 16-bits since p1iw[31:30] !=“00”. The lower 16-bits are buffered. The sixth instruction 6112 is 32-bits wide and is produced by concatenating the buffered 16-bits with the top 16-bits from the next sequential longword. The lower 16-bits are buffered.

Another example of a sequential instruction flow is shown in FIG. 62. The first instruction 6202 is a 16-bit since p1iw=“01”, “10” or “11”. The aligner passes this instruction via p1iw_16 to the processor. The lower 16-bits are buffered. The second instruction 6204 is also 16-bits and it is found to be part of the same longword, which held the first instruction where p1iw[15:14]=“01”. Note the top 16-bits represents the instruction at address pc while the lower 16-bits represents the instruction at address pc+2. The third instruction 6206 is also a 16-bit instruction and is processed in the same manner as (1). The lower 16-bits are buffered. The fourth instruction 6208 is 32-bits wide and is produced by concatenating the buffered 16-bits from (3) with the top 16-bits from the next sequential longword. The lower 16-bits are buffered. The fifth instruction 6210 is also 32-bits wide and is produced by concatenating the buffered 16-bits from (4) with the top 16-bits from the next sequential longword. The lower 16-bits are buffered. The sixth instruction 6212 is a 16-bit instruction and is popped from the history buffer and forwarded to the processor.

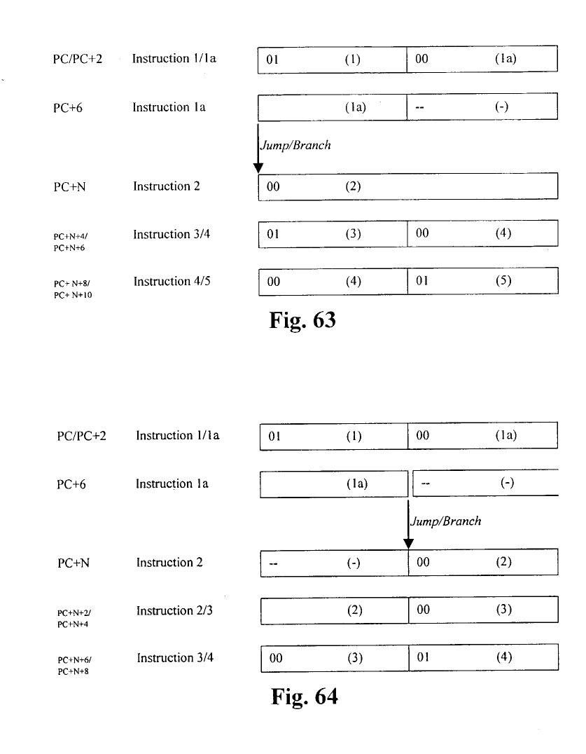

For branches (or jumps) that have destination addresses that are aligned (FIG. 63), the first instruction is a 16-bit since when p1iw=“01”, “10” or “11”. This is the Jump (or Branch) instruction. The aligner performs the appropriate formatting before passing the instruction to the processor. The lower 16-bits are buffered. The second instruction (1a) is 32-bits since the buffered value is p1iw[15:14]=“00”. Note the top 16-bits of the instruction is at address pc+4 while the lower 16-bits is at address pc+6. This is the delay slot of the Jump (or Branch) instruction. The next instruction after the branch (2) is 32-bits wide. This is longword aligned so there is no latency. The following instruction (3) is a 16-bit instruction wide and the lower 16-bits are buffered. The process then continues until terminated.

The behavior of the aligner when a branch (or jump) is taken determines whether the instruction it jumps to is either 32-bits wide (=“00”) or 16-bits (when p1iw=any of “01”, “10” or “11”). An example of an instruction flow where a branch (or jump) is shown in FIG. 64. The first instruction (1) is a 16-bit since p1iw[31:30] !=“00”. This is the Jump (or Branch) instruction. The aligner performs the appropriate formatting before passing the instruction to the processor. The lower 16-bits are buffered. The second instruction (1a) is 32-bits since the buffered value from (1) p1iw[15:14]=“00”. Note the top 16-bits of the instruction are at address pc+4 while the lower 16-bits are at address pc+6. This is the delay slot of the Jump (or Branch) instruction. The next instruction taken after the branch (2) is 32-bits wide. There is a 2-cycle latency since the aligner has to fetch two longwords for an unaligned access. This means the lower 16-bits at address PC+N is the top part of the instruction and the top 16-bits of the following longword provides the lower part of the instruction. The lower 16-bits of the second longword are buffered. The following instruction (3) is also a 32-bit instruction wide and is produced by concatenating the buffered 16-bits from (3) with the top 16-bits from the next sequential longword. The lower 16-bits are buffered.

Note that the aligner behaves the same as described above when returning from branches for unaligned accesses.

The behavior of the aligner in the presence of a single 32-bit instruction zero-overhead loop can be optimised. When the 32-bit instruction falls across a long word boundary the default behaviour of the aligner is to do 2 fetches per instruction. A better method is to detect that next_pc for the current ifetch pulse matches the ‘next_pc’ value for the previous ifetch pulse. This information can be used to prevent the extra fetch process. An example of instruction flow for this case is given in FIG. 64. As shown in the Figure, the first instruction (1) is a 16-bit since p1iw[31 :30] !=“00”. This is the Jump (or Branch) instruction. The aligner performs the appropriate formatting before passing the instruction to the processor. The lower 16-bits are buffered. The second instruction (1a) is 32-bits since the buffered value from (1) p1iw[15:14]=“00”. Note the top 16-bits of the instruction are at address pc+4 while the lower 16-bits are at address pc+6. This is the delay slot of the Jump (or Branch) instruction. The next instruction taken after the branch (2) is 32-bits wide. There is a 2-cycle latency since the aligner has to fetch two longwords for an unaligned access. This means the lower 16-bits at address PC+N is the top part of the instruction and the top 16-bits of the following longword provides the lower part of the instruction. The lower 16-bits of the second longword are buffered. The following instruction (3) is also a 32-bit instruction wide and is produced by concatenating the buffered 16-bits from (3) with the top 16-bits from the next sequential longword. The lower 16-bits are buffered.

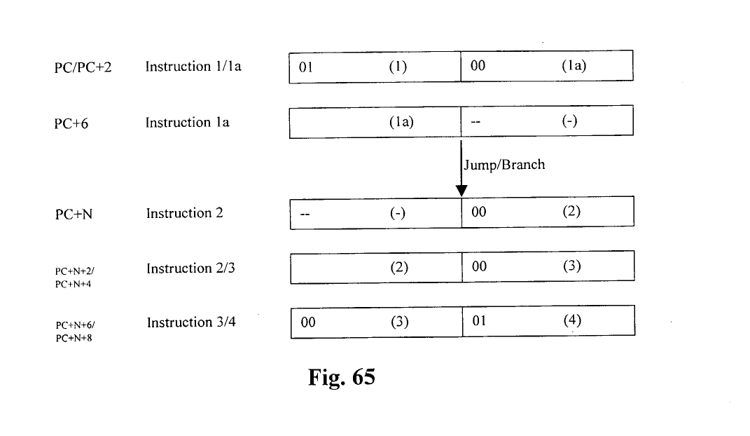

See also FIG. 65 and the following exemplary code. Note that the aligner behaves the same as described above when returning from branches for unaligned accesses.

| MOV | LP_COUNT, 5 | | | ; | no. of times to do loop |
|---|---|---|---|---|---|
| MOV | r0, | dooploop>>2 | | ; | convert to longword size |
| ADD | r1, | r0, 1 | | ; | add 1 to ‘dooploop’ address |
| SR | r0, | [LP_START] | | ; | setup loop start register |
| SR | r1, | [LP_END] | | ; | setup loop end register |
| NOP | | | | ; | allow time to update regs |
| NOP | | | | | |
| dooploop: | | | | | |
| OR | r21, | r22, | r23 | ; | single inst in loop |
| ADD | r19, | r19, | r20 | ; | first inst. after loop |

Note that the aligner of the present embodiment also must be able to support interrupts for when they are generated. All interrupts performed longword aligned accesses. The state of the aligner is reset when the instruction cache is invalidated (ivic) or when a branch/jump is taken.

Integrated Circuit (IC) Device

As previously described, the processor core configuration described herein is used as the basis for IC devices. Such exemplary devices are fabricated using the customized VHDL design obtained using the method referenced subsequently herein, which is then synthesized into a logic level representation, and then reduced to a physical device using compilation, layout and fabrication techniques well known in the semiconductor arts. For example, the present invention is compatible with 0.35, 0.18, and 0.1 micron processes, and ultimately may be applied to processes of even smaller (e.g., the 0.065 micron processes under development by IBM/AMD, or alternatively other resolutions than those listed explicitly herein. An exemplary process for fabrication of the device is the 0.1 micron “Blue Logic” Cu-11 process offered by International Business Machines Corporation, although others may clearly be used.

It will be appreciated by one skilled in the art that the IC device of the present invention may also contain any commonly available peripheral such as serial communications devices, parallel ports, USB ports/drivers, timers, counters, high current drivers, analog to digital (A/D) converters, digital to analog converters (D/A), interrupt processors, LCD drivers, memories, RF system components, and other similar devices. Further, the processor may also include other custom or application specific circuitry, such as to form a system on a chip (SoC) device useful for providing a number of different functionalities in a single package as previously referenced herein. The present invention is not limited to the type, number or complexity of peripherals and other circuitry that may be combined using the method and apparatus. Rather, any limitations are primarily imposed by the physical capacity of the extant semiconductor processes which improve over time. Therefore it is anticipated that the complexity and degree of integration possible employing the present invention will further increase as semiconductor processes improve.

It will be further recognized that any number of methodologies for synthesizing logic incorporating the “dual ISA” functionality previously discussed may be utilized in fabricating the IC device. One exemplary method of synthesizing integrated circuit logic having a user-customized (i.e., “soft”) instruction set is disclosed in co-pending U.S. Pat. application Ser. No. 09/418,663 previously referenced herein. Other methodologies, whether “soft” or otherwise, may be used, however.

It will be appreciated that while certain aspects of the invention have been described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

[image]

[image]

[image]

[image]

[image]

[image]

[image]

[image]

[image]

[image]

[image]

[image]

[image]

[image]

[image]

We claim:

1. Data processor apparatus having a multi-stage pipeline and an instruction set having at least one extension instruction; comprising;
a plurality of first instructions having a first length;
a plurality of second instructions having a second length; and
logic adapted to decode and process both said first length and second length instructions from a single program having both first and second length instructions contained therein.

2. The apparatus of claim 1, wherein said logic comprise an instruction aligner disposed in a first stage of said pipeline, said aligner adapted to provide at least one first word of said first length and at least one second word of said second length to decode logic, said decode logic selecting between said at least one first and second words.

3. The apparatus of claim 2, said aligner further comprising a buffer, said buffer adapted to store at least a portion of a fetched instruction from an instruction cache operatively coupled to the aligner, said storing mitigating stalling of said pipeline.

4. Reduced memory overhead data processor apparatus having a multi-stage pipeline with at least fetch, decode, execute, and writeback stages, and an instruction set having (i) a base instruction set and (ii) at least one extension instruction; the apparatus comprising;
a plurality of first instructions having a first length;
a plurality of second instructions having a second length; and
logic adapted to decode and process both said first length and second length instructions;
wherein the selection of instructions of said first or second length is conducted based at least in part on minimizing said memory overhead.

5. Digital processor pipeline apparatus, comprising:
an instruction fetch stage;
an instruction decode stage operatively coupled downstream of said fetch stage;
an execution stage operatively coupled downstream of said decode stage; and
a writeback stage operatively coupled downstream of said execution stage;
wherein said fetch, decode, execute, and writeback stages are adapted to process a plurality of instructions comprising a first plurality of 16-bit instructions and a second plurality of 32-bit instructions.

6. The apparatus of claim 5, wherein said plurality of instructions comprises at least one extension instruction.

7. The apparatus of claim 6, further comprising at least one selector operatively coupled to at least said fetch stage, said at least one selector operative to select between individual ones of 16-bit and 32-bit instructions within said first and second plurality of instructions, respectively.

8. The apparatus of claim 5, further comprising a register file disposed within said decode stage.

9. The apparatus of claim 5, further comprising:
(i) an instruction cache within said fetch stage;
(ii) an instruction aligner operatively coupled to said instruction cache; and
(iii) decode logic operatively coupled to said instruction aligner and said decode stage;
wherein said aligner is configured to provide both 16-bit and 32-bit instructions to said decode logic, said decode logic selecting between said 16-bit and 32-bit instructions to produce a selected instruction, said selected instruction being passed to said decode stage of said pipeline apparatus.

10. Processor pipeline code compression apparatus, comprising:
an instruction cache adapted to store a plurality of instruction words of first and second lengths;
an instruction aligner operatively coupled to said instruction cache; and
decode logic operatively coupled to said aligner;
wherein said aligner is adapted to provide at least one first word of said first length and at least one second word of said second length to said decode logic, said decode logic selecting between said at least one first and second words.

11. The apparatus of claim 10, wherein said aligner further comprises a buffer, said buffer adapted to store at least a portion of a fetched instruction from said cache, said storing mitigating pipeline stalling.

12. The apparatus of claim 11, wherein said fetched instruction crosses a longword boundary.

13. The apparatus of claim 11, further comprising a register file disposed downstream of said aligner, said register file adapted to store a plurality of source data.

14. The apparatus of claim 13, further comprising at least one multiplexer operatively coupled to said decode logic and said register file, wherein said at least one multiplexer selects at least one operand for the selected one of said first or second word.

15. The apparatus of claim 10, wherein said first length is shorter than said second length, and said decode logic further comprises logic adapted to expand said first word from said first length to said second length.

16. A method of compressing the instruction set of a user-configurable digital processor design, comprising:
providing a first instruction word;
generating at least second and third instructions words, said second word having a first length and said third word having a second length, said second length being longer than said first length; and
selecting, based on at least one bit within said first instruction word, which of said second and third words is valid;
wherein said acts of generating and selecting cooperate to provide code density greater than that obtained using only instruction words of said second length.

17. A digital processor with multi-stage pipeline and multi-length ISA comprising a buffered instruction aligner disposed in the first stage of said pipeline, wherein said instruction aligner allows unrestricted selection of instructions of either a first or second length.

18. An embedded integrated circuit, comprising:
at least one silicon die;
at least one processor core disposed on said die, said at least one core comprising:
(i) a base instruction set;
(ii) at least one extension instruction;
(iii) a multi-stage pipeline with instruction cache and code aligner in the first stage thereof, said instruction aligner adapted to generate instruction words of first and second lengths, said processor core further being adapted to determine which of said instruction words is optimal;
at least one peripheral; and
at least one storage device disposed on said die adapted to hold a plurality of instructions;
wherein said integrated core is designed using the method comprising:
(i) providing a basecase core configuration; and
(ii) selectively adding said at least one extension instruction.

19. A method of processing multi-length instructions within a digital processor instruction pipeline, comprising:
providing a plurality of first instructions of a first length;
providing a plurality of second instructions of a second length, at least a portion of said plurality of second instructions comprising components of a longword;
determining when a given longword comprises one of said first instructions or a plurality of said second instructions; and
when said act of determining indicates that said given longword comprises a plurality of said second instructions, buffering at least one of said second instructions.

20. The method of claim 19, wherein said act of determining comprises reading the most significant bits of each of said first and second instructions.

21. The method of claim 19, wherein said act of buffering comprises determining whether said at least one second instruction being buffered comprises the first portion of an instruction of said first length.

22. The method of claim 21, wherein said first length comprises 32-bits, and said second length comprises 16-bits.

23. The method of claim 21, further comprising concatenating said at least one second instruction with at least a portion of a subsequent longword.

24. A method of processing multi-length instructions within a digital processor instruction pipeline, at least one of said instructions comprising a branch or jump instruction, comprising:
providing a first 16-bit branch/jump instruction within a first longword having an upper and lower portion, said branch/jump instruction being disposed in said upper portion;
processing said branch/jump instruction, including buffering said lower portion;
concatenating the upper portion of a second longword with said buffered lower portion of said first longword to produce a first 32-bit instruction; and
taking the branch/jump, wherein the lower portion of said second longword is discarded.

25. The method of claim 24, wherein said first 32-bit instruction resides in the delay slot of said first 16-bit branch/jump instruction.

26. A single mode pipelined digital processor with an ISA, said ISA having a plurality of instructions of at least first and second lengths, said instructions each having an opcode in their upper portion, said opcode containing at least two bits which designate the instruction length;
wherein said ISA is adapted to automatically select instructions of said first or second length based at least in part on said opcode and without mode switching.

27. A method compressing a digital processor instruction set, comprising;
providing a first plurality of instructions of a first length, said first length being consistent with the architecture of the processor;
providing a second plurality of instructions of a second length, said first length being an integer multiple of said second length;
selectively utilizing individual ones of said second plurality of instructions.

28. A digital processor, comprising;
a first ISA having a plurality of first instructions of a first length associated therewith;
a second ISA having a plurality of second instructions of a second length, said first length being an integer multiple of said second length;
selection apparatus adapted to selectively utilize individual ones of said second instructions in at least instances where either said first instructions or said second instructions could be utilized to perform an operation, said utilization of said second instructions reducing the cycle count required to perform said operation.

29. A method of programming a digital processor, comprising:
providing a first ISA having a plurality of first instructions of a first length associated therewith;
providing a second ISA having a plurality of second instructions of a second length, said first length being an integer multiple of said second length; and
selecting individual ones of said first and second instructions during said programming; and
generating a computer program using said selected first and second instructions;
wherein the execution of said computer program on said processor requires no mode switching.

30. User-configured data processor apparatus having a multi-stage pipeline, a base instruction set, and at least one extension instruction; comprising;
a plurality of first instructions having a 32-bit length;
a plurality of second instructions having a 16-bit length;
an instruction cache disposed in a first stage of said pipeline;
an instruction aligner disposed in said first stage of said pipeline and operatively coupled to said instruction cache;
a register file disposed in a second stage of said pipeline; and
decode logic operatively coupled between said aligner and said register file;
wherein said aligner and said decode logic are adapted to generate and decode both said first and second instructions, said acts of generating and decoding allowing said user to freely intermix said first and second instructions within a program running on said apparatus.
